(19) United States
(12) Patent Application Publication
(10) Pub. No.: US 2018/0349485 A1
(43) Pub. Date: Dec. 6, 2018

(54) SOCIAL MEDIA SYSTEM WITH NAVIGABLE, ARTIFICIAL-INTELLIGENCE-BASED GRAPHICAL USER INTERFACE WITH A CAROUSEL VIEW

(71) Applicant: Inmentis, LLC, Los Angeles, CA (US)

(72) Inventors: Jeffrey C. Carlisle, Los Angeles, CA (US); Ilana G. Fraines, La Canada, CA (US)

(21) Appl. No.: 15/936,303

(22) Filed: Mar. 26, 2018

Related U.S. Application Data
(60) Provisional application No. 62/476,470, filed on Mar. 24, 2017.

(51) Int. Cl. G06F 17/30; G06F 3/0481; G06F 17/27; G06Q 50/00

(52) U.S. Cl. CPC G06F 17/30702; G06F 3/04815; G06F 3/04817; G06Q 50/01; G06F 17/30719; G06F 17/30696; G06F 17/2705

(57) ABSTRACT

Navigable graphical user interface for social media system. In an embodiment, a graphical user interface is generated, which provides user navigation between each screen, generated by an executing one of a plurality of app modules to comprise content from a corresponding content source. In response to receiving a search input, two or more of the plurality of app modules are executed to each generate a content screen that comprises a search result of a search based on the search input. The search results are sorted into a plurality of categories and ranked within each of the plurality of categories. A result screen is generated, within the graphical user interface, that comprises, for each of one or more of the plurality of categories, a scroll interface, wherein each scroll interface comprises visual representations of a plurality of the content screens that comprise the search results that were sorted into the category, and wherein each scroll interface is scrollable in one or more directions.

### CROSS-REFERENCE TO RELATED APPLICATIONS

This application claims priority to U.S. Provisional Patent App. No. 62/476,470, filed on Mar. 24, 2017, the entirety of which is hereby incorporated herein by reference.

### BACKGROUND

### Field of the Invention

The embodiments described herein are generally directed to a social media system, and, more particularly, to a social media system that provides an improved navigable graphical user interface, and may be driven by artificial intelligence and/or record transactions in a blockchain for gamification and/or other functions of the system.

### Description of the Related Art

The amount of consumable information (e.g., on the Internet) continues to increase exponentially. As of March 2016, there were approximately 4.6 billion webpages available on the World Wide Web. By 2020, it is estimated that there will be approximately 40 billion zettabytes of data available for consumption.

This exponential increase in data has rendered existing search engines ineffective. For instance, it is estimated that users spend approximately 6.35 hours per day searching and reading content. These users struggle to find the resources that satisfy their exact needs. Meanwhile, businesses find it difficult to reach potential consumers.

In addition, there are too many apps. For instance, the average user spends approximately 85% of their online time on apps. However, on average, 84% of that time is spent on only five primary apps for the user. While the amount of time that users spend online is increasing, the number of online apps being used is not increasing.

Thus, what is needed is a personalized social media system and graphical user interface that enables users too quickly and efficiently search, find, and consume the resources that they need or desire.

### SUMMARY

Accordingly, systems, methods, and non-transitory computer-readable media are disclosed for an improved social media system.

In an embodiment, a method is disclosed. The method comprises using at least one hardware processor to: manage a plurality of app modules, wherein each app module comprises a software module that generates a screen comprising content from a corresponding content source; generate a graphical user interface, which provides user navigation between each screen generated by an executing one of the plurality of app modules, and which receives a search input; in response to receiving a search input, comprising one or more search terms, via the graphical user interface, execute two or more of the plurality of app modules to, for each of the two or more app modules, generate a content screen that comprises a search result of a search based on the one or more search terms; sort the search results into a plurality of categories; rank the search results within each of the plurality of categories; and generate a result screen, within the graphical user interface, that comprises, for each of one or more of the plurality of categories, a scroll interface, wherein each scroll interface comprises visual representations of a plurality of the content screens that comprise the search results that were sorted into the category, and wherein each scroll interface is scrollable in one or more directions. The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processed described herein, may be executed, according to an embodiment;

FIGS. 3A-3AA illustrate various screens of a graphical user interface, according to one or more embodiments;

FIGS. 4A and 4B illustrate an example operation of a data model, according to an embodiment;

FIG. 5 illustrates a process for a user-biased artificial-intelligence-driven search, according to an embodiment;

FIG. 6 illustrates a process for broadcasting, according to an embodiment;

FIG. 7A illustrates a process for recording transactions in a blockchain, according to an embodiment;

FIGS. 7B and 7C illustrate an e-commerce process using a blockchain, according to an embodiment;

FIG. 7D illustrates an example traversal of a social network, according to an embodiment;

FIG. 8 illustrates a process for recording interactions on a blockchain, according to an embodiment;

FIGS. 9A and 9B illustrate an example operation of a gamification engine, according to an embodiment;

FIG. 10A illustrates an infrastructure for delivering privatized external content, according to an embodiment; and

FIG. 10B illustrates an example of a process for delivering privatized external content, according to an embodiment.

### DETAILED DESCRIPTION

In an embodiment, systems, methods, and non-transitory computer-readable media are disclosed for a social media system. The social media system may enable complete integration of all of a user's online activities, including both personal and professional activities, and nurture a socially conscious, contribution-based culture that focuses on raising awareness to social causes and human development. In addition, the social media system may obtain and present information in a more concise format to provide more personalized search results in less time, may search for information (e.g., in response to a user's search input, or automatically to identify relevant and personalized content for a user using artificial intelligence) simultaneously across all online platforms (e.g., social-networking platforms, search engines, etc.), and may comprise apps within an application that can be executed and operated simultaneously with full functionality.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Example Infrastructure

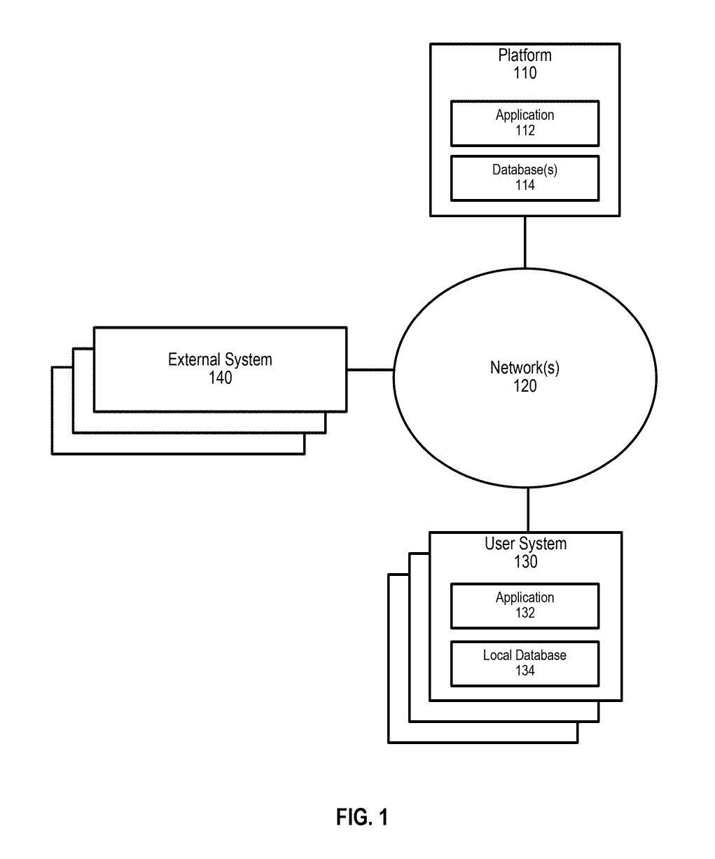

FIG. 1 illustrates an example infrastructure in which the disclosed social media system may operate, according to an embodiment. The infrastructure may comprise a platform 110 (e.g., one or more servers) which hosts and/or performs one or more of the various functions, processes, and/or methods described herein (e.g., by executing one or more software modules that implement the function, process, or method). Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., websites, data feeds, other platforms, etc.) via one or more networks 120.

Network(s) 120 may comprise the Internet, and platform 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile devices, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise one or more user interfaces, including, for example, webpages generated in HyperText Markup Language (HTML) or other language. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet, using standard communication protocols (e.g., HTTP, HTTPS, etc.). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and/or the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Sybase™, Access™, and the like, including cloud-based database instances and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., server application 112), executed by platform 110. For example, the platform 110 may be extended to a user network across public networks, for example, through a virtual private network (e.g., VPN) or the like.

In an embodiment, storage for platform 110 may be decentralized. For example, database(s) 114 may be stored across a decentralized file system, such as the InterPlanetary File System (IPFS). IPFS is a peer-to-peer distributed file system that connects a plurality of computing devices with the same system of files.

In embodiments in which a web service is provided, platform 110 may receive requests from external system(s) 140, and provide responses in eXtensible Markup Language (XML) and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend functions, processes, methods, storage, and/or the like, described herein. For example, in such an embodiment, a client application 132 executing on one or more user system(s) 130 may interact with a server application 112 executing on platform 110 to execute one or more or a portion of one or more of the various functions, processes, and/or methods described herein. Client application 132 may be “thin,” in which case processing is primarily carried out server-side by server application 112 on platform 110. A basic example of a thin client application is a browser application, which simply requests, receives, and renders webpages at user system(s) 130, while the server application on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case, server application 112 performs all processing) or user system(s) 130 (e.g., in which case, client application 132 performs all processing) or be distributed between platform 110 and user system(s) 130 (e.g., in which case, server application 112 and client application 132 both perform some degree of processing), can comprise one or more executable software modules that implement one or more of the functions, processes, and/or methods described herein.

1.2. App Modules

As used herein, “app module” refers to an application within the application. Each app module may have a particular or focused function. For example, an individual app module may be provided for each of a plurality of different social-networking platforms, including, without limitation, Instagram™, Snapchat™, Pinterest™, Twitter™, Reddit™, Tumblr™, YouTube™, Flickr™, Meetup™, Linkedln™, Facebook™, askFM™, and/or the like. The application may also provide an app module for one or more of web browsing, image viewing, chat messaging, electronic books, businesses, catalogs, education, entertainment, finance, food and drink, games, health and fitness, kids, lifestyle, magazines and newspapers, medical, music, podcasts, navigation, news, personal productivity, reference, security, shopping, sports, travel, utilities, weather, sites of interest, maps, video, and/or any other common function, and/or any of the proprietary functions described herein (e.g., broadcasting, analytics, etc.). The application may provide or support any number of app modules, and the user may add or delete app modules according to his or her needs and/or preferences (e.g., using a settings screen of the disclosed graphical user interface). In an embodiment, the number of app modules that may be available in the application or simultaneously executed within the application may be limited (e.g., limited to thirty total app modules).

In an embodiment, one or more of the app modules may not be strictly “within” the application, but may be otherwise initiated, accessed, managed, and/or controlled by the application. For example, the application may access an API of an external app module, installed on user system 130. The application may access and/or control the functionality (e.g., initiate a function, retrieve data, etc.) of the external app module via the API. For example, the application may access the API of a Facebook™ app, installed on user system 130, to post social media, retrieve social media, search social media, and/or the like to the Facebook™ platform. Alternatively, if a certain external app is inaccessible via an API (e.g., the application is not granted access to the API, the app does not utilize an API, or the API does not grant the level of access or control needed by the application), the application may utilize a web-browser app module, which implements a web-browsing function, to access a web-based version of the app (e.g., Facebook.com). Thus, whenever the description of a function, process, or method, discussed herein, refers to an app module, it should be understood that, that function, process, or method may also be utilized in a similar or identical manner with respect to an external app, installed on user system 130, or the use of a web-browser app module to access a third-party web-based platform. For instance, anywhere the present description refers to a screen that may be generated by an app module, it is to be understood that the screen may instead be generated by an external app or third-party web-based platform.

1.3. Operating System Integration

In an embodiment, the application (e.g., client application 132) may function as an operating system or operating environment. In an embodiment in which the application is an operating system, it manages the hardware of user system 130, as well as the software, including app modules, executing on the hardware of user system 130. In an embodiment in which the application is an operating environment, it may act as a layer between the operating system of user system 130 and app modules.

In an embodiment in which the application itself is not the operating system, the operating system, executing on a user system 130, may communicate with the application (e.g., client application 132, executing in the background of user system 130, and/or server application 112, executing on platform 110) to execute one or more or a portion of one or more of the various functions, processes, and/or methods described herein. Specifically, the operating system may interface with the application, through an API, to directly initiate execution of any of the app modules or other functions described herein. In this way, various functions of the application may be executed by the operating system directly, without having to access or open the application.

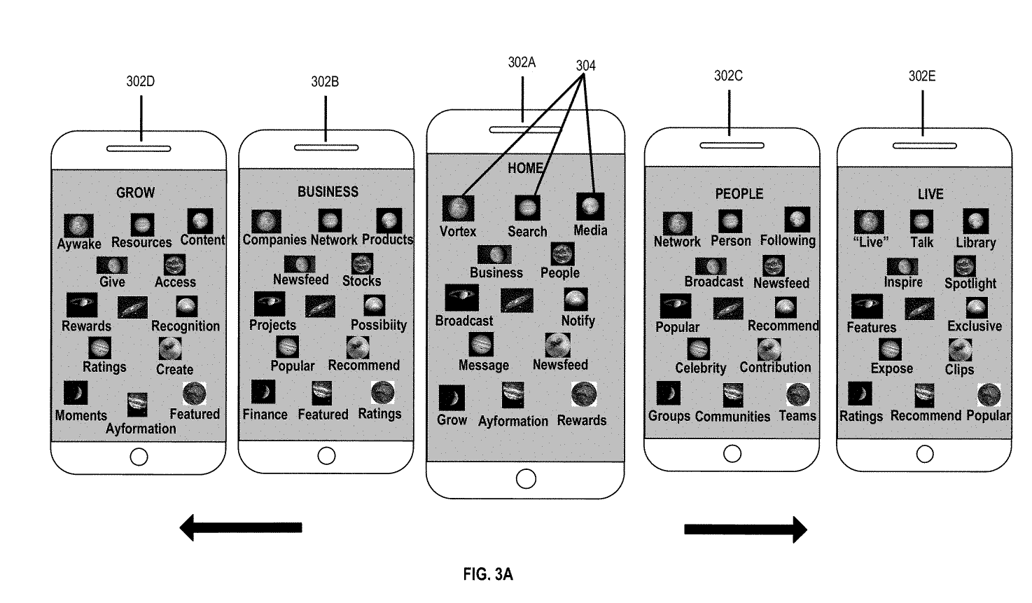

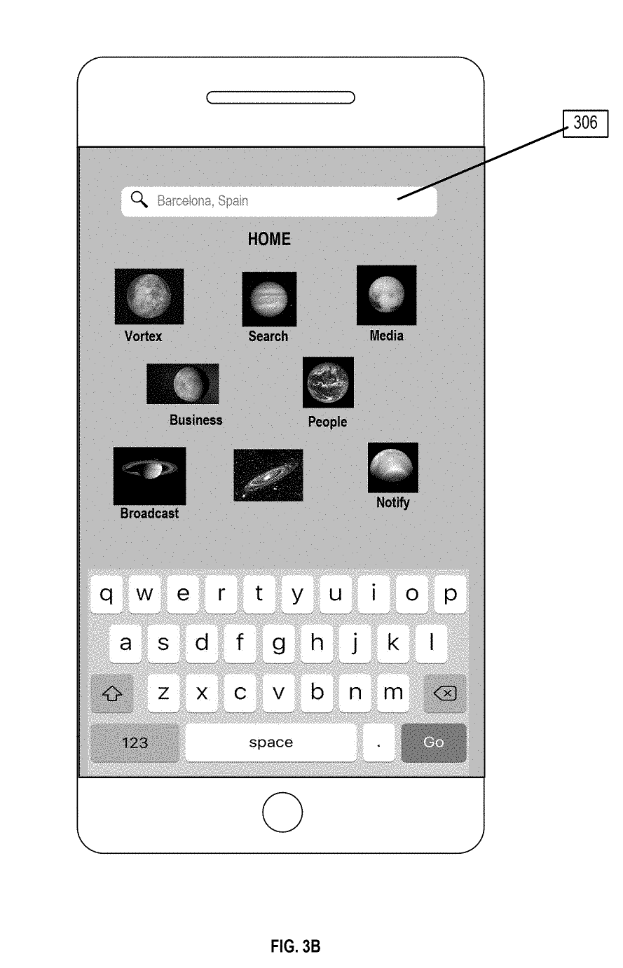

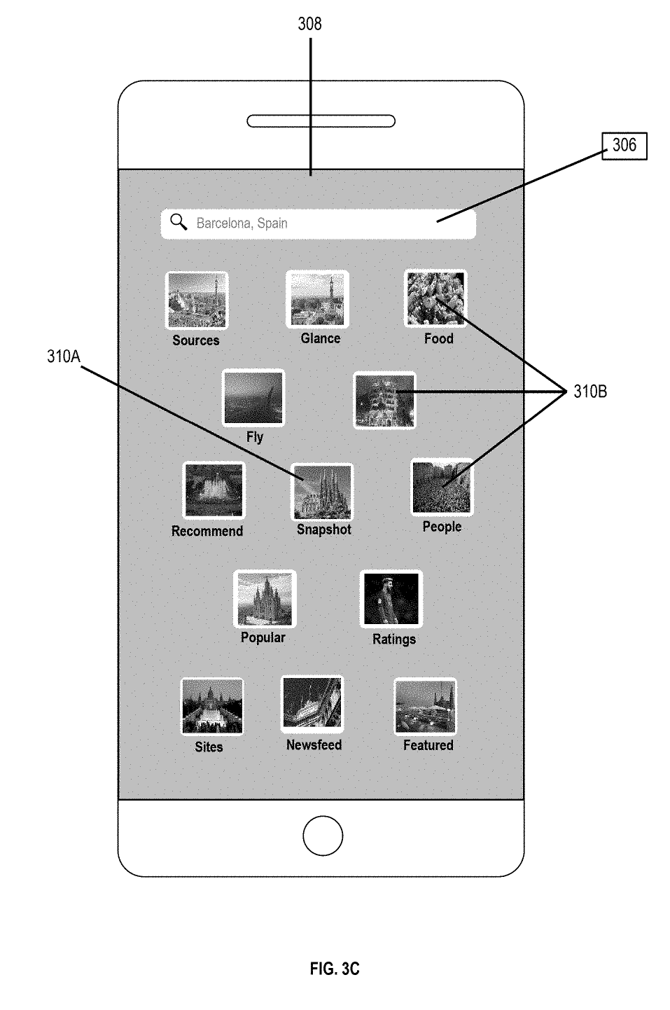

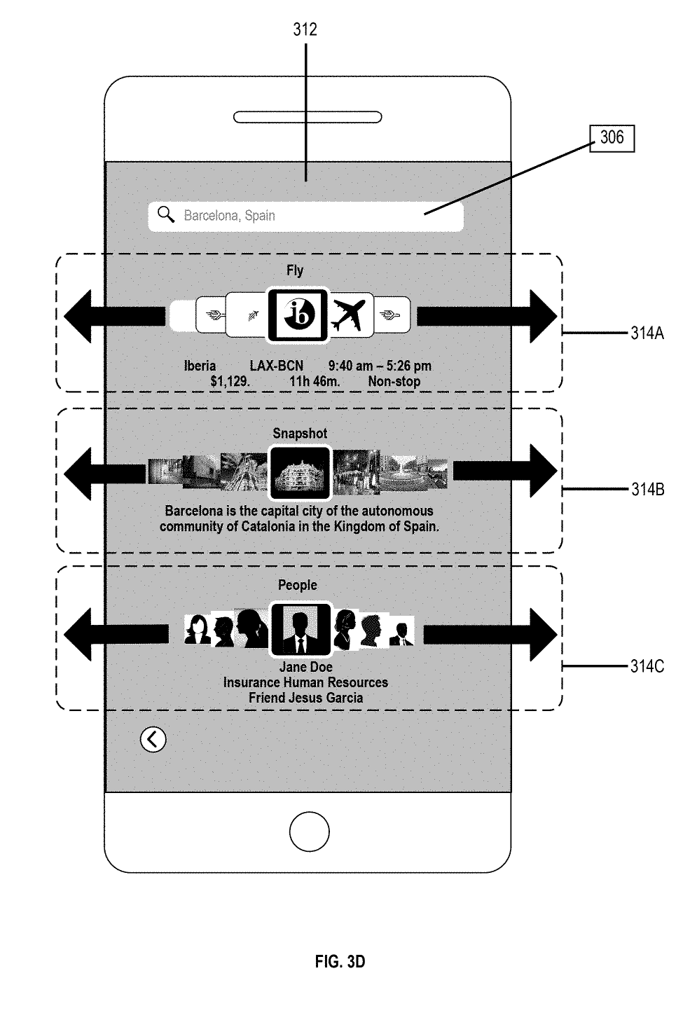

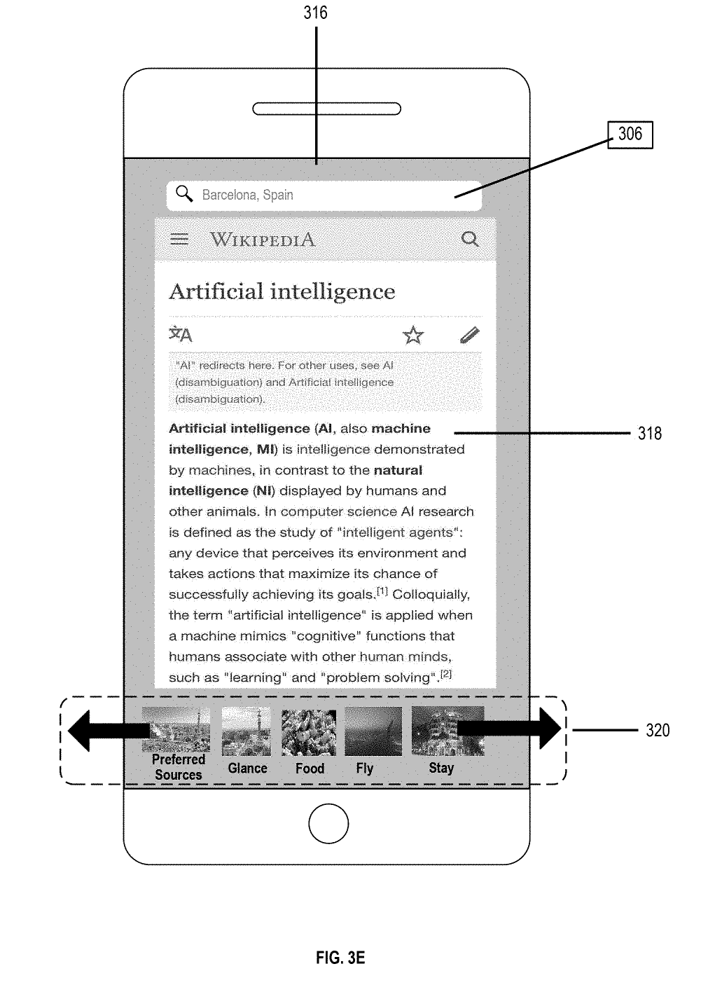

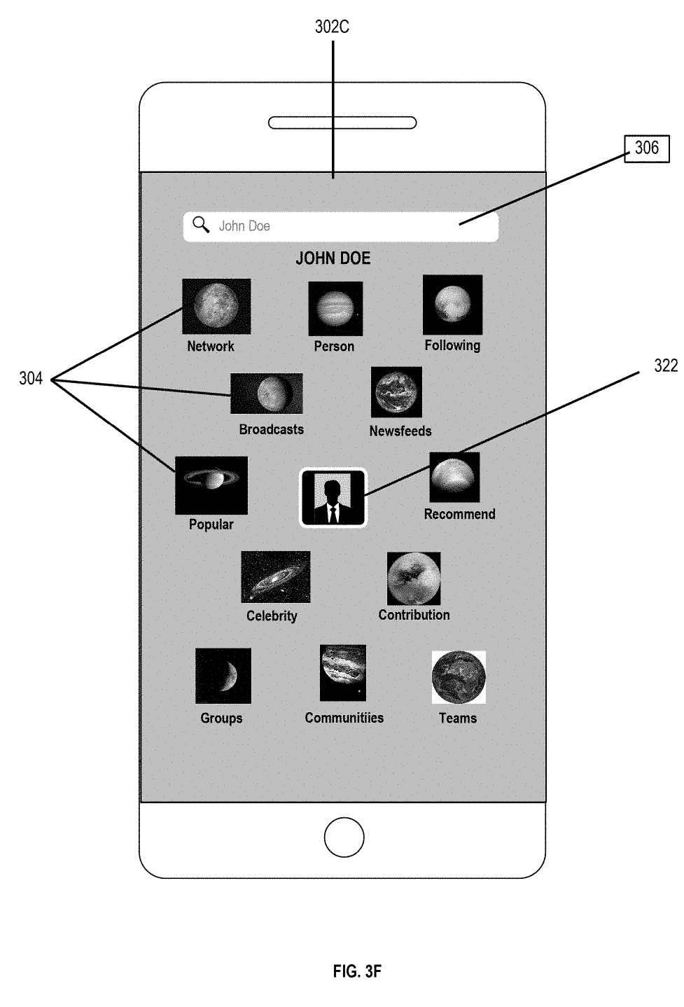

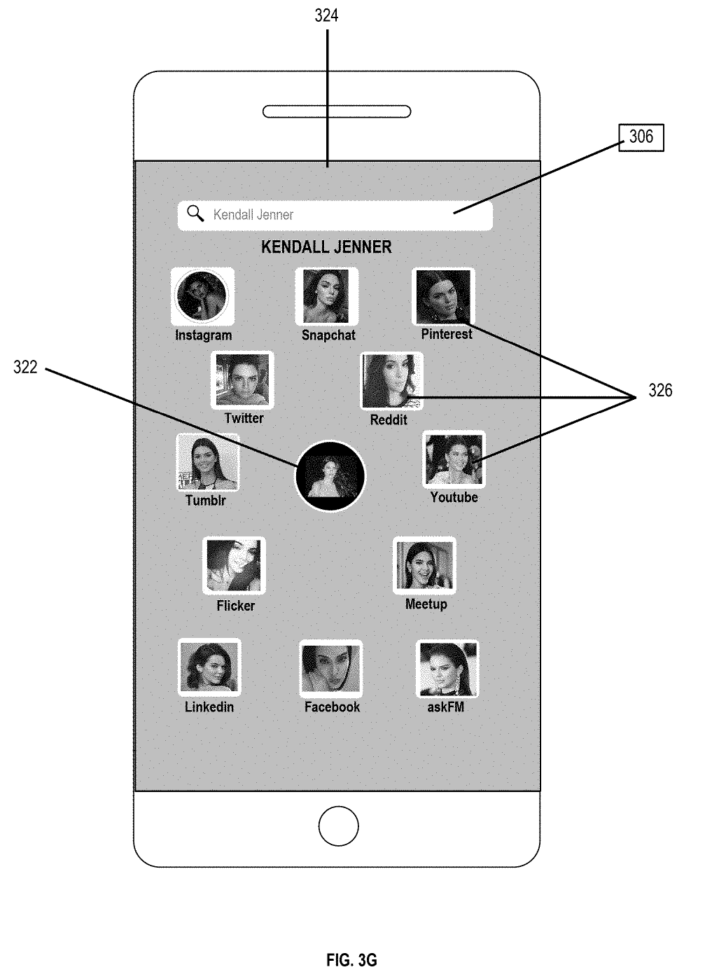

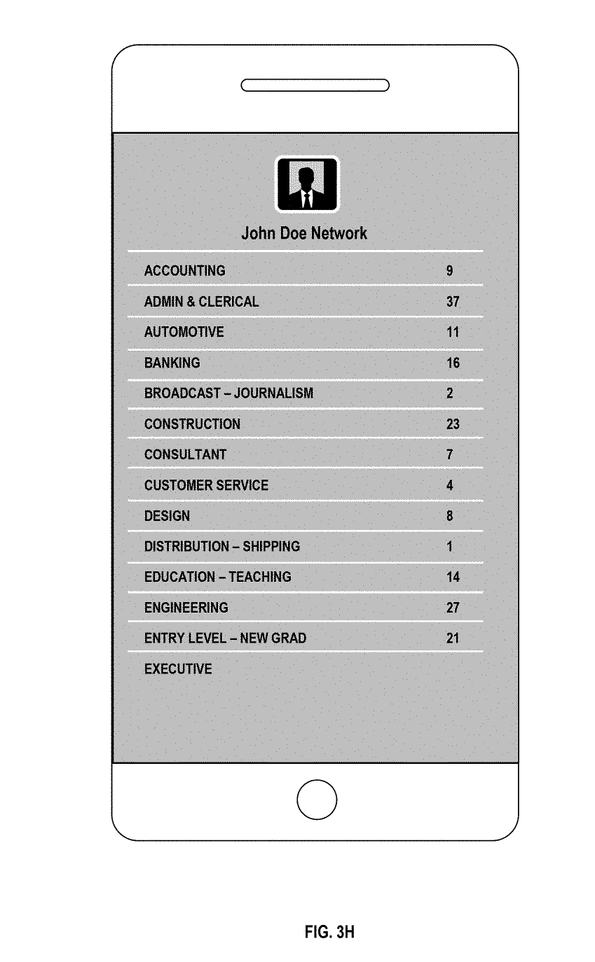

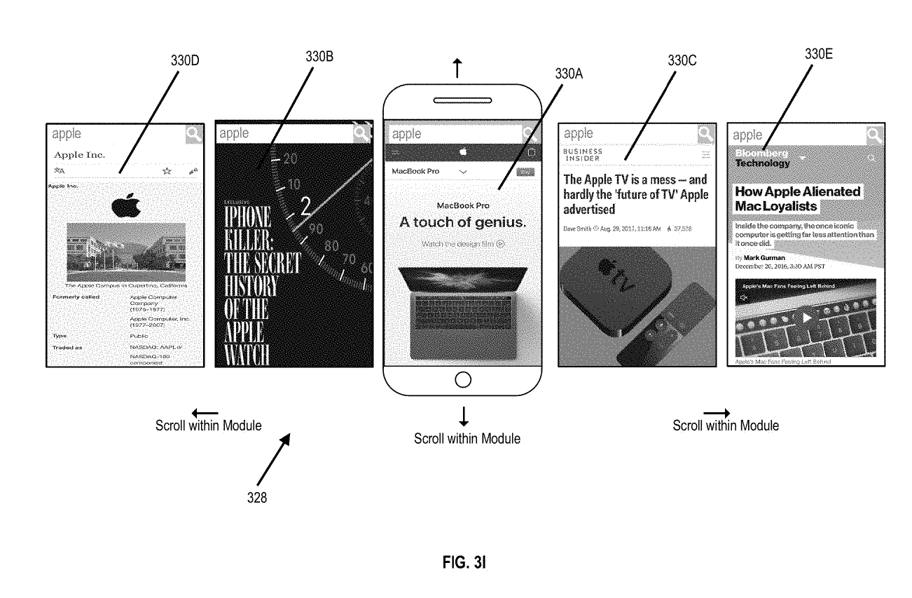

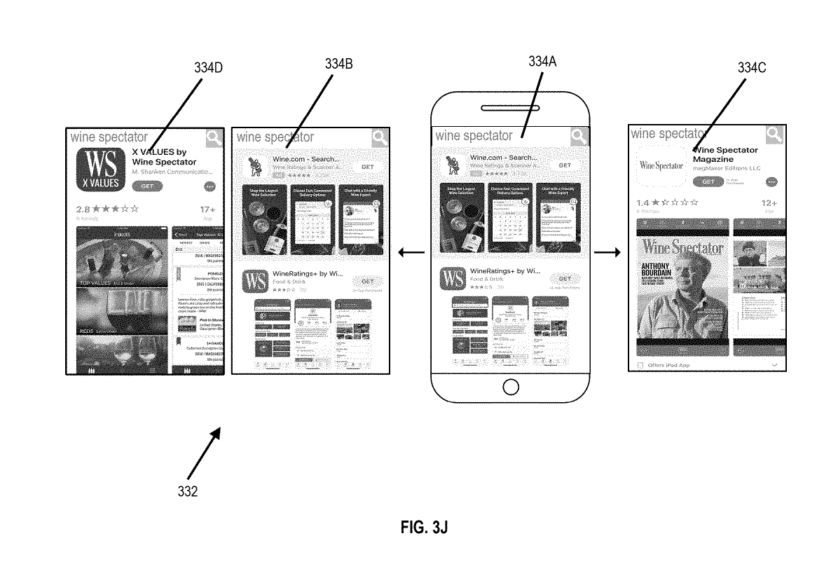

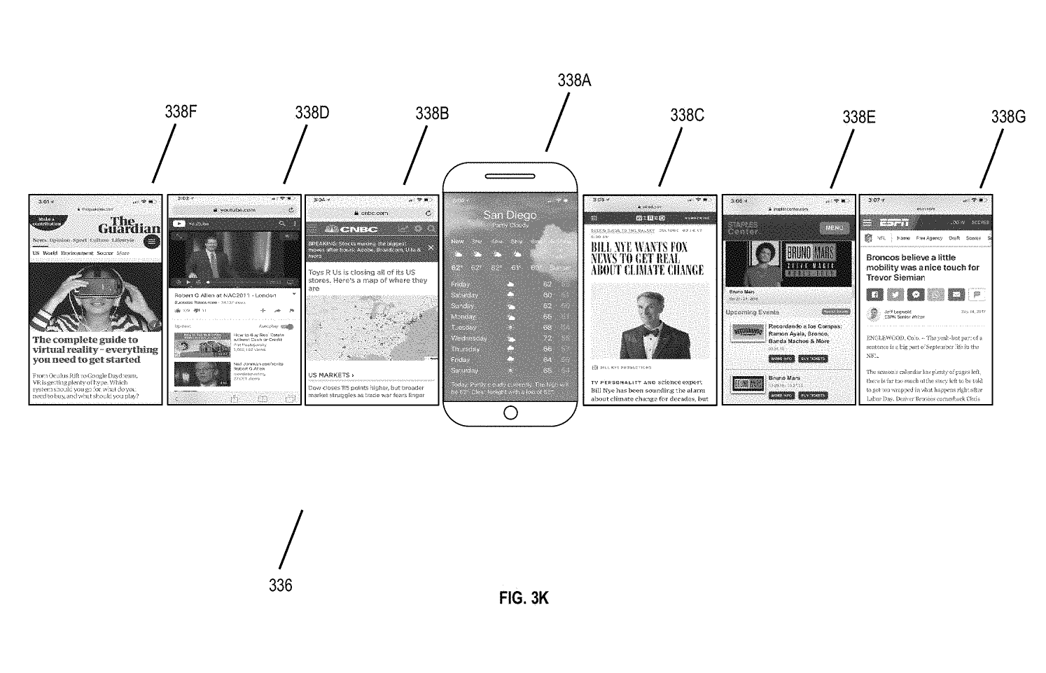

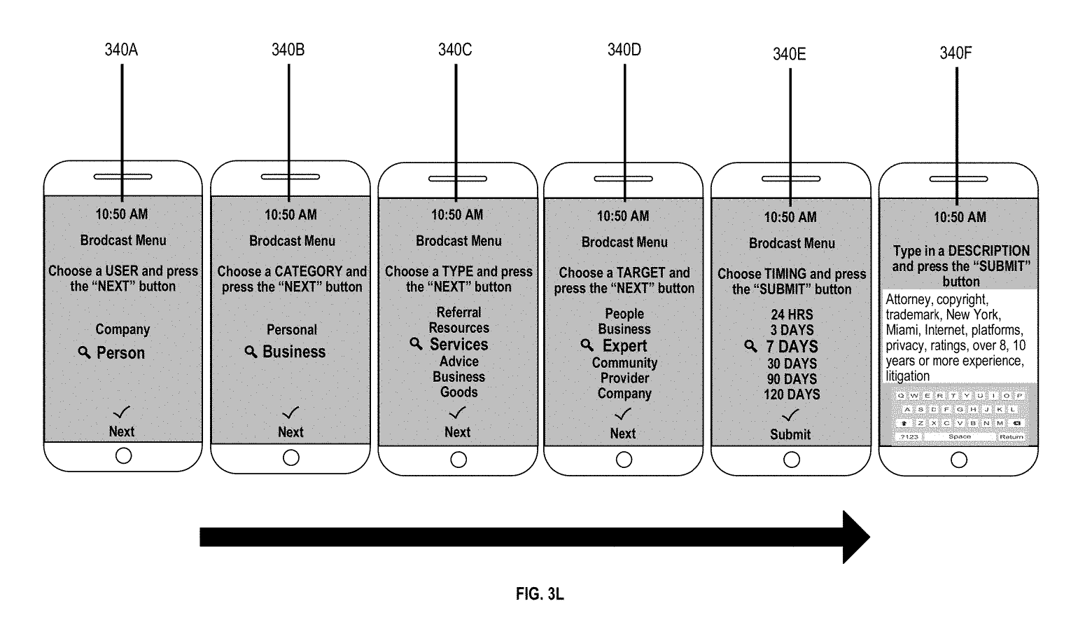

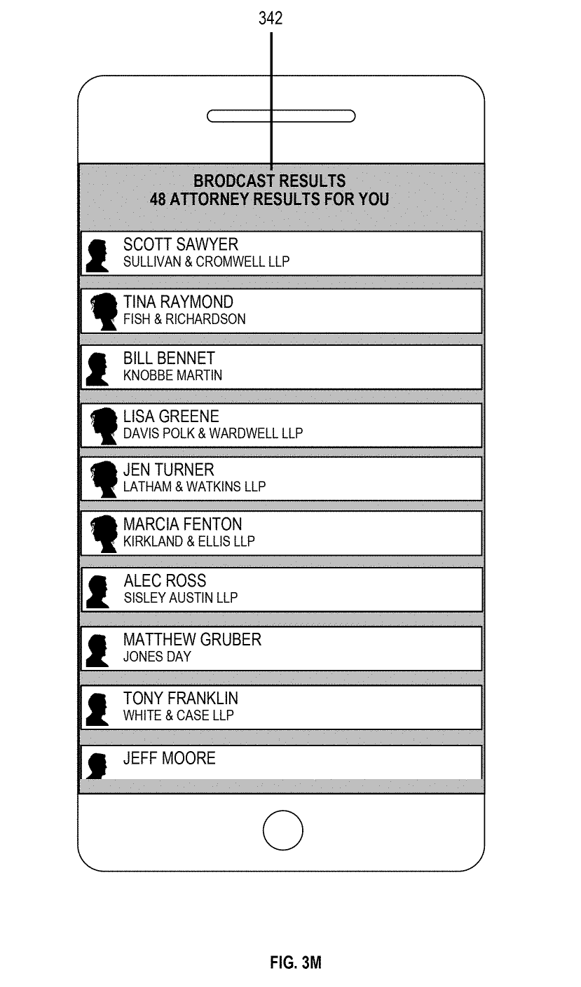

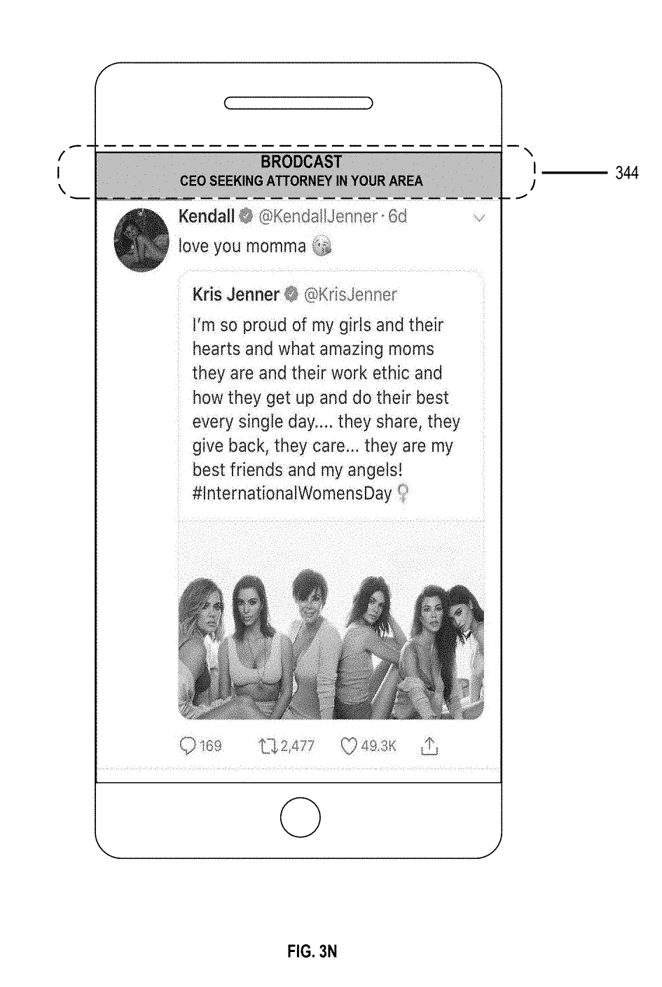

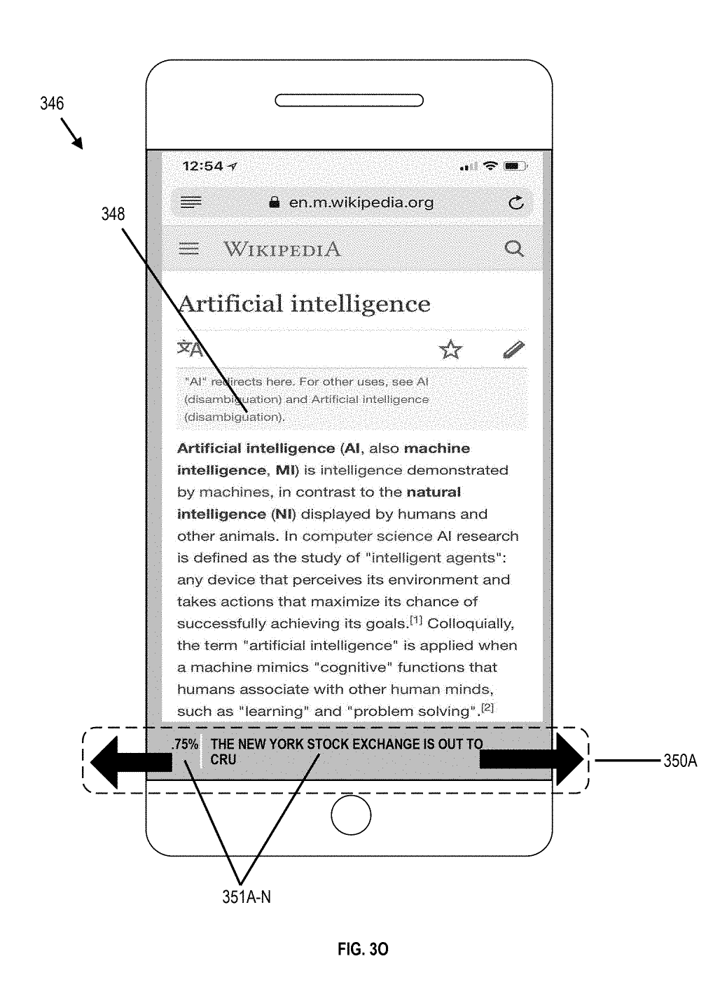

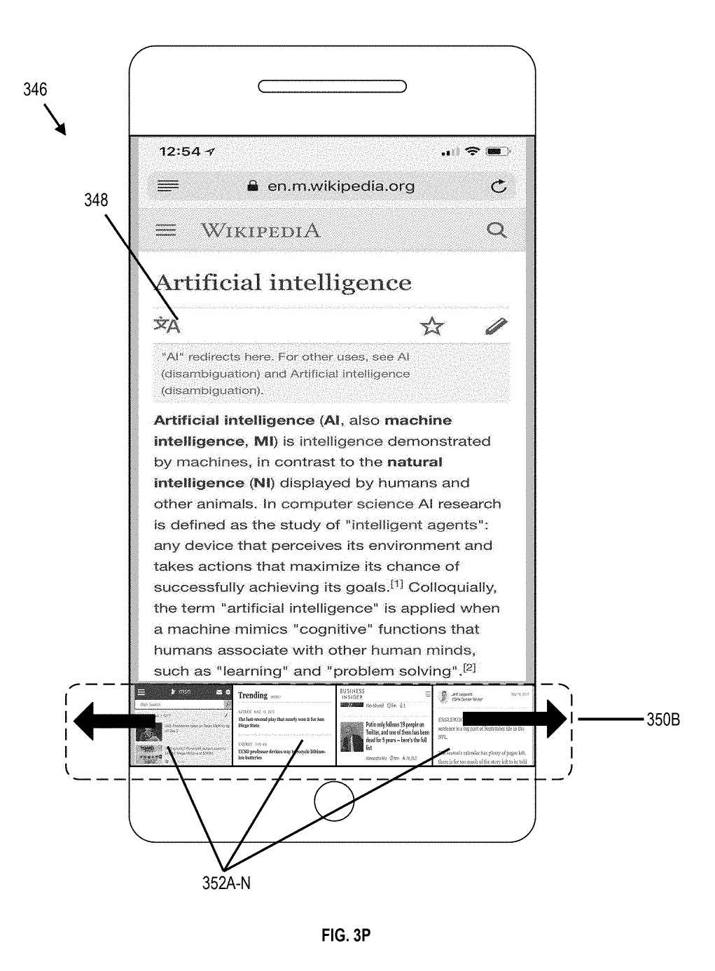

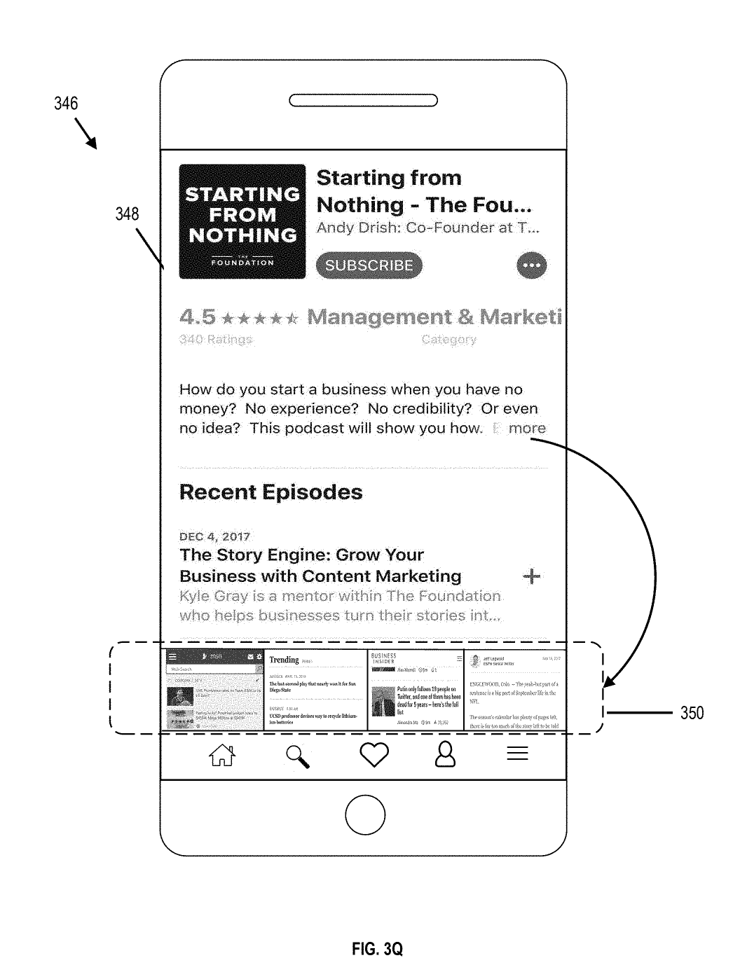

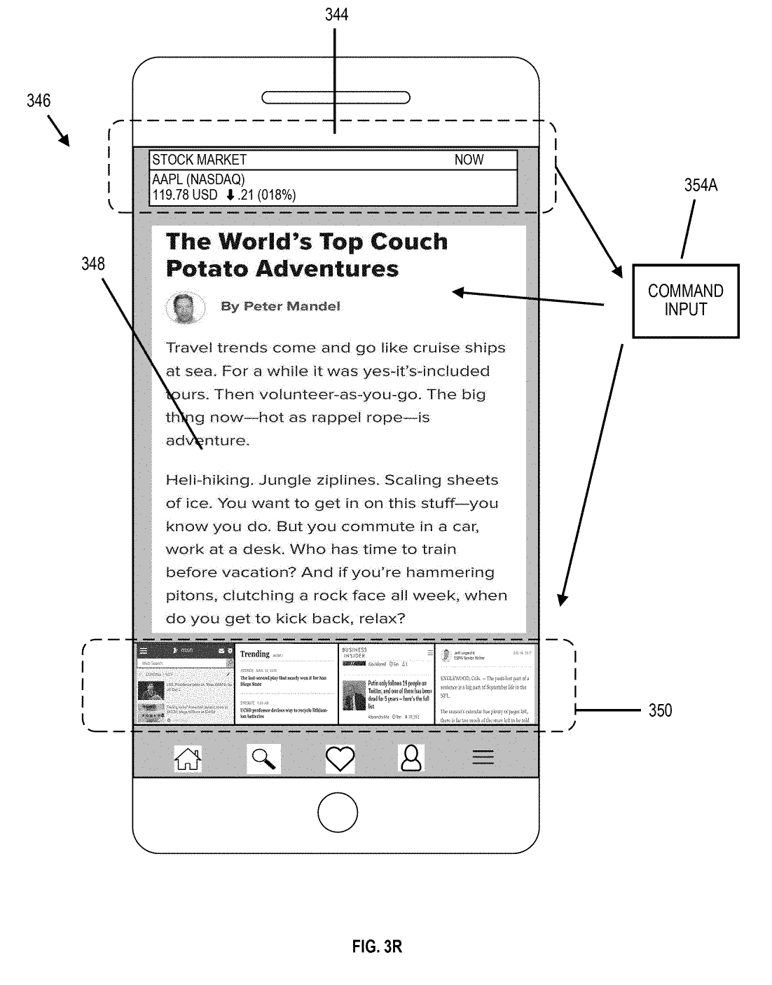

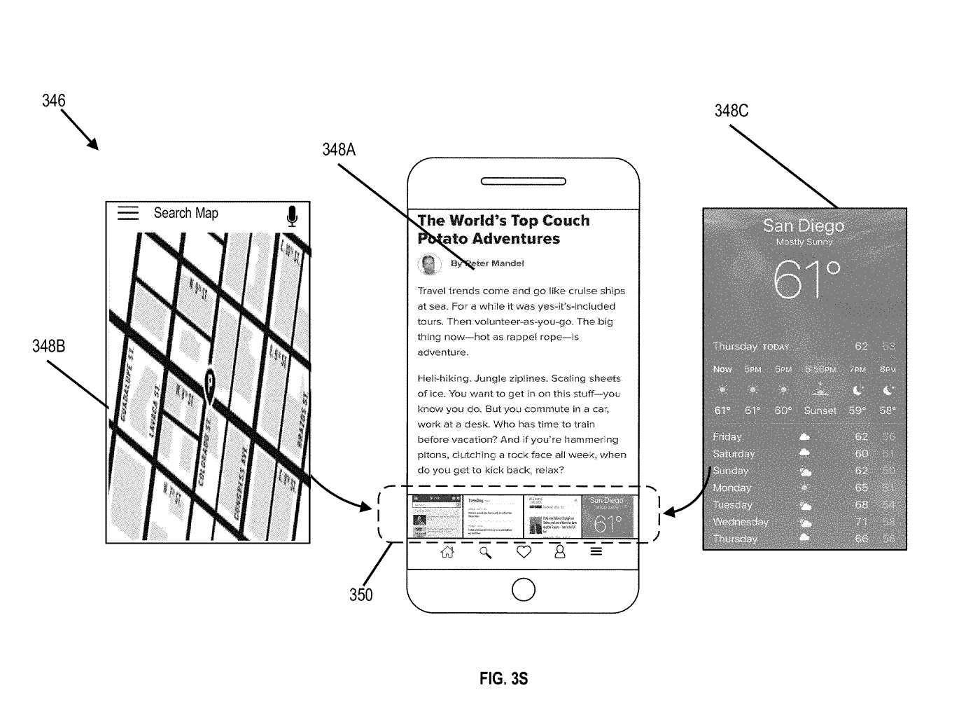

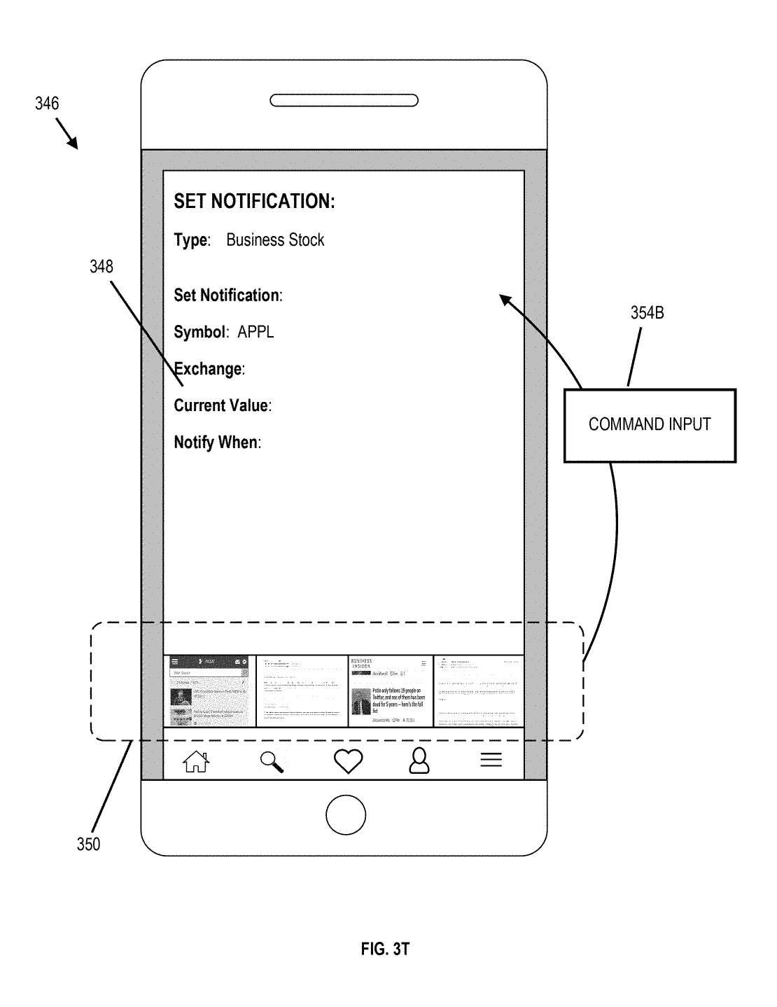

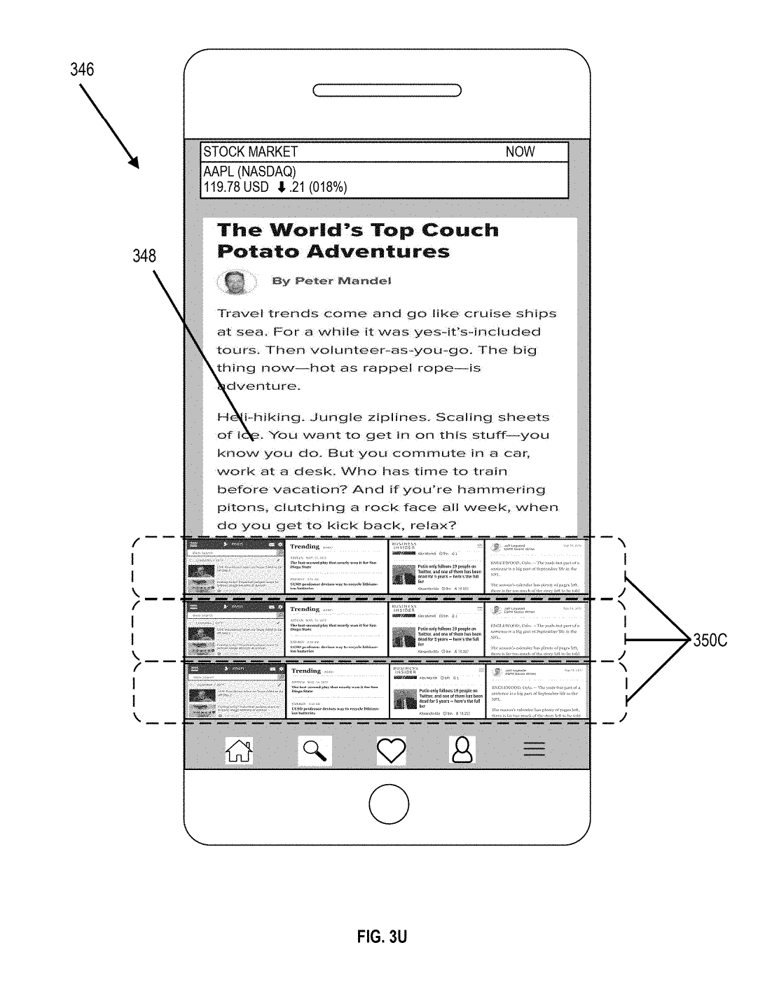

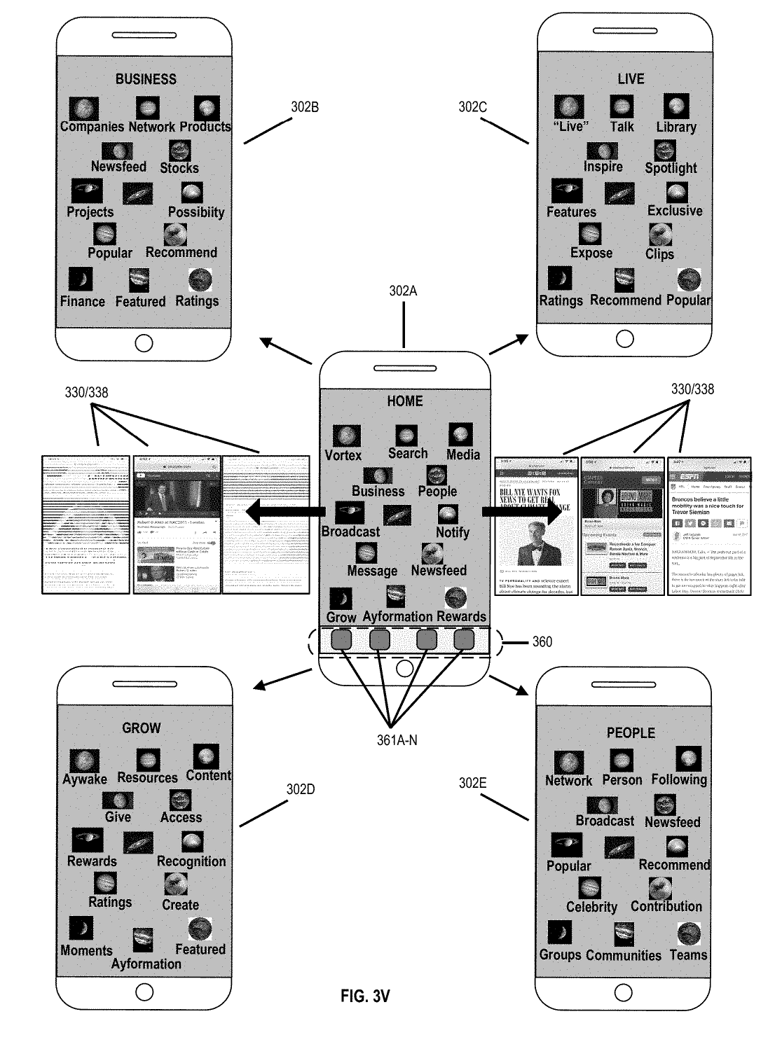

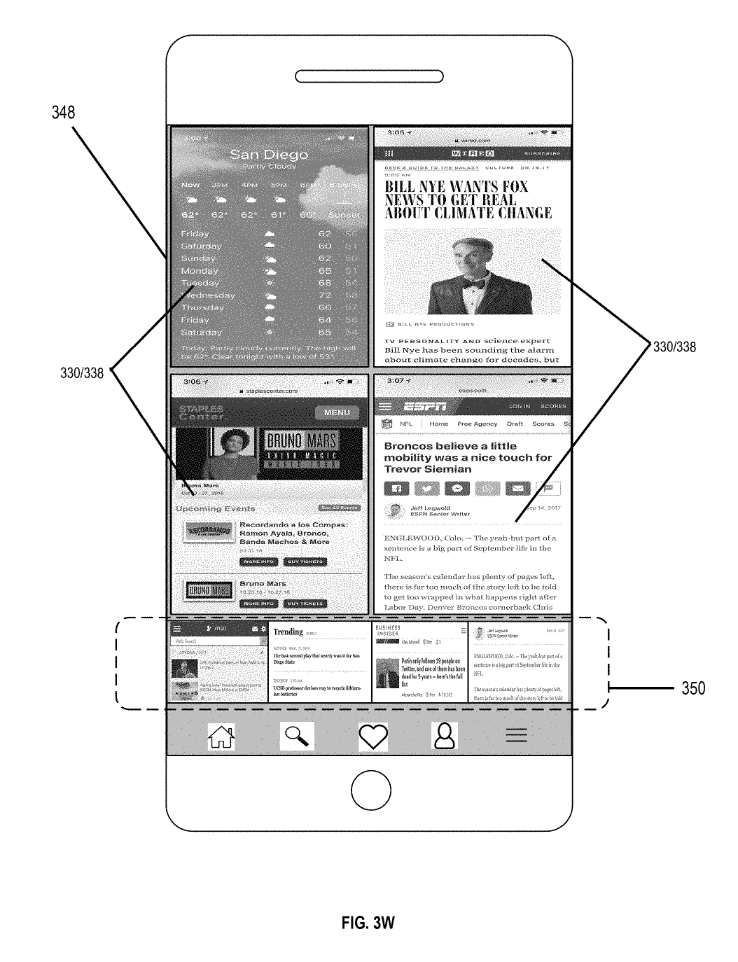

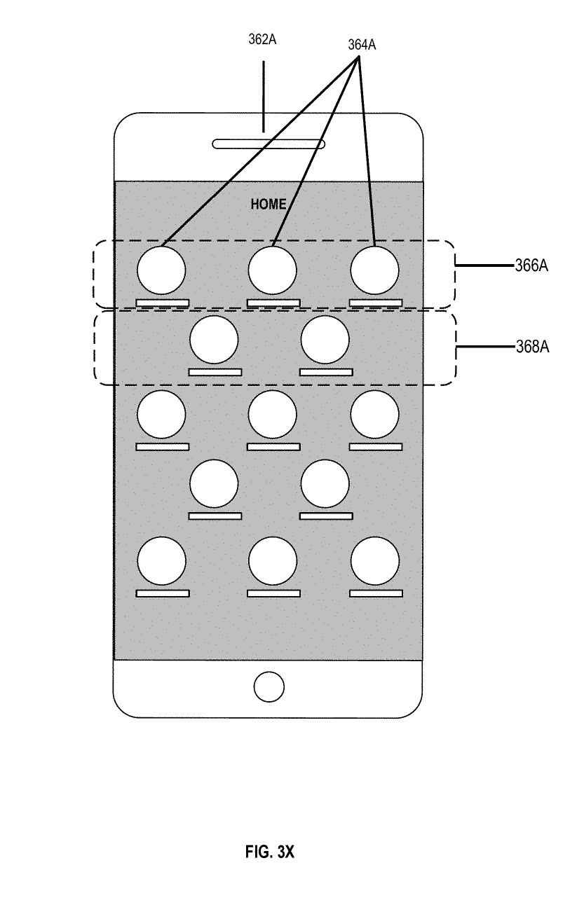

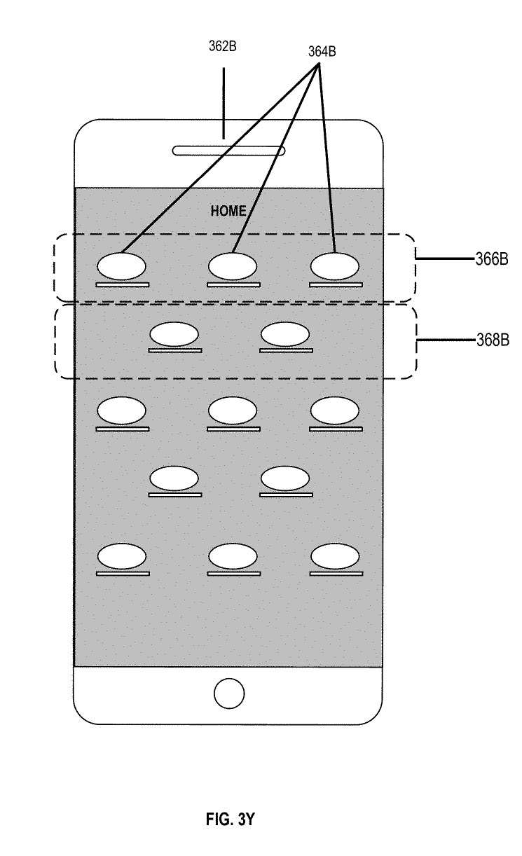

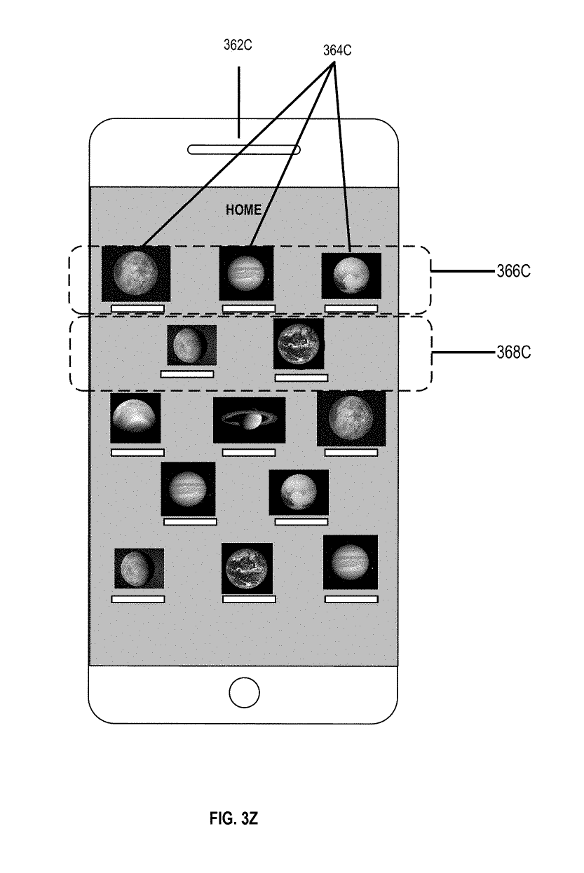

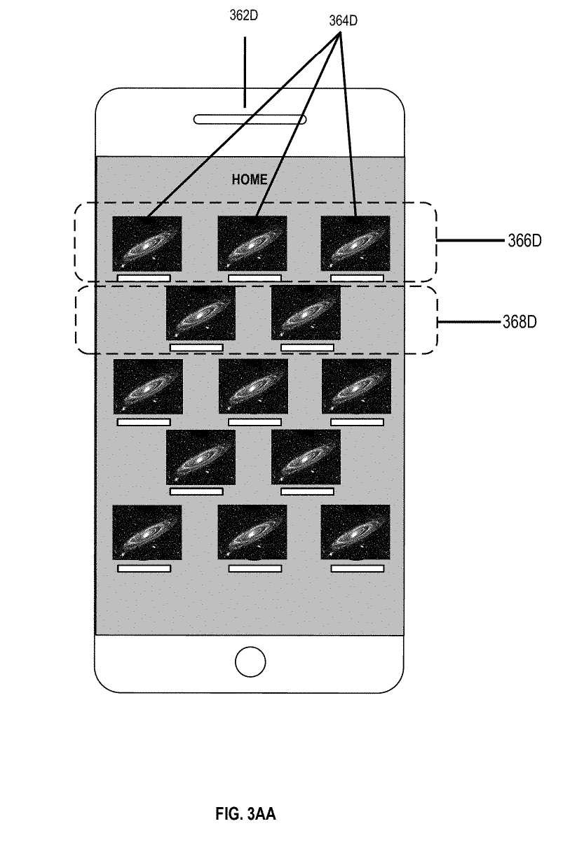

In an embodiment, the user may interact with an input (e.g., icon, link, etc.), within the native graphical user interface of user system 130, to generate an overlay on the displayed screen, through which various functions of the application may be accessed. Alternatively, the functions may be accessed directly via voice input, in which case no overlay may be generated. As an example, the user may select an icon, associated with a social-networking app module (e.g., for viewing social media on an external social-networking platform) that is included in a native screen of user system 130. By selecting the icon, a search overlay may be displayed on a currently displayed native screen of user system 130 (e.g., a screen provided by the operating system), or the currently displayed native screen may be transitioned to a search screen. The user may then perform a search. In an embodiment, at least one galaxy scroll interface (e.g., similar or identical to galaxy scroll interface 314, described with respect to FIG. 3D), content feed or home bar (e.g., content feed 350 and/or home bar 360, described with respect to FIGS. 3O-3W), or other view of search results, described herein, may be generated by the application and overlaid on the native screen of user system 130 in response to the search. The user may then interact with the search results in a manner similar or identical to the interactions described herein. In a similar manner, the user may be able to access a multi-screen view 328 and/or a multi-modal view 336, generate broadcast messages, receive alerts 344 or other notifications, utilize a content feed 350, and/or access or utilize any of the other functions described herein via native screens of the operating system on user system 130.

1.4. Example Processing Device

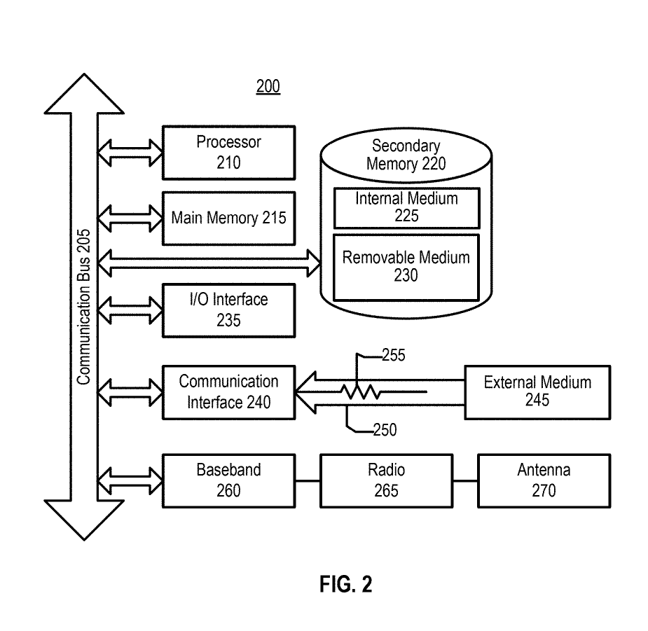

FIG. 2 is a block diagram illustrating an example wired or wireless system 200 that may be used in connection with various embodiments described herein. For example, system 200 may be used as or in conjunction with one or more of the functions, processes, and/or methods described herein (e.g., to store and/or execute the application or one or more software modules of the application), and may represent components of platform 110, user system(s) 130, external system(s) 140, and/or other processing devices described herein. System 200 can be a server, mobile device, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal memory 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, etc.

Removable storage medium 230 is a non-transitory computer-readable medium having stored thereon computer-executable code (e.g., disclosed software modules) and/or data. The computer software or data stored on removable storage medium 230 is read into system 200 for execution by processor 210.

In alternative embodiments, secondary memory 220 may include other similar means for allowing computer programs or other data or instructions to be loaded into system 200. Such means may include, for example, an external storage medium 245 and a communication interface 240, which allows software and data to be transferred from external storage medium 245 to system 200. Examples of external storage medium 245 may include an external hard disk drive, an external optical drive, an external magneto-optical drive, etc. Other examples of secondary memory 220 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules of the application) is stored in main memory 215 and/or the secondary memory 220. Computer programs can also be received via communication interface 240 and stored in main memory 215 and/or secondary memory 220. Such computer programs, when executed, enable system 200 to perform the various functions, processes, and/or methods of the embodiments described elsewhere herein.

The term “computer-readable medium” is used herein to refer to any non-transitory computer-readable storage media used to store computer-executable code (i.e., software) to system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable mediums are means for providing executable code, programming instructions, and other software to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform the functions, processes, and/or methods described elsewhere herein.

In an embodiment, I/O interface 235 provides an interface between one or more components of system 200 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 200 may also include optional wireless communication components that facilitate wireless communication over a voice network and/or a data network. The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 comprises one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also codes the digital signals for transmission and generates a baseband transmit audio signal that is routed to the modulator portion of radio system 265. The modulator mixes the baseband transmit audio signal with an RF carrier signal generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions, processes, and/or methods of the disclosed embodiments. For example, data storage areas 215 or 220 may include various software modules.

2. Example Graphical User Interface

Embodiments of a graphical user interface between a user and the social media system will now be described in detail. The graphical user interface may be generated by one or more software modules of the application (e.g., software modules of server application 112 and/or client application 132), and may be displayed on a physical display (e.g., a touch panel display) of a user system 130. The graphical user interface may comprise one or more displayable screens, such as the screens illustrated in FIGS. 3A-3AA, as well as other screens described and/or implied herein. While many of the screens of the graphical user interface will be individually described, the described screens simply represent non-limiting, exemplary embodiments of the graphical user interface. The graphical user interface may be implemented in a different manner, with fewer or more of the described screens and/or a different arrangement, ordering, and/or combination of the described screens.

The graphical user interface may be different for different user systems 130, depending on one or more characteristics of the particular user system 130 being used to view the graphical user interface (e.g., device type, display size, availability of particular input devices, processor speed, network speed, etc.). For example, the graphical user interface displayed on a mobile smartphone and/or tablet computer may be simpler and/or more compact than the graphical user interface displayed on a desktop computer, in order to accommodate the generally smaller display sizes on mobile devices. As another example, the graphical user interface displayed on a user system 130 with a touch panel display, configured to accept touch operations from a user's finger and/or stylus (e.g., touches/presses, long touches/presses, swipes, flicks, pinch-in operations, pinch-out operations, etc.), may be different than the graphical user interface displayed on a user system 130 that does not have a touch panel display. Alternatively, the graphical user interface may be identical across all user systems 130 and/or device displays. In an embodiment, the application may enable the user and/or the artificial intelligence, described elsewhere herein (e.g., the predictive model described herein), to configure the graphical user interface according to the user's specific preferences.

While user operations on the graphical user interface will primarily be described herein using touch operations, it should be understood that analogous non-touch operations may be used in place of any of the described touch operations. For example, a short touch or tap may be replaced by a click-and-release (e.g., by a mouse or other pointing device), a long touch may be replaced by a click-and-hold or a hover, a swipe may be replaced by a click-and-drag, a flick may be replaced by a click-and-drag-and-release, and so on and so forth.

In addition, any of the user operations described herein, including the selection of links or list or menu options, text input (e.g., search terms), navigation (e.g., scrolling, transitioning between screens, etc.), and/or the like, may be performed via voice input. For example, user system 130 (e.g., via client application 132, the operating system, or some other software) may receive a speech input via a microphone of user system 130, convert the speech input to a text representation via well-known speech-to-text processes, and provide the text representation to the application or a function within the application as a text input. If the context of the voice input is a text-based input (e.g., a focus within the graphical user interface is currently on a textbox input), the application may insert the text representation into the text-based input (e.g., search input 306). On the other hand, if the context of the voice input is not a text-based input, the application may match the text representation to a command (e.g., the name of a particular screen to which the application should transition, a navigation direction, etc.), and execute the matched command.

In addition, the application may support or implement any other conventional or future method of user interaction. Such methods may include augmented reality (e.g., overlaying any of the visual elements described herein over a real-time image of the user's physical environment), virtual reality (e.g., providing a virtual universe in which the user can move and with which the user can interact using conventional virtual reality gear, such as a headset, hand paddles, etc.), and/or the like.

Thus, it should be understood that any user operation of the graphical user interface described herein may refer to a touch operation to a touch panel display (e.g., by finger, thumb, stylus, etc.), an operation using a pointing device (e.g., mouse, trackball, eye tracker, etc.), an operation by voice input, and/or any other means of interacting with a graphical user interface.

It should also be understood that many, if not all, of the screens described herein may be scrollable (e.g., by swiping up or down). Thus, if there are too many elements (e.g., links, search results, list options, etc.) to be represented in a particular screen, only a portion of the elements may be initially displayed, and the user may scroll down to view more elements and scroll up to return to previously viewed elements.

In an embodiment, the graphical user interface comprises an application menu with functional and/or navigational options, including options for any of the functions and/or screens of the application described herein. In an embodiment, the application menu is an overlay menu that can be toggled between visible and hidden, or open and closed, via a user operation (e.g., selection of an omnipresent icon on each screen of the application for which the menu is appropriate, a voice input, etc.). The menu options may change depending on the context, such as the screen in which the menu was toggled to visible or opened. For example, if the application menu is opened from a first screen, it may comprise a first set of options, and, if the application menu is opened from a second, different screen, it may comprise a second set of options that is different from the first set of options. It should be understood that the set of options in one context may overlap with the set of options in a different context, and that some options (e.g., navigation to a screen for setting user preferences and/or application settings) may be present in every context. In addition, each option in the application menu may also have a voice-input command associated with it, such that a user may select options in the application menu via voice input.

2.1. Home Screens

In an embodiment, when a user starts up the application (e.g., client application 132), the application may initially display a set of one or more home screens. Alternatively, if the application requires authentication, the application may initially display a log-in screen, which prompts the user to authenticate by inputting credentials (e.g., username and password) and/or biometric information (e.g., via a fingerprint sensor on user system 130 for matching the user's fingerprint to a stored reference fingerprint, via a camera on user system 130 for matching the user's facial features to stored reference facial features, etc.), and/or by any other existing or future authentication process. Once the authentication process is complete, the application may then generate and/or display the home screen(s).

FIG. 3A illustrates an embodiment of the application which utilizes a plurality of home screens 302 (e.g., five home screens). The number of home screens 302 may be set by the application, the user, and/or both the application and the user (e.g., with the application providing a default set of home screens 302, and the user able to add to, remove from, and/or otherwise modify the default set of home screens 302). For example, the graphical user interface may comprise a settings screen which allows the user to select one or more home screens from a set of predefined themed home screens and/or add a blank home screen which the user may customize. The settings screen may also enable the user to logically arrange the selected home screens (e.g., in any desired order).

Home screens 302 may be logically arranged with a primary or initial home screen 302A, and one or more home screens 302B-302E arranged to the right and/or left of the primary home screen 302A. The user may navigate between the plurality of home screens 302 by a user operation, such as shifting a home screen 302, that is currently being displayed on the display, either right or left. For example, if home screen 302A is currently being displayed, the user may swipe right (e.g., by touching a middle or left side of the touch panel display with his or her finger and sliding the finger right), and the application may responsively transition from home screen 302A to the home screen 302B that is logically to the left of home screen 302A. In the same manner, the user may navigate from home screen 302B to home screen 302D, from home screen 302E to home screen 302C, and from home screen 302C to home screen 302A. Similarly, if home screen 302A is currently being displayed, the user may swipe left, and the application may responsively transition from home screen 302A to the home screen 302C that is logically to the right of home screen 302A. In the same manner, the user may navigate from home screen 302D to home screen 302B, from home screen 302B to home screen 302A, and from home screen 302C to home screen 302E.

Each home screen 302 may comprise one or more links 304 for accessing another screen or function of the application, such as a transition to another screen of the graphical user interface, the execution of a particular app module, the initiation of a search, a transition to search results or a set of screens (e.g., a multi-screen view or multi-modal view of search results or other set of screens), and/or the like. Each link 304 may comprise an icon and/or text indicating the target of the link 304. The group of links 304 in each home screen 302 may be determined by the application, the user, or a combination of the application and user (e.g., with the application providing a default set of links 304, and the user able to add to, remove from, or otherwise modify the default set of links 304). In an embodiment, the links 304 for each home screen 302 may be, at least partially, determined or influenced by the artificial intelligence described elsewhere herein (e.g., the predictive model described herein). For example, the artificial intelligence may determine content in which the user is likely to be interested, and provide links 304 to the determined content (e.g., to be displayed within a corresponding app module).

Each home screen 302 may have a particular theme. The theme may be indicated by an icon and/or text (e.g., at the top of each home screen 302) or in some other manner. The application may provide a set of home screens 302 with a default set of themes, and the user may add, remove, or otherwise alter this default set of themes. In the illustrated embodiment, home screens 302 comprise a home-themed screen 302A, a business-themed screen 302B, a people-themed screen 302C, a grow-themed screen 302D, and a live-themed screen 302E.

The set of links 304 to be included in each themed home screen 302 may be specified by the user and/or determined by the application. For example, the application may include a default set of links 304 in each themed home screen 302, and the user may add, remove, and/or otherwise modify the default set of links 304. Thus, the user may specify links 304 that should always appear on a given themed home screen 302. Alternatively or additionally, the application may automatically include links 304, related to a given themed home screen 302, that are most frequently used by the user, most recently used by the user, and/or otherwise suggested for the user. In this regard, the application may automatically include links 304 that are recommended for a particular user by the artificial intelligence described elsewhere herein (e.g., the predictive model described herein). Thus, in an embodiment, the set of links 304 included in a given home screen 302 for a given user may change over time (e.g., in real time) as the artificial intelligence evolves based on the user's biases. As used herein, the term “biases” refers to a user's preferences, interests, activities, interactions, transactions, and/or the like, as determined, for example, from the user's data model, described elsewhere herein.

Home-themed screen 302A may comprise links 304 related to functions that a user regularly utilizes, to which the user desires quick access, and/or to which the artificial intelligence (e.g., the predictive model described herein) suggests the user should have quick access. Accordingly, home-themed screen 302A will generally be the home screen that the user logically arranges as the initial active home screen (e.g., the first screen that is displayed when the application is started).

Business-themed screen 302B may comprise a set of links 304 related to the user's business or professional life (e.g., for facilitating business-related interactions and activities). For example, business-themed screen 302B may comprise links 304 that provide access to a subset of the user's social network that includes companies and/or other users in their professional capacities, access to a feed that provides real-time news and/or stock quotes related to the user's business or profession, access to popular, recommended, featured, and/or highest-rated content (e.g., search results) related to the user's business or profession, access to projects on which the user is currently working or which represent business opportunities to the user, access to services (e.g., service providers), goods (e.g., products), or other business-related resources, opportunities or possibilities that are available to the user and related to the user's business or profession, and/or the like.

People-themed screen 302C may comprise links 304 related to the user and/or other users activities over the network, for example, user's social network, the user's social activities, and/or other users' social activity within the application. For example, people-themed screen 302C may comprise links 304 that provide quick access to content (e.g., search results) related to people (e.g., within the user's social or business network, including people whose social media the user is following), content feeds, the user's profile and/or other users' profiles, contributions made by the user and/or other users, teams, communities, and/or other groups of which the user is a member, and/or the like. For example, a search option or link 304 on people-themed screen 302C may enable a user to perform a social search for comprehensive personal information on any given person. The artificial intelligence, described elsewhere herein (e.g., the predictive model described herein), may automatically add or suggest links 304 (e.g., links to social app modules) related to real-time activities (e.g., posts on social-networking platforms) of people of interest to the user (e.g., people whose social media the user is following). Advantageously, the provision of real-time information about people in the user's social and/or business network and/or other users may increase interactions between the user and these people via the application. In addition, links 304 on people-themed screen 302C may enable a user to view all of his or her social media simultaneously (e.g., via the multi-modal view described elsewhere herein), post to all of his or her social-networking platforms simultaneously, and/or follow a particular person across all social-networking platforms simultaneously (e.g., via the multi-modal view described elsewhere herein) and/or review information about other users, their profiles, online activities, interest, contributions, ratings, their preferred sources, recommendations, etc., using the artificial intelligence as described elsewhere herein.

Grow-themed screen 302D may comprise links 304 related to the user's personal growth. For example, grow-themed screen 302D may comprise links 304 that are suggested by the artificial intelligence (e.g., the predictive model described herein) for the particular user's personal and/or professional growth and development. Links 304 on grow-themed screen 302D may be selected and/or arranged to allow the user to review data (e.g., statistics) on his or her daily activities, and correlate that data directly to results that the user is achieving in his or her life. As an example, the artificial intelligence may determine that a user is spending too much time playing online video games (e.g., by determining that a percentage of the user's time spent playing video games exceeds a reference threshold), and responsively add links 304 to the grow-themed screen 302D to encourage the user to decrease his or her gaming time (e.g., by adding one or more links 304 to grow-themed screen 302D for articles about overcoming video game addiction) and/or use his or her time better (e.g., by adding one or more links 304 to grow-themed screen 302D for job postings, social clubs within the user's vicinity, memberships to gyms within the user's vicinity, etc.). As another example, the user may seek advice by inputting a question (e.g., inputting the search terms “I am fighting with my girlfriend” into search input 306 described elsewhere herein), and the application may provide the user with the top search results and/or other recommendations (e.g., content, people, suggested actions, etc.) in a plurality of categories of sources (e.g., using category-snapshot screen 308 described elsewhere herein). In the example that the user is seeking relationship advice, the categories, for example, of search results, may include relationship experts (e.g., profiles for users who are relationship experts), relationship-related advice, videos, vlogs, blogs, articles, books, e-books, lectures, questions and answers, case studies, and/or features, and/or the like. As yet another example, links 304 in grow-themed screen 302D may provide access to the user's achievements (e.g., earned reward tokens or tiers, recognitions received by the user, goals achieved by the user, contributions made by the user, charitable donations made by the user, etc.), access to opportunities for contributing to causes (e.g., social causes) and/or exercising global consciousness, access to content promoting causes and/or global consciousness, and/or the like. Grow-themed screen 302D may also comprise links 304 for contributing to causes (e.g., a link 304 to a portal which unites awareness and action), an accelerator for awareness and personal growth, and/or the like. In some embodiments, the artificial intelligence (e.g., the predictive model as described herein) may also ask the user additional questions related to the user's activity, and/or previous answers, and display additional results including but not limited to those above.

Live-themed screen 302E may comprise links 304 related to online content (e.g., images, videos, news articles, etc.) that the user may wish to view. For example, live-themed screen 302E may comprise links to shows, talks, events, a library, exclusives, and/or the like. For example, the shows may comprise real-time streaming events in which opinion leaders share their insights and experiences on a particular topic (e.g., business, entertainment, sports, music, finance, gaming, technology, personal growth, fashion, contributing, etc.). Each show may focus on the speaker's journey to success (e.g., including obstacles, mindsets, beliefs, etc.) and/or feature a charity or cause. Viewing users may be given the ability, via the graphical user interface, to donate to the charity or cause featured in each show. As another example, the talks, accessed via live-themed screen 302E, may feature short, targeted lectures in a particular subject matter, by experts who primarily practice a contribution-based model for building their businesses. The events may promote events which benefit humanity and/or the planet, and are designed to raise awareness about various issues. As yet another example, the library may provide dedicated positive-conscious content, designed to raise awareness and inspire achievement and contribution. In addition, exclusives may comprise a variety of content (e.g., documentaries, interviews, shows, world premieres, features, unique events, exposés, etc.) which advances the collective consciousness and culture of the users of the application.

In an embodiment, the graphical user interface comprises other themed home screens or further themed screens, which may or may not be used as home screens 302, but may at least be accessible via a link on another screen, an option in a menu, a voice input, and/or any other user operation.

In an embodiment, the graphical user interface comprises a self-improvement-themed screen. The self-improvement-themed screen may comprise links to content that is calculated to increase user awareness and effectiveness in creating the life that the user most desires. The artificial intelligence, described elsewhere herein (e.g., the predictive model described herein), may analyze the user's interactions via the application, and offer the user links to people, resources, content, and other solutions to help the user progress towards his or her desired life. For example, the self-improvement-themed screen may comprise links 304 for the spirit (e.g., content related to the subject of spirituality), mind (e.g., content related to the subject of the mind), body (e.g., content related to the subject of the Earth), and/or analytics (e.g., data related to personal use of the application by the user). Other links 304 to other areas of the graphical user interface (e.g., as described throughout this disclosure) may be included for air, ancient civilizations, animals, bridge, celebrities, cosmos, create, creation, food, moments, land, messages from the masters, most wanted, natives, voice of the people, water, we, and/or the like, including but not limited to, other people, companies, communities, teams, and/or the like.

In an embodiment, the graphical user interface comprises a business-possibilities-themed screen (e.g., via a user operation within business-themed home screen 302B). The business-possibilities-themed screen may comprise links to content that facilitates business interactions and participation. For example, the business-possibilities-themed screen may comprise links 304 for business-related opportunities, resources, finance, people, and the like, as well as possible contributions the user can make (e.g., to other users, to social causes, etc.), expert advice, ideas, investment, partnerships, positions, projects, referrals, services, and/or the like.

In an embodiment, the graphical user interface comprises a recognition-themed screen (e.g., via a user operation within grow-themed home screen 302D). The recognition-themed screen may display instances of recognition achieved by the user, friends, and/or other users, teams communities, companies and the like (for example, through the reward tokens or tiers provided by the gamification of the application, described elsewhere herein. Each new level of achievement (e.g., a new rewards tier, or accruement of a certain threshold of reward points and/or tokens) may provide the user with greater exposure to people, businesses, resources, functions, and/or the like within the application.

In an embodiment, the graphical user interface comprises a rewards-themed screen (e.g., via a user operation within people-themed home screen 302C). The rewards-themed screen may track and display a multitude of different rewards, received by the user, in all areas of growth and contribution. The rewards-themed screen may comprise links to information about ratings, recognition (e.g., the recognition-themed screen), reward tokens and/or tiers, access, and/or the like. Ratings, recognition, and rewards may be achieved by the user via his or her activity, interactions, referrals, contributions, creative contributions, service, and/or the like, within the application. A user's overall rating and/or rewards may be determined by the user's growth in awareness, completion of specific content or activities, activities, interactions recommendations, referrals, offers, donations, time spent with the application, contribution to others, contributions to companies, contributions to charities, contributions to the environment and/or the planet, and/or the like. Access refers to a user's access, promotion to, or introductions to various specific types of (e.g., levels) of people, businesses, resources, exposure, promotion, recommendations, gifts, financing, support, donations, advertising, cost-savings, functions, and/or the like within the application (e.g., based on the user's current reward tier).

In an embodiment, the graphical user interface comprises a give-themed screen (e.g., via a user operation within grow-themed home screen 302D). The give-themed screen may be designed to raise awareness to various causes and/or help the user incorporate contribution into various areas of his or her life. For example, the give-themed screen may comprise specific descriptions of current challenges in need of solutions (e.g., to be solved by the user individually or within a team of other users), portals to charities, organizations, and/or projects in need of assistance, specific ways in which a specific user can assist someone in need, and/or the like. As discussed elsewhere herein, the user's contributions may earn the user rewards (e.g., tokens, higher tiers, etc.), in addition to benefiting all involved users in achieving their goals. Contributions may include, without limitation, financial contributions, contributions of goods, services, and/or other resources (food, water, equipment, time, etc.), volunteering, education, and/or the like.

In an embodiment, the graphical user interface comprises a ratings-themed screen (e.g., via a user operation within the rewards-themed screen). The ratings-themed screen may comprise information compiled through analytics and/or feedback from other users, and may track and display the specific and overall ratings that each user (e.g., person or company) has received within the application. A user's ratings may increase as the user raises through different reward tiers (e.g., by growing and/or making contributions). The ratings-themed screen may comprise a description of the user (e.g., thumbnail image, name, title, employer, etc.), the user's reward tier, the user's contribution type (e.g., service, good, volunteering, etc.), the user's overall rating across all categories of contributions, and/or the user's specific ratings for different categories of contributions (e.g., advice, mentoring, referrals, knowledge, communication, service, etc.).

In an embodiment, the graphical user interface comprises a group-themed screen (e.g., via a user operation within people-themed screen 302C). The group-themed screen allows users to create, join, and/or interact with groups of other users (e.g., a team of users, a community of users, etc.). Groups may be categorized and displayed, within the group-themed screen, by area of interest, type, goal, intention, content, affiliations, members, projects, contributions, ratings, and/or the like.

2.1.1 Universe View

In an embodiment, each home screen 302 is visually depicted as a galaxy in the same universe. In other words, the set of all home screens 302 represent a universe, and each individual home screen 302 represents a galaxy within that universe. Each link 304 in each home screen 302 may be visually represented using an image of a virtual planet (e.g., in addition to text above and/or below the image to indicate a target of the link). Each virtual planet for each link 304, within a given home screen 302, may be different (e.g., different size, color, pattern, etc.) than any other virtual planet within the given home screen 302. In addition, each home screen 302 may comprise a black background with inlaid stars, an image of a spiral galaxy in the center, and/or the like, to convey the look-and-feel of outer space. As users navigate through screens, the screens may animate so as to provide each user with the sensation of moving through a universe of galaxies, planets, and stars.

In an embodiment, the graphical user interface enables a user to zoom in or out of each home screen 302 (i.e., zoom in or out of each “galaxy”), as well as scroll to other home screens 302 (i.e., scroll to other “galaxies” or parts of the universe). As a user zooms into a particular link 304 on a home screen 302 (i.e., zooms into a particular “planet”), the application may render the virtual planet of the link 304 at greater detail (e.g., similar to Google Earth™) Similarly, as the user zooms out from a particular link 304 on a home screen 302, the application may render the virtual planet of the link 304 at lesser detail.

Furthermore, when a user holds down a virtual planet of a link 304 (e.g., using a long touch) within a home screen 302, that region of the home screen 302 may open into a detailed menu of all related links (e.g., other sections of the universe) and functions.

In an embodiment, the graphical user interface allows a user to track his or her personal location within the universe by displaying an indicator (e.g., blip of light) within the graphical user interface. For example, the indicator may highlight a link 304 in a home screen 302 that represents a function or section (e.g., “galaxy” or “planet”) which the user, or other users, is currently utilizing or in which the user is currently active.

In addition, in a similar manner, users may be able to see the location of other users (e.g., family, friends, members of a team, community, or other group of which the user is a member, members of the user's personal or business network, etc.). The application may incentivize users to opt in to this feature that allows other users to track them in this manner, by providing rewards in exchange for the user opting in to the feature.

2.1.2 Snapshot

In an embodiment, the graphical user interface may enable a user to search from one or more of home screens 302 and/or any other screens described herein. For example, the user may initiate a search by selecting a “search” link 304 to a search engine via a user operation (e.g., tap or voice input), selecting (e.g., tapping) an open region (e.g., where no links 302 are positioned) on home screen 302, selecting a search option in the application menu, and/or the like.

As illustrated in an embodiment in FIG. 3B, when a search is initiated, a search input 306 may be overlaid on the currently displayed screen (e.g., currently active home screen 302). A user may utilize the keyboard (e.g., a virtual keyboard that is automatically displayed on a touch panel display by the operating system whenever the user focuses on a textbox) or voice input to input search terms into search input 306. In response to submission of the search terms (e.g., in real-time as the search terms are being input, or after the user indicates completion of the search terms by selecting a link or virtual button), the search terms are input to a search engine which produces relevant search results based on the search terms, as described elsewhere herein. The search engine may utilize the artificial intelligence, described elsewhere herein (e.g., the predictive model described herein), to provide the most relevant search results for the particular user (e.g., according to the user's biases). Thus, the search results for the same search terms may be different for different users.

In addition, the search engine may search across all content sources (e.g., the World Wide Web, all social-networking platforms, media galleries locally stored on user system 130, media galleries stored remotely from user system 130 in the cloud or on a server, etc.) to simultaneously provide search results across all media sources. In an embodiment, when the search is initiated from a particular themed screen (e.g., home screen 302), the search may only be performed on the sources for which a link 304 is included in the particular themed screen. In other words, the user may perform a search across the subset of content sources linked to within the themed screen being searched. Alternatively, searches may always be performed across all content sources.

In an embodiment, the application presents the search results in a category-snapshot screen 308, as illustrated in an embodiment in FIG. 3C. Specifically, the application groups the search results into categories, and category-snapshot screen 308 provides links 310 to each of the categories of search results. In an embodiment, the categories may overlap, such that a particular search result may be included in more than one category. Alternatively, the categories may not overlap, such that a particular search result is never included in more than one category.

The categories to be included in category-snapshot screen 308 may be determined by the user and/or the application. For example, some categories may always be included in category-snapshot screen 308 (e.g., as specified by the user or set by the application), whereas some categories, to be included in category-snapshot screen 308, may be determined by the artificial intelligence (e.g., the predictive model described herein).

In an embodiment, the categories represented in category-snapshot screen 308 may include, without limitation, one or more of the following:
Preferred Sources: comprises search results from sources that the user and/or other users prefer (e.g., sources most frequently and/or recently used by the user). The user may specify (e.g., via a profile or settings screen of the graphical user interface) his or her preferred sources (e.g., app modules, websites, brands, retailers, providers, and/or the like).
Recommended: comprises search results that are recommended to the user, for example, by other users within the user's social network and/or the artificial intelligence described elsewhere herein (e.g., the predictive model described herein). In an embodiment, the user may specify the subset of users that should be used to determined recommendations (e.g., only friends, users within the user's social network, users within the user's business network, users within a particular team, community, or other group, users within a vicinity of the user's location or other specified location, etc.).
People: comprises search results related to people (e.g., all users), which the user has recommended, or which have been recommended by other users, for example, within the user's social network and/or which the user follows (e.g., on one or more social-networking platforms), business network, shared community, or any other user, company, team, group, or community In an embodiment, the user may specify the criteria for determining the relevant people. For example, these criteria may comprise the person's experience level, skill level, number of recommendations, ratings, rewards, amount of contributions, and/or the like.
Popular: comprises search results that are the most popular to the user, to other users, companies, teams, groups, communities, and the like (e.g., most frequently accessed by other users within the user's social network).
Highest-Rated: comprises search results that are the most highly rated by other users (e.g., within the user's social network).
Highest-Contribution: comprises search results related to the users, or to other users (e.g., companies) with the highest contributions towards one or more objectives of the application (e.g., contributions to social or global causes) and/or towards the specific subject being searched.
Snapshot: special category that comprises the top search result from every other category represented on category-snapshot screen 308.

The categories to be included in category-snapshot screen 308 may, at least in part, be determined, by the artificial intelligence (e.g., the predictive model described herein), based on the search terms. As an example, if the user inputs the search terms “Barcelona, Spain,” the application may automatically determine that the search terms relate to a particular location (i.e., a city) which is not already the user's current location, and include categories relating to that location and travel, such as a “food” category for search results relating to restaurants in or around Barcelona, a “fly” category for search results relating to travel (e.g., available flights, ticket purchases, etc.) to Barcelona, a “stay” category for search results relating to accommodations (e.g., available hotel rooms, bed and breakfasts, etc.) available in or around Barcelona, and/or the like. In addition, other categories, included in category-snapshot screen 308, may comprise a “people” category for people, within the user's social network, who are currently residing or are traveling in or around Barcelona, a “newsfeed” category for search results relating to news about Barcelona, a “recommended” category for recommend search results pertaining to Barcelona, a “popular” category for popular search results pertaining to Barcelona, a “highest-rated” category for the highest-rated search results pertaining to Barcelona, a “featured” category for featured search results pertaining to Barcelona, and so on and so forth. Thus, advantageously, the user is provided with quick and easy access to the most relevant and useful categories of search results.

The categories in category-snapshot screen 308 may be arranged according to a user-specified, application-determined, and/or artificial-intelligence-driven priority. Categories with higher priority may be displayed more prominently in category-snapshot screen 308 (e.g., nearer to the top and/or center), whereas categories with lower priority may be displayed less prominently in category-snapshot screen 308 (e.g., nearer to the bottom and/or edges).

Link 310 to each category may be visually represented by an icon or thumbnail image. In an embodiment, the icon or thumbnail image for a given category is a portion of, or otherwise indicates or is related to, the top search result in that category. Since the snapshot category is a special category, link 310A for the snapshot category may be visually represented by an icon or thumbnail image that is larger than those for links 310B for the other categories and/or otherwise displayed more prominently than the other links 310B. In addition, the icon or thumbnail image for link 310A, representing the snapshot category, may comprise a portion of, or otherwise indicate or relate to, the top search result across all of the categories.

In an embodiment, each link 310 is selectable. A user may select a plurality of categories by selecting their respective links 310, to view the search results in each of the selected categories. In such an embodiment, the user may select one or more of links 310 and then perform a user operation (e.g., by selection of a link or virtual button, by voice input, etc.) to finalize the selection and cause the application to transition to a results screen (e.g., snapshot-results screen 312). Alternatively, the application may transition to a results screen as soon as the user selects one of links 310, in which case the search results for only a single category (i.e., the selected category) will be displayed in the results screen at any given time.

2.1.3 Galaxy Scroll Interface

FIG. 3D illustrates an embodiment of a snapshot-results screen 312. The application may transition from category-snapshot screen 308 to snapshot-results screen 312 in response to a user finalizing a selection of one or more categories represented in category-snapshot screen 308. Snapshot-results screen 312 may comprise an input for returning to category-snapshot screen 308 (e.g., so that a user may change the selection of categories).

As illustrated, snapshot-results screen 312 comprises a galaxy scroll interface 314 for each of the selected categories. Each galaxy scroll interface comprises a “carousel” of search results. Initially, the top search result for the category may be visually represented in the center position of the carousel. The visual representation of the top search result may be the same as the visual representation for the link 310 which represented the category on category-snapshot screen 308.

Whichever search result is represented in the center position of the carousel may be distinguished from the other search results in other positions in the carousel (e.g., by a highlighted border, an enlarged size, etc.), and text describing that centrally-positioned search result may be displayed above and/or below the carousel within the galaxy scroll interface 314. For example, if galaxy scroll interface 314A represents the “fly” category of a search for “Barcelona, Spain,” the centrally-positioned search result may be an available airline ticket to Barcelona, and the description may comprise the airline information (e.g., departure and arrival airports, departure and arrival times, cost of the ticket, duration of the flight, number of layovers, etc.). If galaxy scroll interface 314B represents the “snapshot” category, the centrally-positioned search result may be information about Barcelona, and the description may comprise a synopsis or portion of that information (e.g., conveying that Barcelona is the capital city of Catalonia in Spain). If galaxy scroll interface 314C represents the “people” category, the centrally-positioned search result may be a personal profile of someone within the user's social network who lives in Barcelona, and the description may comprise information about that person (e.g., name, position, relationship to the user, etc.).

The text used to describe the centrally-positioned search result may be biased by the artificial intelligence (e.g., the predictive model described herein) for the user, for example, to present the information that the specific user, viewing the galaxy scroll interface 314, will find most relevant. In addition, it should be understood that the search results may be biased by the artificial intelligence, described elsewhere herein. For example, the airline information, provided in the “fly” category, may be biased towards presenting available airline tickets for a window seat (e.g., if the user's biases indicate that the user prefers a window seat), a middle seat (e.g., if the user's biases indicate that the user is an extrovert), or an aisle seat (e.g., if the user's biases indicate that the user has an enlarged prostate or other disorder that may require frequent bathroom trips), depending on the particular user's preference.

As illustrated in FIG. 3D, within each galaxy scroll interface 314, the visual representation of the search result in the center position may have the largest size, with each visual representation of a search result, extending to the left and the right of the center position, decreasing in relative size the farther they are from the center position. Only a subset of the search results in the corresponding category may be visually represented in the carousel at any given time (e.g., the top five, top ten, top twenty, etc.). A user may navigate through the search results by “spinning” the carousel. For example, the user may spin the carousel to the right by swiping right on the carousel and spin the carousel to the left by swiping left on the carousel. When the user spins the carousel one position to the right, the visual representation of the search result, positioned immediately to the left of the center position, will move into the center position, while the visual representation of the search result, positioned in the center position, will move to the position immediately to the right of the center position. In other words, all of the visual representations of search results in the carousel will shift one position to the right. In addition, if the amount of search results in the corresponding category is greater than the amount of search results that can be displayed in the carousel at a given time, the visual representation of a new search result will appear at the left-most position in the carousel, while the visual representation of the search result in the right-most position of the carousel disappears. When the user spins the carousel one position to the left, the carousel will change in a similar manner, except that each visual representation of a search result will shift one position to the left, and a new visual representation may appear at the right-most position of the carousel, while the visual representation in the left-most position of the carousel disappears. The amount that the carousel spins (i.e., the number of positions each visual representation shifts for a given user operation) may be proportional to the speed and/or distance of the user operation (e.g., a swipe or flick).

The carousel of each galaxy scroll interface 314 may logically arrange the search results in a circle, such that, if a user spins the carousel far enough to the right, a visual representation of a search result on the right side of the carousel will eventually disappear and appear again on the left side of the carousel, and, if the user spins the carousel far enough to the left, a visual representation of a search result on the left side of the carousel will eventually disappear and appear again on the right side of the carousel. In an embodiment, the application may limit the number of search results in each carousel to a predetermined maximum (e.g., ten) in order to provide only the most relevant (e.g., top-ten) search results to the user. Advantageously, this can prevent the information overload inherent in conventional search results, and quickly direct the user to the most relevant information.

A user may select a particular search result visually represented within a center position of one of galaxy scroll interfaces 314 (e.g., by tapping the visual representation in the center position). In response, the application may transition to a screen for presenting the selected search result. If the search result is related to a particular app module, the application may execute the app module to display a screen that presents the search result to the user. Snapshot-search-result screen 316 in FIG. 3E is an example of such a screen within a web browser app module.

In an alternative embodiment, the application may transition directly from a search input to snapshot-results screen 312, instead of category-snapshot screen 308. In this case, each category will be displayed with its own galaxy scroll interface 314. Each galaxy scroll interface 314 may be as illustrated in FIG. 3D, or may be more similar to results feed 320 or content feed 350 (i.e., without the carousel design), described elsewhere herein. Thus, a user may scroll up and down through various categories, such as preferred sources of content (e.g., such as sources of information, brands, retailers, service providers, and/or the like, that have been preselected by the user and/or determined by the artificial intelligence, for example, the predictive model described elsewhere herein), recommended search results (e.g., recommended by other users or groups of users within the user's social network), most popular search results (e.g., as determined by other users' interactions), location-relevant search results (e.g., based on geographic location(s) set by the user, the search, and/or the artificial intelligence), highest-rated search results (e.g., based on ratings by other users within the user's social network), highest-contribution search results (e.g., related to users with significant contributions), web results (e.g., results from the World Wide Web), recommended people (e.g., profiles or websites of people who are relevant to the search), and/or the like. The user may also scroll right and left to view each search result represented in the particular galaxy scroll interface 314 for a category of search results. The arrangement of the various categories (e.g., order of display, which categories to include in the screen, etc.) may be set by the user.

2.1.4 Results Feed

FIG. 3E illustrates an embodiment of a snapshot-search-result screen 316 for displaying a search result, selected via snapshot-results screen 312. Snapshot-search-result screen 316 may comprise a region 318 that displays the selected search result and a results feed 320. Region 318 may be a screen that is generated by an app module corresponding to the selected search result. While region 318 is described herein with reference to a search result, it should be understood that region 318 may comprise any content or data based on or in response to any one or more of the functions described herein.

In an embodiment, results feed 320 comprises a link for each category in category-snapshot screen 308. These links may be visually represented in the same manner as links 310 in category-snapshot screen 308 (e.g., the same icon or thumbnail image). If there are more categories than can be visually represented in results feed 320 at any given time, results feed 320 may be scrollable, such that a user can navigate to the right or left (e.g., by swiping left or right, respectively) to reveal the visual representations of more categories. In some embodiments, the results feed 320 may be substantially similar to the content feed described herein (e.g., in connection to FIGS. 3O-3S).

When a user selects a visual representation of a category in results feed 320, the application may transition back to snapshot-results screen 312, which may then include a galaxy scroll interface 314 for the selected category. A user may select a plurality of categories for presentation on snapshot-results screen 312 via results feed 320. Alternatively, the user may only be able to select a single category at a time for presentation on snapshot-results screen 312 via results feed 320. As another alternative, when the user selects a visual representation of a category in results feed 320, the application may instead display the top search result from the selected category in region 318.

Advantageously, results feed 320 enabling a user to quickly scan and access top search results from the most relevant categories, without disrupting the user's view of a selected search result in region 318.

2.1.5 People Search

In an embodiment, the search function may be different when the search is initiated from different themed home screens 302. Alternatively, different search options may be available via different links 304.

FIGS. 3F and 3G illustrate an embodiment of a “people” search, which may be different than the general search described with respect to FIGS. 3B-3D (e.g., initiated by selection of a “search” link 304 on home-themed home screen 302A). For example, the people search may be initiated by selection of a “search” link 304 on people-themed home screen 302C, by inputting search terms which the application determines to be a person's name, and/or by some other manner.

The people search may be a more targeted search for information, related to a specific person (e.g., friend, family, coworker, celebrity, company, charity, or other organization, etc.), from only a person-related subset of available sources (e.g., only social-networking platforms). As illustrated in an embodiment in FIG. 3F, when a user inputs a name as search terms into search input 306, the screen may display a visual representation 322 of the person (e.g., a thumbnail image of the person), who matches the name, in the screen (e.g., in the center of the screen), and/or the name of the person (e.g., at the top of the screen). In addition, links 304, related to that person—including, without limitation, links 304 for viewing the person's network (e.g., the person's personal and business networks by location, interests, etc.), the person's user profile, who the person is following, broadcasts by the person, news feeds regarding the person, popular, recommended, and/or highest-rated information pertaining to the person, the person's relationship to the user, as well as additional information, and content (e.g., the degree of separation between the person and the user), areas for which the person is recommended (e.g., as an adviser, content source, service provider, etc.), recommendations by the person, other users who recommended the person, and/or the like—may be displayed around the visual representation 322 of the person. The artificial intelligence, described elsewhere herein (e.g., the predictive model described herein), may automatically customize the set of links 304 in the screen, related to the matched person, according to the searching user's biases.

Alternatively or additionally, assuming that the matched person is a user of the application, the matched person may select which links 304 are available and displayed to searching users. In this case, the application may enable users to opt in or opt out of allowing other users to have access to particular content (e.g., the user's social network, content feeds, etc.) and/or functions related to the user. The application may incentivize users to opt in to allowing as much access as possible by providing rewards in exchange for each access to which the user opts in.

The set of links 304 may comprise, without limitation, links 304 for viewing the matched person's social network, user profile, other people whom the matched person is following, the matched person's broadcasts, teams, communities, or other groups, the matched person's contributions, rewards, ratings, or recognitions, the matched person's content feeds, the matched person's activities, a feed of news articles about the matched person, recommended, popular, featured, and/or highest-rated content about the matched person, and/or the like. Advantageously, the screen, with its person-specific, user-customized links 304, permits the user to quickly search the matched person's activities (e.g., online activities, for example, within social-networking platforms), interact with the matched person (e.g., via a social-networking platform), and access relevant and useful information about the matched person, in a manner that is most appropriate for the particular user.

In response to a user selection of one of the links 304, related to the matched person, the application may transition to a screen with person-specific information for the selected link 304. FIG. 3G illustrates an embodiment of a social-snapshot screen 324 for viewing social media of a matched person. Social-snapshot screen 324 has a similar layout to category-snapshot screen 308. However, instead of visually representing categories of search results, social-snapshot screen 324 comprises visual representations of links 326 to app modules for each social-networking platform associated with the matched person. Advantageously, this enables a user to quickly scan and access the matched person's activities on all associated social-networking platforms, thereby increasing interactions and connections between the user and the matched person. Social-snapshot screen 324, and any other snapshot screen for a specific matched person, may comprise visual representation 322 of the matched person, surrounded by relevant links 326.

In response to a user selecting one of links 326, the application may execute an app module to display a screen for presenting content to the user. In the case of social-snapshot screen 324, when a user selects a link 326, the application may execute the social-networking app module associated with the selected link. The social-networking app module may provide a screen that displays the matched person's activities on the corresponding social-networking platform. For example, if the user selects a link 326 for Twitter™, the application may execute a specific app module for Twitter™ that displays the matched person's tweets (e.g., in order from most recent to least recent). Similarly, if a user selects a link 326 for Facebook™, the application may execute a specific app module for Facebook™ that displays the matched person's Facebook™ posts.

FIG. 3H illustrates an embodiment of a screen for summarizing a matched person's network. A user may access this screen by selecting a link 304, resulting from a person search, from people-themed screen 302C in FIG. 3F. As illustrated, the screen may comprise a representation of the matched person (e.g., thumbnail image and name of the matched person), and a summary of the matched person's business network. For example, the summary may comprise a list with rows conveying a category (e.g., an industry or profession) and the number of contacts that the matched person has in that category. Advantageously, this summary enables a user to quickly identify resources available to the user, via the matched person, and increases the potential for a connection between the user and the matched person or the matched person's contact(s).

In an embodiment, users may have access, within the application, to information about the real-time activities and effects that other users (e.g., people and companies) are having on society and/or the planet. For example, as discussed elsewhere herein, user interactions may be indelibly recorded in a blockchain, which may be visible to certain users or all users. The level of access to, or visibility of, a first user's activities to a second user may be defined by the application (e.g., according to a reward tier of the second user) and/or the first user.

In an embodiment, a user may utilize the people search to add new connections to his or her social network. For example, the user may search for users, who are not yet within the user's social network, by viewing, searching, and/or requesting recommendations from other users within the user's social network. The user may request and receive recommendations for a new contact from a subset of the user's social network (e.g., via the exchange discussed elsewhere herein), such as the user's friends, personal network, business network, and/or the like. Alternatively or additionally, the user may view recommendations, identified by the artificial intelligence (e.g., identified by the matching algorithm from an explicit or inferred need), based on interactions between potential new contacts and the subset of the user's social network. In either case, the user may view, filter, and/or search (e.g., by keyword) the recommendations for potential contacts by interests, location, memberships (e.g., within a team, community, or other group), ratings, contributions (e.g., based on earned rewards or some other contribution index), popularity, and/or the like. In addition, the application may flag potential contacts with which users, within the user's social network, have had a negative interaction (e.g., bad personal experience). Essentially, such a flag represents a negative recommendation or non-recommendation. A user may select one or more potential contacts from a screen of the graphical user interface, and attempt to establish a direct connection, within the user's social network, with those contact(s) via an invitation-and-acceptance function. However, unlike conventional invitation-and-acceptance functions, in an embodiment, the invitation-and-acceptance function of the application may be provided in the context of the exchange, described elsewhere herein, such that the interaction and/or consummated transaction may be recorded in the blockchain.

2.2. Multi-Screen View & Search

In an embodiment, the application provides a multi-screen (“Vortex”) view that enables a user to view and easily navigate a plurality of screens generated by an app module.

2.2.1 Multi-Screen View

FIG. 3I illustrates an embodiment of the application which utilizes a multi-screen view 328 comprising a plurality of module screens 330A-330E. The number of module screens 330 may be set by the application, the user, and/or both the application and the user (e.g., with the application providing a default set of module screens 330, and the user able to add to, remove from, and/or otherwise modify the default set of module screens 330). For example, the user may specify how many module screens 330 should be open at any given time. In addition, the application may allow the user to specify the number of modules screens 330 to be positioned to the right and left of the initially active module screen 330A, and the number of module screens to the right and to the left may be different from each other (e.g., three to the right and five to the left, etc.).

Alternatively or additionally, the number of module screens 330 in a particular multi-screen view 330 may be variable and dictated by the function being used to populate module screens 330 and/or the current context of the application. For example, the number of module screens 330 in a particular multi-screen view 328 may depend on a number of search results, a number of open app modules being executed (e.g., opened by the user), the artificial intelligence described elsewhere herein (e.g., based on a user preference and/or suggested by the artificial intelligence), and/or the like. Thus, while only five module screens 330 are illustrated, the number of module screens 330 may be any number (e.g., two, three, four, ten, twenty, thirty, etc.).

In the illustrated example in FIG. 3I, module screen 330A may be referred to as an “active” screen, since it is currently being displayed on the display of user system 130. The user is able to view and interact with the currently active module screen 330A, for example, by swiping up and/or down to scroll within that module screen 330A, selecting inputs within module screen 330A, inputting text into module screen 330A, and/or the like. Modules screens 330B-330E may be referred to as “inactive” screens since they are not currently being displayed on the display. However, as discussed elsewhere herein, inactive module screens 330B-330E may be generated and cached at the same time as active module screen 330A for quick navigation. In this manner, multi-screen view 350 may enable users to quickly navigate through a plurality of module screens 330.

Module screens 330 may be arranged with an initial active module screen 330A that is displayed on the display of user system 130, and one or more screens 330B-330E arranged to the right and/or left of initial active module screen 330A. The user may navigate between the plurality of module screens 330 by shifting a module screen 330, that is currently displayed on the display, either right or left. For example, if module screen 330A is currently being displayed as the active module screen, the user may navigate left by swiping right (e.g., by touching a middle or left side of the touch panel display with his or her finger and sliding the finger right), and the application may responsively transition from module screen 330A to the module screen 330B that is logically to the left of module screen 330A. In the same manner, the user may navigate from module screen 330B to module screen 330D, from module screen 330E to module screen 330C, and from module screen 330C to module screen 330A. Similarly, if module screen 330A is currently being displayed as the active module screen, the user may navigate right by swiping left, and the application may responsively transition from module screen 330A to the module screen 330C that is logically to the right of module screen 330A. In the same manner, the user may navigate from module screen 330D to module screen 330B, from module screen 330B to module screen 330A, and from module screen 330C to module screen 330E.

In an embodiment, a user may arrange or rearrange module screens 330. For example, the user may select one or more module screens 330, and shift the selected module screen(s) 330 to another position. Specifically, the user may navigate to module screen 330B. The user may select module screen 330B via a user operation (e.g., selection of an option in the application menu, selection of an input within the screen, etc.), drag module screen 330B from between module screens 330A and 330D to a new position between module screens 330A and 330C, and release module screen 330B at the new position. It should be understood that this is only one example, and other arrangements and manners of modifying arrangements are possible. In addition, the user may designate any of module screens 330 to be the initial module screen 330A.

Each module screen 330 may represent a screen being generated by an app module. The application may execute a particular app module to generate a plurality of screens from the app module, which populate module screens 330. As an example, the application may execute a web-browser app module that generates a plurality of webpages as module screens 330.

In an embodiment, the application may simultaneously execute multiple instances of a single app module, such that inactive module screens 330B-330E can be continuously updated in real time in the background, simultaneously with the active module screen 330A, as if active themselves. In other words, each module screen 330 may be contemporaneously rendered prior to being navigated to by the user and cached for quick retrieval during user navigation. Thus, advantageously, the application can quickly render a previously inactive module screen 330, as soon as a user navigates to it, without the delay that would normally be necessary to download the data needed to generate the screen.

Alternatively, the application may download the data necessary to generate each inactive module screen 330B-330E, but wait to generate a given inactive module screen until the user actually navigates to that module screen. In other words, each module screen 330 may be generated and rendered upon being navigated to. In this case, each module screen 330 may be cached after being displayed for the first time, such that the cached module screen 330 can be quickly retrieved and displayed in response to future navigations.

In an embodiment, while navigating between the plurality of module screens 330, a subset of the plurality of the module screens 330 may be displayed on the display of the user system 130 and active simultaneously. For example, three module screens 330 may be displayed simultaneously while the user swipes right or left among the plurality of module screens 330. The user may interact with each of the displayed module screens, for example, by scrolling within each module screen 330. While the above example describes three module screens 330 displayed simultaneously, it will be appreciated that any number of modules screens 330 may be displayed. Alternatively or additionally, during navigation between module screens 330, the inactive module screens may be displayed in a low resolution or “fuzzy” manner until selected as the active module screen.

It should be understood that the user may specify the content or type of content with which each module screen 330 is populated. The application may retrieve data for generating module screens 330 through any interface and/or using any standard communication protocols (e.g., via an HTTP GET request, via a call to a subroutine of an API, etc.). In an example implementation, the particular module screens 330 to be generated may be search results of a multi-screen search, as described below in more detail, such that each module screen 330 represents a different search result. In this case, the collection of module screens 330 may represent a variable or predetermined number of the top search results (e.g., top five, top ten, etc.) for a particular user (e.g., as determined by the user and/or artificial intelligence described elsewhere herein, for example, the predictive model described herein). While the following examples are made with reference to a web-browser app module, other app modules may generate screens for multi-screen view 328 in a similar or identical manner. For example, an image-viewing app module may generate a multi-screen view 328 with a plurality of images (e.g., from a photographic roll or album stored in local memory of user system 130 and/or remotely online), an app-store app module may generate a multi-screen view 328 of available app modules for use within the application (e.g., as search results of the Apple® App Store, Google Play®, etc.), a social-networking app module may generate a multi-screen view 328 of social media posted on a social-networking platform (e.g., by a particular user, regarding a particular topic, containing a particular tag, etc.), and so on and so forth.

2.2.2 Multi-Screen Search

In an embodiment, a user may execute a multi-screen search from one or more screens (e.g., home screens 302, the application menu, etc.). For example, the user may initiate a multi-screen search by selecting a “multi-screen search” link 304 to a search engine via a user operation (e.g., tap or voice input), selecting (e.g., tapping) an open region (e.g., where no links 304 are positioned) on home screen 302, selecting a search option in the application menu, and/or the like.

As described above in connection to FIG. 3B, when a search is initiated, a search input 306 may be overlaid on the currently displayed home screen 302. A user may utilize the keyboard (e.g., a virtual keyboard that is automatically displayed on a touch panel display by the operating system whenever the user focuses on a textbox) or voice input to input search terms into search input 306. In response to submission of the search terms (e.g., in real-time as the search terms are being input, or after the user indicates completion of the search terms by selecting a link or virtual button), the search terms are input to a search engine which produces relevant search results based on the search terms, as described elsewhere herein. In an embodiment, the multi-screen search may search across one app module or multiple app modules (e.g., a multi-modal search). Thus, in an embodiment, a user or the artificial intelligence (e.g., the predictive model described herein) may select one or more app modules for performing the search.

In an embodiment, the application presents the search results in a multi-screen view 328, as illustrated in an embodiment in FIG. 3I. Specifically, the application may retrieve a plurality of search results, and populate each of a plurality of module screens 330 with a different one of those plurality of search results. For example, the application may execute the app module(s) that will be used to generate module screens 330 for the multi-screen search results, retrieve a set of search results (e.g., a top number of search results) and/or the data necessary to render each search result, and execute the app module(s) to populate each module screen 330 with the content of a different search result.

How the search results are populated into module screens 330 of multi-screen view 328 may be determined by the user and/or the application. For example, the search result to be populated into the initial active module screen 330A may be determined based on a preference or suggestion (e.g., as determined by the artificial intelligence). This search result may be the top search result, the top search result from a particular app module (e.g., determined by the user and/or artificial intelligence), a search result from a particular source (e.g., determined by the user and/or artificial intelligence) within a particular app module, a recommend search result, a most popular search result, a highest-rated search result, and/or the like.

In an embodiment, the application may initially populate the top search result into active module screen 330A, the second top search into an inactive module screen 330 (e.g., module screen 330B) that is logically adjacent to active module screen 330A, the third top search result into an inactive module screen 330 (e.g., module screen 330C) that is also logically adjacent to active module screen 330A but on a different logical side of active module screen 330A than the inactive module screen 330 (e.g., module screen 330B) in which the second top search result is populated, the fourth top result into an inactive module screen 330 that is logically adjacent to the inactive module screen 330 into which the second or third top search results are populated, and so on and so forth. Generally, the closer a module screen is to the initial active module screen 330A, the more relevant the populated search result may be. Conversely, the farther a module screen is from initial active module screen 330A, the less relevant the populated search result may be.

As another example, each of one or more module screens 330 (e.g., the active module screen 330A) may always be populated by a search result from a particular content source (e.g., as specified by the user or set by the application) available to an app module, whereas other module screen(s) 330 may be determined by the user, by artificial intelligence described elsewhere herein (e.g., the predictive model described herein), and/or by any other means. For example, in the case of a web-browser app module, which generates one or more module screens 330 that each comprise a webpage representing a search result, at least one of the webpages may always be retrieved from a particular source (e.g., a search result from Wikipedia.org). In this manner, the user may always be presented with at least one search result from a preferred or suggested source.

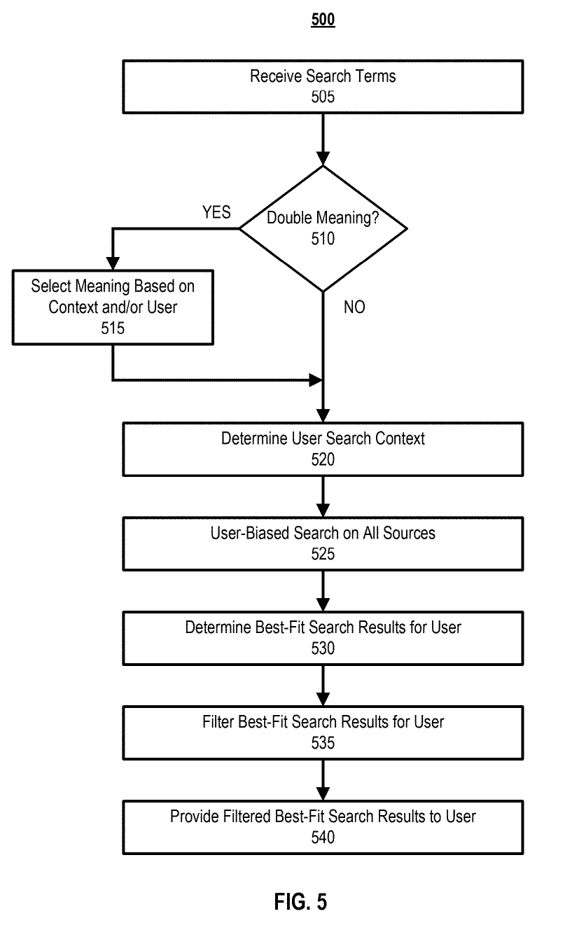

As an example of the multi-view search, if the user inputs the search term “Apple” (e.g., into search input 306), the application (e.g., the artificial intelligence, for example, described with respect to process 500 in FIG. 5) may automatically determine that the search term relates to the company Apple™ Inc. (e.g., as opposed to the fruit). The application may also determine that the user prefers certain websites for information (e.g., Wikipedia™, Bloomberg™, CNN™ etc.). Additionally, the application may determine that Apple's home page may also be relevant, based on the search terms. The application may then execute one or more app modules to retrieve data for generating a plurality of module screens 330 that each represent a search result (e.g., from a different content source). In one example, the application may determine (e.g., as specified by the user, set by the application, or based on artificial intelligence) that the user has a particular preference for Wikipedia™, and render the initial module screen 330A with a search result obtained from Wikipedia.org (e.g., using the search term “Apple”, including a disambiguation for the company “Apple Inc.”).

As mentioned above, multi-screen view 328 may generate module screens 330 from types of app modules, other than a web-browser app module. For example, FIG. 3J illustrates a multi-screen view 332 with module screens 334A-D that have been generated from an app module for an online app module store (e.g., similar to Apple™ App Store, Google Play™, etc.). In the illustrated example, a user has entered a search for the search terms “wine spectator,” and the application has generated module screens 334A-D, which each comprises a description of a particular app module within the online store that matches the search terms “wine spectator.” As described above, the search results and position of each result within the plurality of module screens 334 may be determined based, at least in part, on the user's preferences, application selection, artificial intelligence, and/or the like. The user may navigate between the search results in multi-screen view 332, as described elsewhere herein.

2.3. Multi-Modal View & Search

In an embodiment, the application provides a multi-modal (“MyVortex”) view that enables a user to view and easily navigate a plurality of screens generated by a plurality of different types of app modules.

2.3.1 Multi-Modal View

FIG. 3K illustrates an embodiment of the application which utilizes a multi-modal view 336 comprising a plurality of module screens 338A-338G. Multi-modal view 336 may be substantially similar to multi-screen view 328 of FIG. 3I. In an embodiment, multi-modal view 336 is simply a particular instance of multi-screen view 328, in which module screens 330/338 are generated by two or more different types of app module (e.g., as opposed to different instances of the same type of app module).

The number of module screens 338 may be set by the application, the user, and/or both the application and the user (e.g., with the application providing a default set of module screens 338, and the user able to add to, remove from, and/or otherwise modify the default set of module screens 338). For example, the user may specify how many module screens 338 should be open at any given time. In addition, the application may allow the user to specify the number of modules screens 338 to be positioned to the right and left of the initially active module screen 338A, and the number of module screens to the right and to the left may be different from each other (e.g., three to the right and five to the left, etc.).

Alternatively or additionally, the number of module screens 338 in a particular multi-modal view 336 may be variable and dictated by the function being used to populate module screens 338 and/or the current context of the application. For example, the number of module screens 338 in a particular multi-modal view 336 may depend on a number of search results, a number of open app modules being executed (e.g., opened by the user), the artificial intelligence described elsewhere herein (e.g., the predictive model described herein) (e.g., based on a user preference and/or suggested by the artificial intelligence), and/or the like. Thus, while only seven module screens 338 are illustrated, the number of module screens 338 may be any number (e.g., two, three, four, ten, twenty, thirty, etc.).

In addition, while only a couple of different types of app module (e.g., a weather app module and a web-browser app module) are illustrated, the number of types of different app module and the number of instances of each different type of app module may be any number. As with the number of module screens 338, the number of types and/or instances of different app modules may be variable and dictated by the function being used to populate module screens 338 and/or the current context of the application. For example, the number of types of different app modules may depend on the number of different categories of search results, a number of open app modules being executed (e.g., opened by the user), the artificial intelligence described elsewhere herein (e.g., the predictive model described herein) (e.g., based on a user preference and/or suggested by the artificial intelligence), and/or the like.

Module screens 338 may be arranged with an initial active module screen 338A that is displayed on the display of user system 130, and one or more screens 338B-338G arranged to the right and/or left of initial active module screen 338A. The user may navigate between the plurality of module screens 338 by shifting a module screen 338, that is currently displayed on the display, either right or left (e.g., in the same manner as discussed above with respect to multi-screen view 328).

In an embodiment, a user may arrange or rearrange module screens 338. For example, the user may select one or more module screens 338, and shift the selected module screen(s) 338 to another position. Specifically, the user may navigate to module screen 338B. The user may select module screen 338B via a user operation (e.g., selection of an option in the application menu, selection of an input within the screen, etc.), drag module screen 338B from between module screens 338A and 338D to a new position between module screens 338E and 338G, and release module screen 338B at the new position. It should be understood that this is only one example, and other arrangements and manners of modifying arrangements are possible. In addition, the user may designate any of module screens 338 to be the initial module screen 338A.

Similarly to multi-screen view 328, the application may simultaneously execute one or more instances of multiple app modules, such that inactive module screens 338B-338E can be continuously updated in real time in the background, simultaneously with the active module screen 338A, as if active themselves. In other words, each module screen 338 may be contemporaneously rendered prior to being navigated to by the user and cached for quick retrieval during user navigation. Thus, advantageously, the application can quickly render a previously inactive module screen 338, as soon as a user navigates to it, without the delay that would normally be necessary to download the data needed to generate the screen.

Alternatively, the application may download the data necessary to generate each inactive module screen 338B-338E, but wait to generate a given inactive module screen until the user actually navigates to that module screen. In other words, each module screen 338 may be generated and rendered upon being navigated to. In this case, each module screen 338 may be cached after being displayed for the first time, such that the cached module screen 338 can be quickly retrieved and displayed in response to future navigations.

As in multi-screen view 328, each module screen 338 in multi-modal view 336 may represent a screen being generated by an app module. However, multi-modal view 336 refers to an instance in which module screens 338, collectively, comprise at least one module screen 338 from two different types of app modules. For example, module screen 338A comprises weather content generated by a weather app module (e.g., that forecasts local weather), whereas module screen 338B comprises a webpage generated by a web-browser app module. While the described examples are made with reference to certain types of app modules, it should be understood that other types of app modules may used. For example, other types of app modules that may be mixed and matched in multi-modal view 336 include, without limitation, a social-networking app module (e.g., for viewing social media on a social-networking platform), an image-viewing app module (e.g., for viewing a gallery of locally-stored and/or remotely-stored images), and/or the like.

In an example usage, the particular module screens 338 to be generated may be search results of a multi-modal search across a plurality of content sources (e.g., all available content sources, including webpages, social-networking platforms, image databases, newsfeeds, etc.). In this case, which is described in more detail below, each individual result of the search may be represented in its own distinct module screen 338.

Use of multi-modal view 336 may enable users to quickly navigate through a plurality of module screens 338 corresponding to a plurality of different types of app modules. For example, module screen 338A, associated with a first app module of a first type, may be an active module screen, and modules screens 338B-G may be inactive module screens associated with one or more second app modules of a second type that is different than the first type.

In an embodiment, the selection of which app modules to execute in order to generate module screens 338 may be based on the user's current or past activity. This may be referred to as a “personalized multi-modal view.” Module screens 338 may each represent a module of an app module that the user has recently accessed or utilized. For example, in a single session of the application, the user may have accessed social media via a social-networking app module, browsed the web via a web-browser app module, viewed images in a media gallery via an image-viewing app module, performed a search, and/or utilized some other app module or function of the application. The application may store a record (e.g., app module identifier) of each app module accessed, and retrieve data to populate module screen 338A with content representative of social media viewed via the social-networking app module, populate module screen 338B with content representative of the last webpage visited via the web-browser app module, populate module screen 338C with content representative of the viewed media gallery, populate module screen 338D with a screen representative of the retrieved search results, and so on and so forth. Additionally or alternatively, upon start-up of a particular instance of a multi-modal view 336 (e.g., after a restart of the application), the application may select the app modules to use to populate module screens 338, based on the app modules that were used in a prior instance of the multi-modal view 336 (e.g., before the application was last closed). For example, when the application is closed, it may store a record of those app modules (e.g., along with their arrangement) that were open in multi-modal view 336, immediately prior to the application being closed. Then, at some future time, when the application is restarted, restore the multi-modal view 336, using the exact same arrangement of app modules as were recorded, but execute each app module to retrieve updated data to populate updated module screens 338. Thus, the user will be able to view module screens 338 that have been generated by the exact same arrangement of app modules as in a prior session, but with updated content within each module screen 338.

In an embodiment, module screens 338 in multi-modal view 336 may be changed (e.g., swapped in and out), based, at least in part, on user preferences and/or the artificial intelligence described elsewhere herein (e.g., the predictive model described herein). For instance, any module screen 338, generated by a first instance of an app module, may be replaced with a second module screen 338, generated by a second instance of the same type of app module or a first instance of a different type of app module. In some cases, a module screen 338, generated, by a previously accessed app module, may be removed from the set of module screens 338, and replaced with a module screen 338, generated by a newly accessed app module or a different previously accessed (e.g., more recently accessed) app module. Such a replacement may be useful to keep the content of module screens 338 fresh, for example, when the application restricts the number of module screens 338 to a fixed number. As another example, the user or application (e.g., the artificial intelligence described elsewhere herein) may select one or more app modules that may not be removed from multi-modal view 336. In this case, multi-modal view 336 may always comprise at least one module screen 338 from these selected app module(s).

2.3.2 Multi-Modal Search

In an embodiment, a user may execute a multi-modal search from one or more screens (e.g., home screens 302, the application menu, etc.). Similarly or identically to the multi-screen search described above, the user may initiate a multi-modal search by selecting a “multi-modal search” link 304 to a search engine via a user operation (e.g., tap or voice input), selecting (e.g., tapping) an open region (e.g., where no links 304 are positioned) on home screen 302, selecting a search option in the application menu, and/or the like.

As described above in connection to FIG. 3B, when a search is initiated, a search input 306 may be overlaid on the currently displayed home screen 302. A user may utilize the keyboard (e.g., a virtual keyboard that is automatically displayed on a touch panel display by the operating system whenever the user focuses on a textbox) or voice input to input search terms into search input 306. In response to submission of the search terms (e.g., in real-time as the search terms are being input, or after the user indicates completion of the search terms by selecting a link or virtual button), the search terms are input to a search engine which produces relevant search results based on the search terms, as described elsewhere herein. The search engine may utilize the artificial intelligence, described elsewhere herein (e.g., the predictive model described herein), to provide the most relevant search results for the particular user (e.g., according to the user's biases). In addition, the search engine may search across a plurality of content sources (e.g., the World Wide Web, all social-networking platforms, media galleries locally stored on user system 130, media galleries stored remotely from user system 130 in the cloud or on a server, etc.), accessed via a plurality of app modules, to simultaneously provide search results across this plurality of content sources and app modules.

In an embodiment, the application presents the search results in multi-modal view 336, as illustrated in an embodiment in FIG. 3K. Specifically, the application may retrieve a plurality of search results, and populate each of a plurality of module screens 338 with a different one of those plurality of search results. For example, the application may execute the app modules that will be used to generate module screens 338 for the multi-modal search results, retrieve a set of search results (e.g., a top number of search results) and/or the data necessary to render each search result, and execute the app modules to populate each module screen 338 with the content of a different search result.

How the search results are populated into module screens 338 of multi-modal view 336 may be determined by the user and/or the application, in the same or similar manner as discussed above with respect to the multi-screen search. For example, the search result to be populated into the initial active module screen 338A may be determined based on a preference or suggestion (e.g., as determined by the artificial intelligence, for example, the predictive model described herein). This search result may be the top search result, the top search result from a particular app module (e.g., determined by the user and/or artificial intelligence), a search result from a particular source (e.g., determined by the user and/or artificial intelligence) within a particular app module, a recommend search result, a most popular search result, a highest-rated search result, and/or the like. As another example, the application may arrange module screens 338, such that the more relevant the search result, the closer it is to the logical center (i.e., active module screen 338A) of module screens 338. As yet another example, one or more module screens 338 may always be populated by a search result from particular source(s) available to particular app module(s).

In an embodiment, a user may perform a search within a multi-modal view 336 (e.g., via a search input 306 within the active module screen 338A), in which the user has already arranged, opened, or otherwise been using a certain configuration of app modules. In this case, the search results of the multi-modal search may be automatically populated into the prior configuration of app modules, without altering the configuration of app modules. For example, the application may automatically populate the top search result for each type of app module into each app module.

As a more specific example, assume that a user inputs the search term “Apple” (e.g., into search input 306), while the user has a multi-modal view 336 comprising a module screen generated by a stock-quote app module, a module screen generated by a web-browser app module, a module screen generated by a weather app module, and a module screen generated by a news app module. In this case, the application, in response to the search, may determine that the search term relates to the company Apple™ Inc., and submit a search within each app module. The application may then populate the module screen generated by each app module with the top search result, for the particular user, that was returned within that app module. Thus, for instance, the module screen generated by the stock-quote app module may be updated with a stock quote for Apple™ Inc., the module screen generated by the web-browser app module may be updated with a Wikipedia entry for Apple™ Inc., the module screen generated by the weather app module may be updated with a weather forecast for Cupertino, Calif. (i.e., the location of the headquarters of Apple™ Inc.), and the module screen generated by the news app module may be updated with a recent news article about Apple™ Inc.

2.4. Broadcast

In an embodiment, the application enables a user to broadcast a message (e.g., send) to one or more other users via a set of one or more intuitive screens. Options and criteria related to the broadcast message may be driven by the artificial intelligence described elsewhere herein (e.g., the predictive model described herein).

2.4.1 Broadcast Search

FIG. 3L illustrates an embodiment of a broadcast wizard by which a user may generate a broadcast message. In the illustrated embodiment, the broadcast wizard comprises a series of screens 340A-340F. In alternative embodiments, the broadcast wizard may comprise more, fewer (e.g., including only a single screen), or a different arrangement of screens than the illustrated wizard.

Each screen in the broadcast wizard may be used to collect a different set of information. This information may be collected using selectable options. For example, one or more of the screens in the broadcast wizard may provide a user with a list of selectable options, from which the user may select one or a plurality of options. As is the nature of wizards, the set of selectable options or other information collected in a subsequent screen may depend on the information collected in a preceding screen.

At a minimum, the collected information should define the content of the broadcast message and criteria for determining the recipients of the broadcast message. In more complex embodiments, the information may specify the sender, context, and type of the broadcast message, and/or the time at which the broadcast message should be sent. While the broadcast wizard will be described as collecting a certain set of information from a user in a certain manner, it should be understood that the broadcast wizard may collect more, less, or different information than the information described in the illustrated embodiment and may collect this information according to any known or future process.

Screen 340A of the illustrated embodiment of the broadcast wizard prompts the user to specify the sender of the broadcast message. For example, screen 340A may comprise a list with a “company” option (e.g., indicating that the broadcast message will be sent on behalf of a company, such as the user's company or employer, or by the user professionally) and a “person” option (e.g., indicating that the broadcast message will be sent by the user personally).

Screen 340B of the illustrated embodiment of the broadcast wizard prompts the user to specify the context of the broadcast message. For example, screen 340B may comprise a list with a “personal” option (e.g., indicating that the broadcast message comprises a personal message) and a “business” option (e.g., indicating that the broadcast message comprises a business-related message, such as an advertisement).

Screen 340C of the illustrated embodiment of the broadcast wizard prompts the user to specify the type of broadcast message. For example, screen 340C may comprise a list with a “referral” option (e.g., indicating that the broadcast message is requesting or offering a referral), a “resources” option (e.g., indicating that the broadcast message is requesting or offering a resource), a “services” option (e.g., indicating that the broadcast message is requesting or offering a service), a “goods” option (e.g., indicating that the broadcast message is requesting or offering a good, such as a product), and/or an “advice” option (e.g., indicating that the broadcast message is requesting or offering advice). In some embodiments, additional message types may be included, for example, but not limited to, broadcast a notification that does not require any action or response from the recipients, as explained in greater detail herein.

Screen 340D of the illustrated embodiment of the broadcast wizard prompts the user to specify a target of the broadcast message. The target may define or indicate a set of one or more recipients (i.e., other users) to which the broadcast message should be sent. For example, screen 340D may comprise a list with a “people” option (e.g., indicating the target should include non-company-users), a “company” option (e.g., indicating that the target should include company-users), an “expert” option (e.g., indicating that the target should include users with expertise in the subject matter of the broadcast message), a “community” option (e.g., indicating that the target should include a particular community of users), a “provider” option (e.g., indicating that the target should include a provider of a particular good, service, or resource), and/or a “global” option (e.g., indicating that the target should include all users of the application). In an embodiment, the user may specify additional or different criteria to be used in determining the target, and the artificial intelligence, described elsewhere herein (e.g., the predictive model described herein), may use the specified criteria to determine the subset of users who should receive the message.

Screen 340E of the illustrated embodiment of the broadcast wizard prompts the user to specify a timing at which the broadcast message should be sent. For example, screen 340E may comprise a list with options for specifying a delay (e.g., no delay, twenty-four hours, three days, seven days, thirty days, ninety days, one-hundred-twenty days, etc.), from the time that the broadcast message is submitted, until the broadcast message is sent. If no delay is specified, the application may send the broadcast message to the recipients as soon as possible after the broadcast message has been submitted by the user. Otherwise, if a delay is specified, the application will wait until the delay period expires, from submission of the broadcast message, to send the broadcast message to the recipients. Alternatively or additionally, the user may specify a particular date and/or time at which the broadcast message should be sent and/or a particular date range and/or time range during which the broadcast message should be sent, a frequency or interval at which the broadcast message should be periodically sent (e.g., daily, weekly, monthly, etc.), and/or the like.

Alternatively, screen 340E of the illustrated embodiment of the broadcast wizard prompts the user to specify a timing by which responses to the broadcast message need to be received. For example, screen 340E may comprise a list with options for specifying a time period (e.g., twenty-four hours, three days, seven days, thirty days, ninety days, one-hundred-twenty days, etc.), from the time that the broadcast message is submitted, by which any response to the broadcast message need to be received. If no time period is specified, recipients may respond to the broadcast message at any time. Alternatively or additionally, the user may specify a particular date and/or time by which all responses to the broadcast message should be received.

Screen 340F of the illustrated embodiment of the broadcast wizard prompts the user to specify the content of the broadcast message. For example, screen 340F may comprise a textbox into which the user may enter text to be included in the broadcast message. Screen 340F may also comprise inputs for adding images, videos, a subject, and/or other media or information to the broadcast message. After all of the information has been collected, the user may submit the broadcast message, by performing a user operation that indicates or confirms that the broadcast message is complete.

It should be understood that the broadcast wizard described above is merely illustrative. Types of information, other than those described, may additionally or alternatively be collected. Such types of information may comprise, for example but not limited to, a media type (e.g., used for the broadcast message, such as text message, email, video, etc.), a contribution type (e.g., whether the broadcast message represents a request for, or is otherwise related to, a general, social, environmental, or other contribution), a subset of the user's social network to which the broadcast message should be sent (e.g., general, personal network, business network, team, community, or other group, people or companies recommended by the users friends, preferred sources, preferred people, celebrities, etc.), a rating of users to which the broadcast message should be sent (e.g., a minimum or maximum rating), and/or a maximum number of responses (e.g., the maximum number of responses that will be collected and relayed to the sending user).

In an embodiment, senders and receivers of broadcast messages may search their personal broadcast messages, for example, sent broadcasts and/or recipients of broadcast messages may search their received broadcasts via a user operation. In either case, the user may search specifically within current broadcasts, previous broadcasts, team, community, or other group broadcasts (e.g., sent on the behalf of a group, to a group, or by members within a group), company broadcasts (e.g., sent on behalf of a company or to a company), and/or other types of broadcasts. In an embodiment, the user may also search broadcast messages of other users who have opted in to allowing users to search their broadcast messages (e.g., in exchange for a reward).

2.4.2 Broadcast Results

In an embodiment, after a broadcast message has been sent to a recipient, the recipient may respond to the broadcast message. The response may comprise the selection of an option (e.g., “accept” or “decline” if the broadcast message is a request or offer), a responsive message (e.g., with text, images, videos, and/or other media), an acknowledgement that the message was delivered, and/or the like. The application may collect each response to a broadcast message and provide the responses to the sender of the broadcast message. In an embodiment and instance in which the user has specified a maximum number of responses (e.g., 25, 50, 100, 250, 500, any), the application may stop collecting responses to the broadcast message after the maximum number of responses have been received.

FIG. 3M illustrates an embodiment of a broadcast-results screen 342, which lists each response to a particular broadcast message. Broadcast-results screen 342 may be accessed via a user operation (e.g., user selection of a link 304 on a home screen 302, which links to a list of broadcast messages sent by the user, which links to a broadcast-results screen 342 for a selected broadcast message). As illustrated, the response list may comprise a selectable entry for each response. Each selectable entry may comprise a summary of the corresponding response, such as a thumbnail image, name, and employer of the responding recipient.

The user may select one of the entries on broadcast-results screen 342 to view detailed information about the respective response. The screen, comprising the detailed information, may comprise inputs for further communicating with the responding recipient, negotiating, confirming, and/or finalizing a transaction, and/or the like.

2.5. Notifications

The graphical user interface may provide notifications to users in real time. A notification may be generated to alert the user about the reception of a message (e.g., broadcast message or a response to a broadcast message), new content in an app module (e.g., new social-media post by a person whom the user is following), and/or the like. As additional examples, the application may support user-relevant notifications for one or more of the following, non-limiting examples: announcements, app modules, new articles, activity in the user's bank account, business opportunities or deals, chats, city alerts, concert tickets, currency, job postings, charity opportunities, governmental or community alerts, concerts, currency exchange rates, new email messages, events, exclusives, fashion, recommended flights, flight tracking, games, groups, horoscopes, recommended hotel reservations, winning lottery numbers, available media (e.g., images, videos, movies, music, etc.), available merchandise, opportunities within a vicinity of the user, news, activities by people within the user's social network or being followed by the user, personal growth opportunities or reminders, advice, stock quotes, rated content, real estate opportunities, recognition for the user, restaurants, rewards, technology, available tickets, calendar or to-do reminders, toys, travel, school, sports, software updates, weather, and/or the like.

In an embodiment, the artificial intelligence, described elsewhere herein (e.g., the predictive model described herein), may identify new information (e.g., a new social media post, a new article, a new event, a new opportunity for personal or professional development, etc.) in which the user is likely to be interested (e.g., based on the user's biases), and automatically alert the user of the new information. Thus, the application may provide instant, personalized notifications to the user, across all areas of interest to the user, and according to the user's unique preferences.

Additionally or alternatively, the user may specify (e.g., via a settings screen) which notifications to receive and/or how notifications should be displayed. In this manner, the user can select which categories of notifications are of interest to him or her, and the application may only provide the specified categories of notifications to the user in real time within the graphical user interface. The selectable categories may comprise, without limitation, advice, business, donations, goods, referrals, resources, services, communities, groups, media, messages, near me, people, personal, technology, travel, and/or the like. In addition, the user may specify where the notification should be displayed within the graphical user interface (e.g., at the top, middle, or bottom of whatever screen is being displayed at the time of the notification).

In an embodiment, a first user may specify to receive a notification whenever a second user approaches something of interest to the first user. For example, the first user may be a company, the second user may be a consumer, and the company-user may specify that the application should trigger a notification to the company-user whenever the consumer approaches a store of the company (e.g., as defined by a geolocation, such as Global Positioning System (GPS) coordinates or a street address). The application may determine whether or not a current location of the consumer-user's mobile user system 130 (e.g., as determined by a GPS sensor on the mobile user system 130) is within a vicinity (e.g., predetermined radius) of the location of the store by comparing the two locations. Whenever the current location of the consumer-user's mobile user system 130 is within the vicinity of the store's location, the application may trigger a notification to a user system 130 of the company-user. This may enable the company-user to target a communication (e.g., a broadcast message comprising an advertisement) to the consumer-user while the consumer-user is within a vicinity of the company-user's store. It should be understood that the company-user may set such a notification for a plurality of consumer-users or a group of consumer-users (e.g., consumer-users matching one or more criteria defined by the company-user or determined by the artificial intelligence described elsewhere herein, for example, the predictive model described herein).

FIG. 3N illustrates an embodiment of a notification in the graphical user interface. Specifically, regardless of what screen the user is currently viewing within the graphical user interface (e.g., social media in a social-networking app module), an alert 344 may be presented within the screen (e.g., at the top of the screen). Alert 344 may provide a description of the notification (e.g., type of notification and a synopsis of the notification's content). For example, if alert 344 is notifying the user that he or she has received a broadcast message, alert 344 may comprise the title “broadcast” and at least a portion of the broadcast message.

In an embodiment, a user may select alert 344, via a user operation (e.g., tap or voice input) to view notification details. In response to user selection of alert 344, the application may transition to a detail screen displaying the full notification (e.g., comprising the entire content of a broadcast message). In the event that the notification is a message, such as a broadcast message requesting a response thereto, the detail screen may comprise one or more inputs for responding to the message (e.g., an “accept” or “decline” input if the message comprises a request, a textbox for inputting a responsive message, etc.).

In an embodiment, a user can access various notification-related searches. For example, a user may search his or her current or personal notification settings, perform a content search from a notification, including a multi-screen and/or multi-modal search, from a notification, and/or search the notification settings and/or histories of other users (e.g., friends, companies, celebrities, charities, members of the same team, community, or other group, etc.) who have opted in to allow such searches (e.g., in exchange for a reward). These searches may be performed by a user operation, such as selection of an option in an overlay menu and/or a voice input.

In an embodiment, the application may also enable users to send or broadcast a message to platform (e.g., to server application 112 or client application 132), and/or of other users, for example, as a notification. The notifications may be sent by a user in similar manner to the notifications described above or any other messaging functionality described herein. In this case, the notification may comprise an instruction for the server and/or client application to execute some function on behalf of the sending user. For example, the notification may be sent to the application to record some transaction or other interaction (e.g., to record a rating of a personal interaction that the user just had with another user) in the blockchain, as discussed elsewhere herein. Such notifications may be sent to the application to execute any one or more of the functions described herein, for example, execute a bank transaction. In some embodiments, such notifications maybe recorded in the blockchain and/or executed via any messaging protocol as described herein.

2.6. Content Feed

In an embodiment, the application provides a content feed that enables users to view information related to one or more of their areas of interest (e.g., as predefined by the user and/or determined by the artificial intelligence described elsewhere herein, for example, the predictive model described herein) without disrupting the users' real-time activity. In some implementations, results feed 320 may be an example of a type of content feed.

FIGS. 3O and 3P illustrate embodiments of an example screen 346 for displaying and interacting with different content. FIG. 3O illustrates example screen 346 comprising a region 348 that displays content generated by an app module, and a content feed 350A. FIG. 3P illustrates example screen 346 comprising the region 348 and a content feed 350B. It should be understood that both content feed 350A and content feed 350B may be present in the same embodiment of the graphical user interface of the application, but may be provided by the application at different times under different criteria (e.g., based on user preference, based on user interaction, or the lack thereof, with content feed 350, etc.). Content feed 350 may overlay a portion of region 348, or be positioned underneath, above, or to either side of region 348.

In an embodiment, content feed 350 comprises a plurality of content blocks. In the illustrated examples, content feed 350A comprises content blocks 351A-351N, and content feed 350B comprises content blocks 352A-352N. Content blocks 352 may essentially be thumbnail images, summaries, or other miniatures of module screens 330 or 338. A content feed 350 may be populated with a set of content blocks 351 or 352 representing the functional results of any of the functions of the application, described herein. Thus, individual content blocks 351 or 352 of a content feed 350 may be generated for any functional result, screen, or other content, described herein, including, without limitation, an active module screen (e.g., 330A, 338A), an inactive module screen (e.g., 330B, 338B), search results, category-snapshot screen 308, snapshot-results screen 312, a notification, a broadcast, a screen being generated by an open app module, a screen for display content related to one or more predefined keywords, topics, people, companies, charities, or other organizations, teams, communities, or other groups, and/or the like. In some embodiments, where the content blocks 351A-351 are miniature module screens 330 or 338, the content blocks maybe navigable within each content block in a manner substantially similar to the module screens 330 or 338 (e.g., scrolling up, down, left, and/or right within the content displayed in each content block).

In an embodiment, each content block 351 and 352 may comprise a link to one or more other functions of the application. For example, a content block may comprise a link to one or more app modules, an instance of an app module running in the background, a themed screen (e.g., home screen 302), a category-snapshot screen 308 for a particular search, a snapshot-results screen 312 for one or more categories of a particular search, a module screen 330, a module screen 338, broadcast messages and/or notifications, keywords searches, people, companies, charities, or other organizations, teams, communities, or other groups, and/or any other screen, function, and/or functional results of the application. If there are more content blocks than can be visually represented in content feed 350 at any given time, content feed 350 may be scrollable, such that a user can navigate to the right or left (e.g., by swiping left or right, respectively) to reveal the visual representations of more content blocks. In an embodiment, content feed 350 may automatically scroll right or left at a set or modifiable velocity (e.g., determined by the user and/or the artificial intelligence).

In an embodiment, content feed 350 may be a “newsfeed” comprising a summary of news. In such an embodiment, each content block 351 and/or 352 may visually represent and link to a screen (e.g., generated by an app module) for viewing news content. For example, FIG. 3O illustrates an example content feed 350A comprising two content blocks 351 (e.g., two content blocks) which each summarize different subject matter, via brief narrative content, and provide a link to a screen for viewing full content on that subject matter from the news source. The application may retrieve a portion of data from the linked source to generate the narrative content. As an example, content feed 350A illustrates a stock ticker comprising a stock price as narrative content in content block 351A, and a summary of a news story (e.g., “The New York Stock Exchange is Out to Cm . . . ”) in content block 351N. It should be understood that these are simply examples, and that the subject matter of content blocks 351 may include any subject matter of interest to a user (e.g., world news, political news, sports updates, news about or social media from a person being followed by the user on a social-networking platform, etc.). Content bar 350A may continuously scroll through all content blocks 351 at a predetermined or variable velocity (e.g., set by the user, application, and/or the artificial intelligence described elsewhere herein, for example, the predictive model described herein), while the user interacts with the content in region 348. While FIG. 3O illustrates a certain number of content blocks 351, any fixed or variable number of content blocks 351 may be used, and the user may select more or fewer content blocks 352 as desired.

In an embodiment, content feed 350 may be a set of search results. For example, a user could input search terms (e.g., using search input 306 or via voice input), while viewing region 348. In response to submission of the search terms, the application may input the search terms to a search engine which produces relevant (e.g., user-biased) results. The application may generate a content block 352 for each search result, and populate a content feed 350 with content blocks 352, representing all search results or a top number of search results (e.g., top five, top ten, etc.). In an embodiment, content feed 350 may be used similarly to the snapshot category described elsewhere herein, such that each content block 352 represents the top search result for a different category of content (e.g., where the categories to be represented by a content block 352 in content feed 350 are determined in the same manner as the categories to be included in category-snapshot screen 308, or in some other manner based on user biases and/or the artificial intelligence described elsewhere herein, for example, the predictive model described herein).

In any case, the application may generate and render a new content feed 350 and/or populate an existing content feed 350 with the content blocks 352, representing the search results, without affecting region 348. Thus, for example, while performing the search and viewing the search results in content feed 350, the user may continue to view the content in region 348 and, in the event the user has a multi-screen view 328 or multi-modal view 336 open, even navigate between module screens within region 348 (e.g., by swiping right or left) or within an active module screen within region 348 (e.g., by scrolling up or down), without any interruption. In other words, the search and population of content feed 350 occurs independently from whatever function is being utilized in region 348.

In an embodiment, content feed 350B may comprise content blocks 352, which each comprise an icon or thumbnail image that is based on the corresponding link. For example, FIG. 3P illustrates content blocks 352A-352N (e.g., five content blocks) as thumbnails of an instance of a screen generated by an app module corresponding to the link associated with the respective content block 352. Content blocks 352 may comprise thumbnail images or icons based on various app modules, people, business, or any other function of the application. In an embodiment, content blocks 352 may be active and updated in real time, as the user interacts with region 348. Alternatively or additionally, content blocks 352 may be static and each reflect a status of the linked source at the time that the content block 352 was added to content bar 350B. While FIG. 3P illustrates a certain number of content blocks 352, any fixed or variable number of contact blocks 352 may be used, and the user may select more or fewer content blocks 352 as desired.

Content blocks 351 and/or 352 in content feed 350 may be determined by the user and/or the application. For example, some content blocks may always be populated by preselected content (e.g., as specified by the user and/or the application), whereas some content blocks may be determined (e.g., dynamically) by the artificial intelligence described elsewhere herein (e.g., the predictive model described herein). For example, the user or application may select links to app modules and/or content sources within particular app modules for populating the content blocks. Thus, content feed 350 may be personalized based, at least in part, on the artificial intelligence and/or a descriptive user data model, as described elsewhere herein. Additionally or alternatively, the content blocks may be based on previous user activity, such as the last type of app module and/or the last instance of an app module that the user accessed. The content blocks may also be based on a preferred content source, recommended content source, most popular content source, highest-rated content source, featured content source, and/or the like.

In an embodiment, content feed screen 346 may be accessed from one or more home screen 302 (e.g., via a link 304). Additionally or alternatively, content feed 350 may be accessed from any other screen and/or added to a screen, via the application menu and/or voice input. For example, the user may request content feed 350 via a voice input (e.g., by speaking “content feed”) or a touch operation (e.g., predetermined gesture, tapping an input or option in the application menu, etc.) to cause content feed 350 to overlay the currently active screen. Upon activation of content feed 350, the application may execute app modules associated with the content blocks to populate each content block 351 and/or 352. In an embodiment, content feed 350 may be hidden (e.g., terminated or run in the background) in response to, for example, a predetermined time of inactivity or a user operation.

FIGS. 3Q-3T illustrate examples of the environment in which content feed 350 may be operated, according to embodiments. Content may be fed into one or more content blocks from content in region 348 and/or content associated with alert 344. Conversely, content may be fed into region 348 from one or more content blocks and/or an alert 344. While examples are described herein with respect to content feed 350B comprising content blocks 352, the examples are equally applicable to content feed 350A comprising content blocks 351, as well as any other embodiment of a content feed comprising content blocks.

In an embodiment, the application may provide information to content feed 350. FIG. 3Q illustrates example screen 346 comprising region 348 and content feed 350. The content displayed in region 348 may be selected from content feed 350 and/or added to content feed by a user operation.

In an embodiment, if a content block in content feed 350 is currently rendering content from a first source, the user may perform an operation to replace that content block with content from a second source, such as the source of content in a selected region (e.g., region 348) of screen 346. The application may shift the existing content block (e.g., one position within content feed 350), and insert a new content block, rendering content from the second source, into the vacated position. In another embodiment, the content feed functionality may generate a miniaturized window in the content block 330 that may be updated in real time based on the source.

For example, in response to a certain user operation (e.g., initiating a contact point within region 348 and, without releasing, dragging the contact point to content feed 350), the application may generate a content block comprising a visual representation (e.g., narrative description, thumbnail image, icon, etc.) of the content in region 348 and a link to an app module and/or source for displaying the content in region 348. The application may then add the content block to content feed 350, by inserting it as an added content block into content feed 350 or using it to replace an existing content block in content feed 350. In an embodiment in which a user performs a drag operation from region 348 to content feed 350, the content block, generated for the content in region 348, may be inserted at or near an end point of the drag operation. For instance, the generated content block may replace an existing content block at the position of the end point, or be inserted adjacent to the existing content block at the position of the end point. In addition, as the user drags a contact point from region 348 to content feed 350, a visual representation of the content in region 348 (e.g., the content block generated for the content in region 348, or another visual representation of the content in region 348) may be shown to drag, in accordance with the motion (e.g., speed and direction) of the contact point, to provide the user with visual feedback.

Each content block may comprise a dynamic or static visual representation of the content to which it links. In the event that the visual representation is dynamic, the content block may be updated in real time to represent (e.g., in a thumbnail image) a screen comprising the content. In this case, the screen may be generated by an app module executing in the background. In the event that the visual representation is static, the application may perform a screen capture of the content at its source, and generate a thumbnail image based on the screen capture. A content block can be configured, in either manner, to display any type of content.

FIG. 3R illustrates another example of feeding content into content feed 350. Specifically, FIG. 3R illustrates an alert 344 that may be used to populate content feed 350 and/or region 348. In an embodiment, a user may select alert 344 (e.g., by tap or voice input) to populate a content block in content feed 350 or the region 348. In response to the user selection of alert 344, the application may transition to or generate a command input interface 354A (e.g., overlay menu) that displays a plurality of options for interacting with the notification represented by alert 344. Example commands may include, without limitation, creating and inserting a new content block for the notification corresponding to alert 344 into content feed 350, re-populating or replacing an existing content block in content feed 350 with the notification corresponding to alert 344, displaying the notification corresponding to alert 344 (e.g., a broadcast message, response to broadcast message, etc.) in region 348, deleting alert 344, saving alert 344, responding to alert 344, and/or the like. If the user selects to either create and/or repopulate a content block in content feed 350, the application can generate a content block for the notification corresponding to alert 344, comprising a visual representation of the notification (e.g., thumbnail image, narrative description, etc.) and a link to the notification. As an example, if the notification is the reception of a broadcast message, the content block may link to a screen comprising the broadcast message. If the notification is for the reception of a response to a broadcast message that the user previously sent, the content block may link to a screen comprising the response or broadcast-results screen 342.

FIG. 3S illustrates another example of feeding content to content feed 350. Specifically, FIG. 3S illustrates, a multi-modal and/or multi-screen view, as described elsewhere herein, being used to populate and/or create a content block in content feed 350. In an embodiment, a user may navigate among the module screens (e.g., module screens 330 or 338), and select one or more module screens to generate a content block 330. For example, upon navigating to a desired module screen in region 348, the user may select region 348, and the application will generate a content block for the module screen in region 348. The content block may be generated in a manner that is similar or identical to the manner for generating content blocks described elsewhere herein.

The various examples of content feed 350, content blocks 351 and 352, and the operations performed in relation to content feed 350 and content blocks 351 and 352, are not intended to be limiting. Content blocks may be generated to represent any of the various screens and functions of the application described herein. Additionally, content feed 350 may comprise any mixture of the example content blocks described herein and illustrated in the drawings. Furthermore, a single content feed 350 may comprise one or more of content blocks 351 in combination with one or more of content blocks 352.

In an embodiment, content feed 350 may be utilized to populate region 348 or other regions of the graphical user interface provided by the application. FIG. 3T illustrates a content feed 350 comprising a plurality of content blocks, wherein one or more content blocks are selected for display in region 348. For example, in response to a user operation selecting a content block in content feed 350 (e.g., tapping a content block 352 in content feed 350), the application may follow the link in the content block to retrieve content and execute an instance of an app module to generate a screen comprising the content. The application may then display the generated screen in region 348.

As an alternative example, a user may select a content block via a user operation (e.g., a tap or voice input). In response to the user selection, the application may transition to or generate a command input interface 354B (e.g., overlay menu) that displays a plurality of options for interacting with the selected content block. Example commands may include, without limitation, accessing the source associated with the link of the selected content block, populating region 348 based on the link of the selected content block, generating a message (e.g., broadcast message) from the selected content block, executing an app module based on the selected content block, deleting the selected content block, moving the selected content block, performing a search based on the selected content block, performing a multi-screen and/or multi-modal search based on the selected content block, setting a notification based on the selected content block (e.g., setting a stock alert for a particular company based on a content block with a stock quote for that company), and/or the like. The user may then select one or more of the command inputs, and the application will transition to the appropriate function as described herein. If the user selects the option to open the selected content block in region 348, the application can execute an app module to retrieve content from the link of the selected content block and display the content in region 348. In an embodiment, the user may select a plurality of content blocks for display in region 348. For example, the user may select a plurality of content blocks, and the application may populate a plurality of module screens (e.g., modules screen 330 or 338) of a multi-screen and/or multi-modal view to display the content associated with each selected content block within a different one of the plurality of module screens.

In an embodiment, the application may perform a snapshot search, multi-screen search, and/or multi-modal search of a content feed associated with another user. For example, upon searching for or navigating to another user of the application platform (e.g., using people-themed home screen 302, illustrated in FIG. 3F), the user may select to search the other user's content feed in accordance with the above description. The results of the search may then be used to populate a content feed 350 of the user's graphical user interface and/or populate one or more module screens in a multi-screen view and/or multi-modal view within the user's graphical user interface.

In an embodiment, a user can access various content-feed-related searches. For example, a user may search the user's specified areas of interest and feed the search results into the user's content feed (e.g., by content source, category of content, etc.). In this manner, the user could search a personal newsfeed, preselected areas of interest, preferred sources of information, past notifications, past broadcasts, trending news (e.g., by area of interest, friend, family, celebrity, company, charity, or other organization, team, community, or other group, general, etc.), advertising (e.g., by area of interest or specified by the user, company, prior broadcasts, prior search queries, prior notifications, etc.), recommended sources of information, most popular sources of information, and/or the like. In addition, in an embodiment, the user may view or search the content feeds 350 of other users (e.g., friends, family, celebrities, members of the same team, community or other group, companies, charities, or other organizations, etc.).

In an embodiment, content feed 350 may be implemented in conjunction with multi-modal view 336 to provide access to a plurality of module screens and/or content for viewing and managing content, search, people, notification, messages, and/or the like, in real time. For example, a user may be reading an article about improvements in the economy. The user may want to start investing, and perform a search for stock brokers. The application may run a user-biased search implementing, for example, artificial intelligence in conjunction with a descriptive user data model (described elsewhere herein) (e.g., the predictive model described herein), associated with the user, to return user-biased search results. Search results may include news articles, advertisements for stock brokers, other users within the user's social network that are a stockbroker or know a stockbroker, and/or the like. The user may select to populate content feed 350 and/or module screens 338 with the search results. In the case where the user populates content feed 350 with the search results, the user may then select one or more of the content blocks to further perform a search based on the content block, and the application may repopulate module screens 338 with the new search results. For example, one of the content blocks may represent a friend of the user (e.g., based on the user's social network), who has relevant experience and/or knowledge of the market, and the user may select this person for an additional search to populate module screens 338 with new search results.

FIG. 3U illustrates another example content feed comprising a plurality of content feeds 350C. Each content feed 350C may be substantially similar to either content feed 350A and/or 350B. In an embodiment, the content feed 350C may comprise a plurality of content feeds 350A, a plurality of content feeds 350B, and/or a combination of one or more content feeds 350A with one or more content feeds 350B. Each content feed 350C may be navigated, populated, and/or otherwise utilized independently of the other content feeds 350C. While three content feeds 350C are illustrated in FIG. 3W, it will be appreciated that any number of content feeds 350C may be included (e.g., two, four, five, etc.). Additionally, each content feed 350C may be arranged horizontally along the bottom of screen 346 (as shown in FIG. 3U), horizontally along the top of screen 346, or vertically along one or both sides of screen 346. The user may be able to shift or rearrange content feeds 350C as desired by, for example, selecting a particular content feed 350C and dragging or moving it to another position or via voice input.

In an embodiment, a user may be able to view and/or search the content feeds 350 of other users, such as friends, users who are members of a team, community, or other group of which the user is also a member, celebrities, companies, charities, or other organizations, users who are members of the user's personal or business network, and/or the like. Whether other users may search a particular user's content feed 350 may depend on whether or not the particular user has opted in to allowing other users to search his or her content feed 350. Users may be incentivized to opt in to this search function (e.g., via rewards)

In an embodiment, a user may switch his or her active content feed 350 to a particular group of related content. In other words, in response to a user operation (e.g., selection of an option in the application menu and/or voice input), the application may populate the content blocks 352 of the active content feed 350 with representations of content in the selected group of related content. For example, the groups of related content may comprise trending news for a particular topic (e.g., breaking news, business, culture, current events, environment, finance, games, government, health, magazines, media, music, politics, regional news, real estate, shopping, spirituality, sports, technology, traffic, weather, etc.), a particular category of content (e.g., within a particular app module, such as a social app module), among a subset of users within the user's social network (e.g., friends, family, company, charity, or other organization, team, community, or other group, personal or business network, etc.), among the user's preferred sources of content, among recommended sources of content, among users whom the user is following, among the most popular sources of content, within a certain geographical area (e.g., city, county, region, state, country, etc.), among all users, and/or the like. Advantageously, by being able to view trending news in this manner, the user may be able to identify relevant news before it even hits the mainstream media. As another example, the groups of related content may comprise previously received or current advertisements that have been preselected by the user, pertain to particular area(s) of interest, pertain to a particular company, are based on prior broadcasts or other notifications, were found in prior search results, were recommended (e.g., by users within the user's social network), are the most popular, are the highest rated, are for a company with significant (e.g., the highest) contributions, and/or the like. The groups of related content may also comprise a user's personal content feed (e.g., preset and prearranged by the user and/or the artificial intelligence), pre-selected areas of interest, the user's personal content feed by source of information or category of content, past notifications that the user added to his or her content feed, past broadcasts that the user added to his or her content feed, and/or the like.

2.7. Combined Universe and Multi-Modal Views

In an embodiment, the application may utilize other variations of the universe view than the one illustrated in FIG. 3A. For example, FIG. 3V illustrates an embodiment of the application which utilizes a plurality of home screens 302 (e.g., as described above in connection with FIG. 3A) and a plurality of module screens 330 or 338 (e.g., as described above in connection with FIGS. 3I-3K). In an embodiment, the graphical user interface combines the plurality of home screens 302 with the multi-screen view 328 and/or multi-modal view 336, described elsewhere herein.

In an embodiment, home screens 302 are substantially similar or identical to home screens 302 in FIG. 3A, and the module screens are substantially similar to module screens 330 and/or 338. Each screen may be logically arranged relative to a primary or initial home screen 302A, with one or more home screens 302B-302E and one or more module screen 330 or 338 arranged around initial home screen 302A. In an example implementation, home screens 302B-302E are logically arranged at the diagonals of initial home screen 302A (e.g., top-left, bottom-left, bottom-right, and top-right, respectively), and module screens 330 or 338 are logically arranged to the right and/or left of initial home screen 302A. In an alternative implementation, the positions of home screens 302B-302E and module screens 330 or 338 are interchanged, such that module screens 330 or 338 are logically arranged on the diagonals and home screens 302B-302E are logically arranged on the right and/or left sides. Other arrangements are also possible.

The user may navigate between the various screens by using similar navigation operations as those described elsewhere herein. For example, in the implementation illustrated in FIG. 3U, if home screen 302A is currently being displayed, the user may swipe right, and the application may responsively transition from home screen 302A to the module screen 330 or 338 that is logically to the left of home screen 302A. Similarly, if home screen 302A is currently being displayed, the user may swipe left, and the application may responsively transition from home screen 302A to the module screen 330 or 338 that is logically to the right of home screen 302A. Furthermore, if home screen 302A is currently being displayed, the user may navigate to the top-left by swiping towards the bottom-right (e.g., by touching a middle or top-left corner of the touch panel display with his or her finger and sliding the finger towards the bottom-right corner, for example, at roughly a forty-five-degree angle from horizontal or vertical), and the application may responsively transition from home screen 302A to the home screen 302B that is logically to the top-left of home screen 302A. In the same manner, the user may navigate to the other home screens 302C, 302D, and 302E (e.g., by swiping towards the bottom-left, top-right, and top-left, respectively).

It should be understood that any number of module screens 330 or 338 and home screens 302 may be arranged in this manner. For example, any number of screens may be arranged along the left-right axis and both diagonal axes (i.e., the axis formed by the logical arrangement of home screens 302B, 302A, and 302E, and the axis formed by the logical arrangement of home screens 302C, 302A, and 302D), and the user may navigate along these axes in any of the manners described elsewhere herein. As one example, a home screen 302 could be logically arranged to the top-left of home screen 302B and accessed by swiping towards the bottom-right while home screen 302B is displayed, and a home screen 302 could be logically arranged to the bottom-right of home screen 302E and accessed by swiping towards the top-left while home screen 302E is displayed.

FIG. 3V also illustrates a home bar 360 of the graphical user interface that is overlaid on home screen 302, according to an embodiment. Home bar 360 may comprise links 361A-361N (e.g., represented by icons or thumbnail images) to one or more functions of user system 130. These functions may include, without limitation, a call function (e.g., for making telephone calls), a messaging function (e.g., for sending text messages, such as a Short Message Service (SMS), Multimedia Messaging Service (MMS), etc.), an electronic mail function (e.g., for sending email messages), and/or the like. Home bar 360 may be a stock menu controlled by the operating system of user system 130. Alternatively, home bar 360 may be generated by the graphical user interface of the application, but comprise links to functions performed by the operating system or an external application. In either case, the linked-to functions may be performed by software that is different than and external to the application (i.e., different than client application 132 and server application 112).

In an embodiment, home bar 360 is not displayed on home screen 302, unless the user requests the home bar 360 to be viewable. For example, the user may interact with user system 130 (e.g., by swiping up, tapping, or performing some other gesture on a touch panel display, by a voice input, etc.) to cause the home bar 360 to become viewable. The user may then interact with (e.g., tap) one or more of links 361A-361N to perform the associated function of user system 130. While home bar 360 is described herein with reference to home screen 302, other configurations are possible. For example, home bar 360 may be requested from, and be overlaid on, any of the screens of the graphical user interface described herein.

In an embodiment, the application may also utilize other variations of the multi-screen view and/or multi-modal view illustrated in FIGS. 3I-3K. FIG. 3W illustrates such an embodiment of the application, which utilizes a plurality of module screens 330 or 338 (e.g., as described above in connection with FIGS. 3I-3K), displayed simultaneously in region 348. Each displayed module screen 330/338 may be an active screen with which the user may interact while simultaneously viewing the other displayed module screens 330/338. Each module screen 330/338 may be populated from the same sources (e.g., app modules and functions) and in the manner as the module screens described in connection to FIGS. 3I-3K. The embodiment, illustrated in FIG. 3W, may be implemented in conjunction with a plurality of inactive module screens 330/338, as described with respect to FIGS. 3I-3K. Furthermore, as illustrated in FIG. 3W, a content feed 350 may also be implemented simultaneously with the multi-screen or multi-modal view. In an embodiment, a user may simultaneously populate one or more of the content blocks, one or more module screens 330/338, and/or any combination thereof based on content from any one of the app modules of the application. Accordingly, the user may have instantaneous access to a plurality of module screens and/or content blocks for viewing and managing content, searches, people, notifications, messages, and/or the like in real time.

FIG. 3W illustrates four module screens 330/338, each corresponding to a quadrant of the display of the user system 130. However, other configurations are possible. For example, the application may be configured to display any array of N×M module screens 330/338, where N represents the number module screens 330/338 along a horizontal axis of the array and M represents the number of module screens 330/338 along a vertical axis of the array. The application may simultaneously display any arrangement of N×M (e.g., 1×2, 2×1, 3×1, 1×3, etc.) module screens 330/338 in region 348. In an embodiment, the displayed module screens may be enlarged, reduced, and/or minimized in size based on a user operation. For example, one of the four illustrated active module screens 330/338 may be selected and enlarged to take up two or more quadrants of region 348, including the entire region 348 if desired.

FIGS. 3X-3AA illustrate designs for a variety of the screens described herein, such as home screens 302, category-snapshot screen 308, social-snapshot screen 324, and/or any other screen comprising a plurality of visual representations (e.g., icons, thumbnail images, etc., representing links to app modules, functions, people, etc.). Each illustrated design comprises a lattice pattern (also referred to herein as a “hex pattern”) of visual representations 364. The lattice pattern comprises a plurality of rows, with alternating rows 366 of three visual representations 364 and rows 368 of two visual representations. As illustrated, screen 362 may include three rows 366 and two rows 368. In an embodiment, each visual representation 364 may be spaced equidistantly (or substantially equidistantly) apart from adjacent visual representations 364 in its row and/or adjacent rows. While a specific lattice pattern is illustrated, other lattice patterns are possible, for example, with different numbers of rows and/or different numbers of visual representations per row. More generally, the lattice pattern may comprise rows of N visual representations 364 alternating with rows of N−1 visual representations 364. The application may automatically adjust the lattice pattern, depending on the particular user system 130 displaying the lattice pattern, such that a larger N is used for user systems 130 with larger displays, and a smaller N is used for user systems 130 with smaller displays.

In the event that every visual representation 364 cannot fit on a single screen, the lattice pattern may be scrollable in one or more directions (e.g., up, down, right, left, top-right, top-left, bottom-right, and bottom-left). In this manner, the user can scroll through a larger lattice pattern of visual representations 364 than can be represented on a single screen.

Visual representations 364 may comprise an icon and text describing the link associated with the visual representation 364. As illustrated in FIG. 3X, visual representations 364A may be substantially circular. In a more specific example, illustrated in FIG. 3Z, the visual representations 364C may comprise images of planets or icons representing virtual planets. Similarly, as illustrated in FIG. 3Y, visual representations 364B may be substantially elliptical, and, in a more specific example, illustrated in FIG. 3AA, visual representations 364D may comprise images of galaxies or icons representing virtual galaxies. While specific examples have been described, visual representations of any shape, size, color, design, and/or the like may be arranged in the lattice pattern described herein, including visual representations of different shapes, sizes, colors, designs, and/or the like.

2.8. Other Types of Searches

In an embodiment, the graphical user interface may comprise one or more inputs by which a user can perform a quick and/or extended content search. For example, the application menu, within a particular context or submenu, may comprise a plurality of options comprising specific categories of content. Upon selecting one of the options, representing a specific category of content, the graphical user interface may provide one or more additional inputs by which the user may input search terms or provide additional search criteria, and submit the search. In response to submission of the search criteria, the search criteria are input to a search engine which produces relevant search results, for the selected content category, based on the search criteria. The search engine may utilize the artificial intelligence, described elsewhere herein (e.g., the predictive model described herein), to provide the most relevant search results for the selected content category and the particular user (e.g., according to the user's biases). The search results may be provided using category-snapshot screen 308, a multi-screen view 328, multi-modal view 336, content feed 350, and/or any other means described herein, with the user's preferred source of information displayed most prominently (e.g., in the center position of a galaxy scroll interface 314, in the initial active module screen, etc.).

The difference between the quick and extended content searches may simply be the number of content categories provided in the application menu. A user may switch between a first submenu of the application menu with the quick set of content categories and a second submenu of the application menu with the extended set of content categories, via a simple user operation (e.g., selecting a link or virtual or physical button, a voice input, etc.). The quick set of content categories may include, without limitation, app modules, articles, companies, concerts, flights, games, how-to, images, maps, movies, music, music videos, photographs, news, podcasts, shopping, social media, user-generated content, video, and/or the like. In addition to or instead of the quick set of content categories, the extended set of content categories may include, without limitation, blogs, book summaries, calculator, cartoons and illustrations, case studies, charts and graphs, company news, content curation, charity, data journalism, a “day in the life,” posts, dictionaries, electronic books, email newsletters, frequently asked questions (FAQs), GIFs, guides, helpful app modules and tools, image sliders, infographics, landing pages, lists, locations, mind maps, morphing GIFs, node diagrams, opinion posts, original research, parallax, photo collages, pin boards, polls, predictors, press releases, question and answer (Q&A) sessions, quizzes, quotes, slide shares, state maps, surveys, templates, timelines, tool reviews, vlogs, webinars, white pages, and/or the like.

In an embodiment, the graphical user interface may comprise one or more inputs by which a user can perform a following search. For example, the application may provide a follow-all feature that enables a user to follow people, celebrities, or other users, companies, charities, or other organizations, teams, communities, or other groups, events, sources, and/or any other entity, across any and all social-networking platforms, with a single operation (e.g., a single input, such as a single selection of a link of virtual button, a single voice command, etc.). For example, the application may provide one or more screens, within the graphical user interface, that allow a user to select one of these entities and select a follow-all input (e.g., link or virtual button) that automatically and simultaneously registers the user to follow the entity's posts and/or other activities on all of the social-networking platforms with which the entity has an account. Then, the user may search (e.g., via a search input, similar or identical to search input 306, or a voice input) across all social-networking platforms for all entities that they are following, and the application may display the search results in a multi-screen and/or multi-modal view, content feed, and/or the like. In an embodiment, the user may also search the following activities of other users (e.g., who other users are following), such as friends, family, celebrities, companies, charities, or other organizations, members of the same team, community, or other group, and/or the like.

In an embodiment, the graphical user interface may comprise one or more inputs by which a user can search collections of photographs (e.g., the user's camera roll). Each collection may comprise a plurality of photographs with associated metadata. The metadata for each photograph may comprise one or more tags (e.g., keywords) that have been added by a user and/or automatically by software (e.g., software of the camera that captured the photograph). The user may search (e.g., via a search input, similar or identical to search input 306, or a voice input) the collection(s), and the application may populate a screen of the graphical user interface with photographs associated with metadata that matches the input search terms. The screen may comprise scrollable thumbnails of each matched photograph and/or provide the matched photographs in a multi-screen view 328, multi-modal view 336, content feed 350, and/or the like. In an embodiment, the user could search, across all available sources of photographs (e.g., social media on a plurality of social-networking platforms) or a subset of sources of photographs to which the user is biased (e.g., social media of one or more other users whom the user is following on a plurality of social-networking platforms). Alternatively or additionally, the user may search across only his or her personal collection of photographs (e.g., his or her local or cloud-based camera roll).

In an embodiment, the graphical user interface may comprise one or more screens and/or inputs for searching business information provided by the application (e.g., a search input 306 and/or voice input in business-themed screen 302B). The user may search based on companies, service providers, possibilities, and/or the like. In addition, the user may be able to search the business activities of other users, such as friends, family, celebrities, companies, charities, or other organizations, users who are members of a team, community, or other group of which the user is also a member, and/or the like. Whether other users may search a particular user's business activities may depend on whether or not the particular user has opted in to allowing other users to search his or her business activities. Users may be incentivized to opt in to this search function by receiving a reward (e.g., reward tokens or reward tier) in exchange for opting in.

In an embodiment, the graphical user interface may comprise one or more screens and/or inputs for searching reward information for the user (e.g., a search input 306 and/or voice input in a recognition-themed home screen). The user may search based on ratings, recognition, rewards, access, and/or the like. In addition, the user may be able to search the reward information of other users, such as friends, family, celebrities, companies, charities, or other organizations, users who are members of a team, community, or other group of which the user is also a member, and/or the like. Whether other users may search a particular user's reward information may depend on whether or not the particular user has opted in to allowing other users to search his or her reward information. Users may be incentivized to opt in to this search function by receiving a reward (e.g., reward tokens or reward tier) in exchange for opting in.

In an embodiment, the graphical user interface may comprise one or more screens and/or inputs for searching self-improvement information for the user (e.g., a search input 306 and/or voice input in a self-improvement-themed screen). The user may search content on the spirit, mind, body, or earth, personal analytics, and/or the like. In addition, the user may be able to search the self-improvement information of other users, such as friends, family, celebrities, companies, charities, or other organizations, users who are members of a team, community, or other group of which the user is also a member, and/or the like. Whether other users may search a particular user's self-improvement information may depend on whether or not the particular user has opted in to allowing other users to search his or her self-improvement information. Users may be incentivized to opt in to this search function by receiving a reward (e.g., reward tokens or reward tier) in exchange for opting in.

In an embodiment, the graphical user interface may comprise one or more screens and/or inputs for searching contribution information for the user (e.g., a search input 306 and/or voice input in a give-themed screen). The user may search content on charities, contribution opportunities, the user's personal contributions, and/or the like. In addition, the user may be able to search the contribution information of other users, such as friends, family, celebrities, companies, charities, or other organizations, users who are members of a team, community, or other group of which the user is also a member, and/or the like. Whether other users may search a particular user's contribution information may depend on whether or not the particular user has opted in to allowing other users to search his or her contribution information. Users may be incentivized to opt in to this search function by receiving a reward (e.g., reward tokens or reward tier) in exchange for opting in.

In an embodiment, the graphical user interface may comprise one or more screens and/or inputs for searching all areas which the user is following across all forms of media, including, without limitation, people, companies, events, areas of interest, content sources, charities, and/or the like. In addition, the user may be able to search the areas being followed by other users, such as friends, family, celebrities, companies, charities, or other organizations, users who are members of a team, community, or other group of which the user is also a member, and/or the like. Whether other users may search a particular user's following information may depend on whether or not the particular user has opted in to allowing other users to search his or her following information. Users may be incentivized to opt in to this search function by receiving a reward (e.g., reward tokens or reward tier) in exchange for opting in.

In an embodiment, the graphical user interface may comprise one or more screens by which a user can view, filter, and/or search his or her social network, including the user's personal network (e.g., friends and family) and business network (e.g., coworkers). The screen may list a description for each contact, including, for example, the contact's thumbnail image or avatar, name, profession, employer, and/or the like, along with a link for contacting the contact (e.g., using a messaging function provided by the application). The user may search the list of contacts within his or her social network by profession, keywords, location (e.g., city, postal code, state, country, continent), languages spoken, highest-rated, most popular, contributions, and/or the like.

2.9. Simultaneous Population

In an embodiment, the application may simultaneously populate an active screen, multi-screen view 328, multi-modal view 336, and/or content feed 350 of the graphical user interface, from any function or result of a function. This simultaneous population may be performed in response to a user operation (e.g., user selection of an option in the application menu, voice input, etc.) performed with respect to a particular function or functional result. For example, in response to a user operation with respect to a broadcast that the user sent, the application may simultaneously populate a multi-screen view 328, multi-modal view 336, and/or content feed 350 with the broadcast responses (e.g., one broadcast response per module screen or content block). As another example, in response to a user operation with respect to search results, the application may simultaneously populate a multi-screen view 328, multi-modal view 336, and/or content feed 350 with the search results (e.g., one search result per module screen or content block). As yet another example, in response to a user operation with respect to notifications, the application may simultaneously populate a multi-screen view 328, multi-modal view 336, and/or content feed 350 with all, recent, or unread notifications (e.g., one notification per module screen or content block).

In an embodiment, the application may also enable a user to easily exchange a multi-screen view 328 and/or multi-modal view 336 with a content feed 350. For example, in response to a user operation (e.g., user selection of an option in the application menu, voice input, etc.), the application may generate a content block 352 for each existing active and inactive module screen of the multi-screen view 328 and/or multi-modal view 336, and generate and render a new content feed 350 with all of the generated content blocks 352. At the same time, the application may generate a module screen for each content block 352 in the existing content feed 350, and render all of the generated module screens in a new multi-screen view 328 and/or multi-modal view 336. In this manner, the user can easily populate an existing multi-screen view 328 or multi-modal view 336 with the existing content feed, and populate the existing content feed with the existing multi-screen view 328 or multi-modal view 336.

Alternatively or additionally, the application may enable a user (e.g., via another user operation) to move the content of an existing content feed 350 into an existing multi-screen view 328 or multi-modal view 336, without replacing the content of the existing content feed with the multi-screen view 328 or multi-modal view 336. In this case, the content feed 350 may end up with the same content as the multi-screen view 328 or multi-modal view 336, or may be removed from the display entirely as redundant. Similarly, the application may enable the user to move the content of an existing multi-screen view 328 or multi-modal view 336 into an existing content feed 350, without replacing the existing multi-screen view 328 or multi-modal view 336 with the content feed 350.

In an embodiment, the graphical user interface may comprise a results screen, which is configured to succinctly list the functional result of any function of the application. For example, the results screen may comprise a simple scrollable list with each functional result on a separate row of the list. A user may switch from the results screen to another view of the functional result (e.g., multi-screen view 328, multi-modal view 336, content feed 350, category-snapshot screen 308, galaxy scroll interface 314, etc.) and/or from another view of the functional result to the results screen, by a simple user operation (e.g., user selection of an option in the application menu, a voice input, etc.). Thus, a user may quickly and easily switch between the results screen and other views. The functional results, that may be displayed and switched in this manner, may include, without limitation, search results, broadcast results, newsfeed results, recommendations, notifications, and/or the like.

2.10. At-a-Glance Screens

In an embodiment, the graphical user interface may comprise at least one at-a-glance screen, which comprises a visual representation of each open instance of an app module or each home screen 302. The visual representations may be linked to the screen that it represents, and the application may transition to the linked screen, to render the linked screen as the currently active screen being displayed on the display of a user system 130, whenever one of the visual representations is selected.

For example, a first at-a-glance screen may comprise a scrollable grid of thumbnail images of the current content in the screen of each open instance of an app module. A user may switch from this first at-a-glance screen to another view of the content (e.g., multi-screen view 328, multi-modal view 336, content feed 350, etc.) and/or from another view of the content to the first at-a-glance screen, by a simple user operation (e.g., user selection of an option in the application, a voice input, etc.). Thus, a user may quickly and easily switch between the first at-a-glance screen and other views. However, the first at-a-glance screen may also be accessible from any other screen (e.g., via an option of the application menu, a voice input, etc.), regardless of the view. Advantageously, the first at-a-glance screen allows a user to quickly and easily view every instance of an app module that is currently being executed (e.g., within the application). In addition, the application may provide one or more screens and/or inputs which enable the user to add closed app modules into the first at-a-glance screen (e.g., via a drag-and-drop operation), and responsively open the added app modules. Furthermore, the application may provide one or more screens and/or inputs which enable the user to drag and drop an open app module from the first at-a-glance screen into a module screen of a multi-screen view 328 and/or a multi-modal view 336, and/or a content block of a content feed 350.

Similarly, a second at-a-glance screen may comprise a scrollable grid of icons (e.g., galaxy images) representing each home screen 302 and/or other themed screen. A user may switch from this second at-a-glance screen to the universe view (or combined universe and multi-modal views) and/or from the universe view to the second at-a-glance screen, by a simple user operation (e.g., user selection of an option in the application menu, a voice input, etc.). Thus, a user may quickly and easily switch between the second at-a-glance screen and the universe view. However, the second at-a-glance screen may also be accessible from any other screen (e.g., via an option of the application menu, a voice input, etc.). Advantageously, the second at-a-glance screen allows a user too quickly and easily view and access every home screen 302.

In an embodiment, each at-a-glance screen may display each visual representation (e.g., thumbnail image or icon) in a lattice pattern. For a mobile user system 130 (e.g., with a small display size), the lattice pattern may comprise alternating rows of three and two visual representations per row (e.g., rows having three visual representations alternating with rows having two visual representations, with the topmost row comprising three visual representations). In another implementation or for user systems 130 for which the display size is not so restrictive, the lattice pattern may comprise alternating rows of any other odd (e.g., N) and even (e.g., N−1) number of visual representations.

In the event that every visual representation cannot fit on a single screen, each at-a-glance screen may be scrollable in one or more directions (e.g., up, down, right, left, top-right, top-left, bottom-right, and bottom-left). In this manner, the user can scroll through a larger lattice pattern of visual representations than can be represented on a single screen.

In an embodiment, each at-a-glance screen may also be populated into a content feed 350 (e.g., via a user operation). In the case of the first at-a-glance screen, the resulting content feed 350 would comprise a content block 352 representing the content in the screen of each open instance of an app module. In the case of the second at-a-glance screen, the resulting content feed 350 would comprise a content block 352 representing each home screen 302. Similarly, each at-a-glance screen may also be populated into a multi-screen view 328 and/or multi-modal screen 336 (e.g., via a user operation).

2.11. Additional Functions

In an embodiment, the graphical user interface of the application comprises a peer-to-peer communication feature, which allows users to communicate via instant messaging, audio call, and/or video call. For security, the communications may utilize end-to-end encryption. The application may enable the user to search his or her communication history (e.g., via a search input 306), as well as communication histories across all third-party messaging platforms available through the application. In an embodiment, the user may search all messages for a particular subset of other users, such as a subset of users with a personal relationship to the user (e.g., friends, family, etc.), a subset of users with a business relationship to the user (e.g., coworkers), a subset of users who are members of a team, community, or other group of which the user is also a member, and/or the like.

In an embodiment, the graphical user interface of the application comprises a follow-all feature, which may be accessed via one or more follow-all screens and/or inputs. The follow-all feature enables a user to follow various people, celebrities, companies, charities, or other organizations, teams, communities, or other groups, events, and/or any other information sources, across any and all relevant content sources, via a single input (e.g., selection of an input or option within a follow-all screen or the application menu, a voice input, etc.). Thus, with a single input, a user can instruct the application to add the user as a follower for a particular entity across all applicable content sources. For example, the user may access a follow-all screen (e.g., by selecting a link 304 on people-themed home screen 302C) for a particular celebrity. The follow-all screen may comprise a description of the celebrity (e.g., thumbnail image, name, description of who the celebrity is and/or for what he or she is a celebrity), and a list of all content sources on which the celebrity posts information (e.g., each social-networking platform on which the celebrity has an account). Each content source may be associated with an input, and the user may select each individual content source, which the user wants to follow, for that celebrity. For instance, the user could choose to follow the celebrity on Instagram™ and Twitter™, but not Facebook™ or Internet Movie Database™ (IMDB). In addition, the follow-all screen may accept a single input which selects all of the content sources simultaneously. Whether the user selects all or a subset of the content sources, the application will begin notifying the user (e.g., via notifications) when new content is available from the celebrity at any of the selected content sources.

In an embodiment, a user may view the identities of other users, within the user's social network, who are currently viewing or otherwise connected to the same content as the user. For example, if a user is viewing content from his or her content feed 350 (e.g., within region 348), in response to a user operation (e.g., selection of an option in the application menu, voice input, etc.), the application may display a visual representation (e.g., text, thumbnail image, link, etc.) for each other user or subset of users (e.g., friends, personal network, business network, team, community, or other group, company or other organization, etc.), within the user's social network, who is also connected to the same content.

In an embodiment, the application may crawl social-networking platforms to automatically identify and/or generate user profiles for potential users. For example, the application may automatically fill in fields of a user profile using information parsed or otherwise retrieved from the accounts of a potential user on one or more social-networking platforms (e.g., Facebook™, Linkedln™, etc.). The application may then send an invitation to the potential user (e.g., via a messaging function of one or more of the crawled social-networking platforms, via a message to a contact number or email address provided by one or more of the social-networking platforms, etc.), inviting the potential user to register with the application (i.e., set up an account with the application). In an embodiment, the potential user may establish the account and/or begin or complete the registration process simply by selecting a single input within the invitation (e.g., a link to a URL established for the pre-generated user profile) and/or within the graphical user interface (e.g., link or virtual button in a screen linked to by a URL in the invitation) to “claim” the user profile that was previously generated by the application in advance.

In an embodiment, any of the groupings of content described herein (e.g., search results, broadcast messages received, notifications received, and/or groupings of content generated by or otherwise resulting from other functions of the application) may be limited, for example, to a maximum number. For example, the results for one or more of the types of searches, described herein, may be limited to the top ten, top twenty, top fifty, and/or the like. As discussed elsewhere herein, the content in such groupings may be ranked by the artificial intelligence, based on the searching user's biases. Alternatively or additionally, the content may be ranked by most recommended (e.g., the number of users who recommended each content item) and/or most popular (e.g., the number of users who have viewed each content item). In an embodiment, company-users may bid to increase the ranks of their content (e.g., advertisements) within a grouping. However, in order to preserve the integrity of the groupings (e.g., search results), the application may only increase the rank of a particular content item being bid up, if that content item would have made it into the maximum number of content items without the increase in rank. Furthermore, in order to encourage contributions and/or positive interactions, the rank of content from person-users and/or company-users may be increased based on the users' prior contributions (e.g., reward tokens and/or tier), ratings, and/or the like.

In an embodiment, the graphical user interface may comprise a user profile screen that displays personal data 422, collected for a user, in a particular arrangement. For example, the user profile screen for a company may comprise the company's logo, name, location (e.g., address), website, industry, size, type, ratings, contributions, and/or one or more media (e.g., one or more videos about or related to the company). In addition, the user profile screen may comprise a content feed 350 comprising content blocks representing content related to the user and/or selected by the user, associated with the user profile.

In an embodiment, the application may enable a user to open an external app on his or her user system 130 into a function of the application (e.g., a module screen of multi-screen view 328 and/or multi-modal view 336, a content block of content feed 350, a search result, a broadcast, a notification, a galaxy scroll interface 314, a category-snapshot screen 308, etc.). For example, a user may search external apps on his or her user system 130 (e.g., using a native function of user system 130 or a function of the application) and feed screens and/or functions from one or more of the external apps into screens and/or functions of the application. In an embodiment, the graphical user interface enables the user to specify the location (e.g., screen or function) into which the screen or function of the external app should be fed.

In an embodiment, the application may have public functions, which are available to non-users (e.g., not possessing an account with the application) and users (e.g., possessing an account with the application) alike, in addition to private functions, which are only available to users. For example, public functions may include, without limitation, searches (e.g., by preferred sources, most popular, location, highest-rated, etc.), multi-screen and/or multi-modal views and searches, searches of photograph collections, app module searches, the follow-all function, content related to personal development, live shows, a political content feed, and/or the like. Whichever functions are not public may remain private, so as to incentive non-users to become users.

In addition, in an embodiment, the application may offer account tiers. For example, the lowest tier may be a free tier, which offers screens and/or functions of the application that are available to all users for free. Higher tiers may require a subscription fee and offer access to further screens and/or functions that are not available at the free tier, such as the ability to opt out of advertisements and/or the collection of certain data. It should be understood that further tiers are possible, for example, in exchange for higher subscription fees.

In an embodiment, the application may enable users to anonymously vote and/or interact with (e.g., provide an opinion on) a particular topic (e.g., politics, proposed legislation, regulations, sports, news, etc.), similarly to a secret ballot. The application may aggregate the votes and/or interactions, across all users, to generate anonymous statistics on the votes, opinions or sentiments in the interactions, demographics, and/or the like regarding the particular topic. These statistics may be fed into the data sets used by the artificial intelligence (e.g., the predictive model described herein), the analytics, and/or any other function of the application described elsewhere herein.

2.12. Emulation

In an embodiment, the application may be configured to emulate one or more functions simultaneously on one or more external devices. The application may be able to emulate any of the screens of the graphical user interface described herein. Furthermore, the user may dictate which function is to be emulated on which device.

User system 130 may be communicatively coupled to a plurality of displays. Example displays may include, without limitation, a television, a computer monitor, a laptop computer, a tablet computer, a smart phone, and/or the like. User system 130 may be communicatively coupled to the displays through, for example, network(s) 120, a LAN connection, Bluetooth™ connection, Wi-Fi™ connection, and/or any standard communication protocol. The application may be configured to emulate a screen of the graphical user interface on each of the plurality of displays. For example, the application may be rendering a broadcast-results screen 342, a people search function, and a multi-modal view 336. The application may communicate and emulate the screens for each of these on a different display. For instance, the application may display broadcast-results screen 342 on a communicatively coupled television, the people search results on a communicatively coupled computer monitor, and multi-model view 336 on both a communicatively coupled tablet computer and the native display of user system 130 (e.g., a smartphone). The application may synchronize each device for simultaneously viewing and interaction by the user within the application (e.g., for viewing or interacting with the same content on two different displays).

3. Process Overview

Embodiments of processes for various functionality of the social media system will now be described in detail. The described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130 such that some portions or modules of the application are executed by platform 110 and other portions or modules of the application are executed by user system(s) 130. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

3.1. Data Modeling

As discussed throughout the present description, much of the functionality in the application may be personalized or biased for each particular user. For example, the application may collect data indicative of the user's biases, such as data relevant to preferences, interests, activities, history, and/or any other user-specific data acquired by usage of the application by a user. For example, descriptive user-specific data may be received, parsed, and/or inferred from data input during a user registration process (e.g., via a registration screen of the graphical user interface), a user objective (e.g., user requests, needs, wants, desires, goals, etc.), surveys, search terms entered by a user for any type of user search (e.g., snapshot search, multi-screen search, multi-modal search, content feed search, people search, content search, etc.), search results that were accessed and/or not accessed by the user, content of communications exchanged via the application (e.g., broadcast messages, broadcast notifications, broadcast responses, requests, offers, etc.), and/or any other interactions that the user has with the application.

In an embodiment, the descriptive user-specific data is stored in a descriptive user data model that drives the artificial intelligence (e.g., the predictive model described herein) to bias search results, content, and/or the like for the associated user. For example, the application may use the descriptive user data model to train the artificial intelligence for a particular user. In an embodiment, training the artificial intelligence includes a feedback loop. For example, the artificial intelligence may access the descriptive user data model to retrieve descriptive data indicative of a user bias. The artificial intelligence may then bias the results of a user search, analyze the user's interaction with the search results (e.g., which search results the user finds helpful and/or which search results the user does not find helpful), and updates the descriptive user data model based on those interactions.

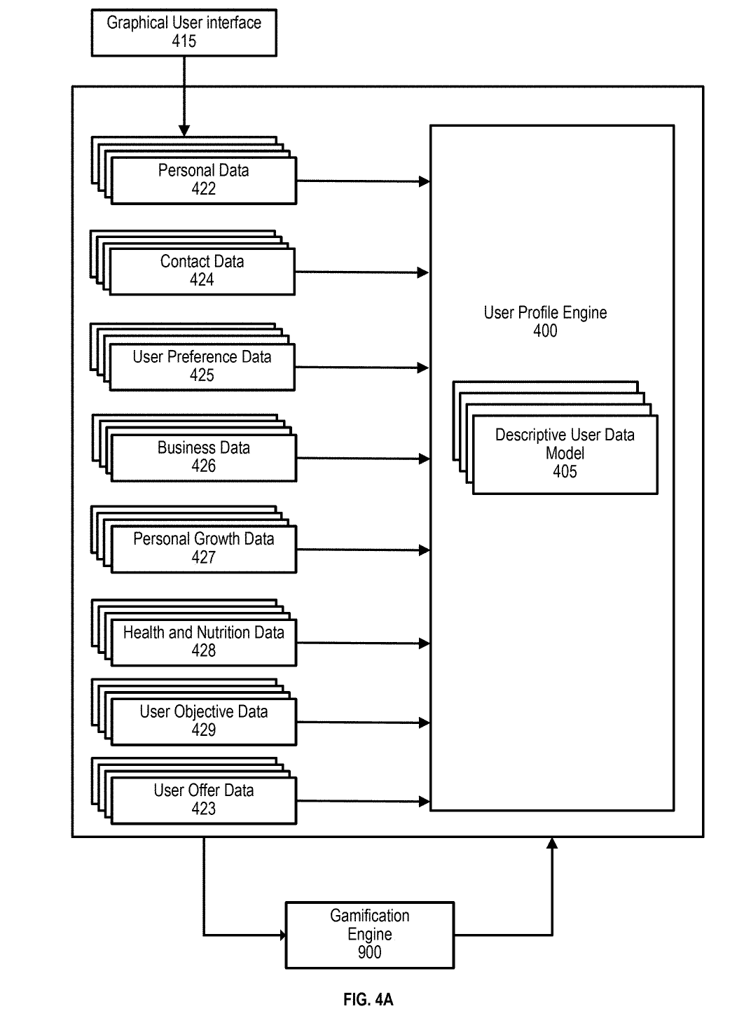

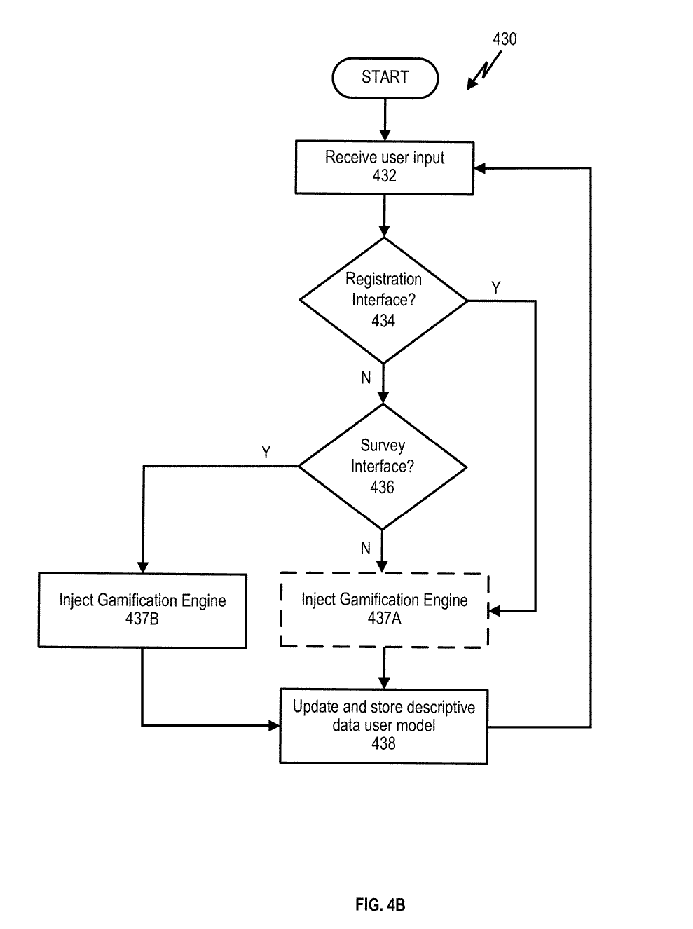

FIG. 4A illustrates an example of the operation of a user profile engine 400, according to an embodiment. User profile engine 400 may be a software module of the application. User profile engine 400 aggregates, or facilitates aggregation of, categories (e.g., categories 422-429) of descriptive data from a plurality of data sources to generate a descriptive user data model 405. Descriptive user data model 405 may be a collection of data indicative of the user's biases. As used with respect to disclosed embodiments, descriptive data may refer to data and information received by the application, for example, provided by and in association with a given user of the application that is indicative of the user's biases (e.g., preferences, interests, activities, social network, personality, likes/dislikes, etc.).

In an embodiment, user profile engine 400 aggregates descriptive data from a plurality of users and generates a plurality of descriptive user data models 405, each associated with a different user of the plurality of users. The data sources may be one or more app modules and/or other functions of the application, as described elsewhere herein. For example, a user may interact with a graphical user interface 415 (e.g., the graphical user interface described throughout the present disclosure) to input data and execute one or more app modules of the application, and the executed app modules may then inject the data into user profile engine 400.

Each descriptive user data model 405 comprises a table or other data structure comprising a plurality of data categories (e.g., categories 422-429) of descriptive data in association with a given user. In an embodiment, the data structure may comprise a plurality of embedded data fields into which descriptive data may be entered and stored. Each category of descriptive data may be an individual table or other data structure, and the descriptive data may include a plurality of types of descriptive information, as described below. The data structure of each category may be included and updateable within descriptive user data model 405. For example, as a given user interacts with graphical user interface 415, the corresponding module of the application may receive data inputs and inject the data inputs into user profile engine 400. User profile engine 400 may then extract data from the data inputs, process the data to determine a descriptive nature, and store it as part of the corresponding data structure. The data structure may then be utilized by the artificial intelligence (e.g., the predictive model described herein) to bias functions for a particular user. For example, the artificial intelligence may access the data structure to determine preferences, interests, activities, and/or the like of the user, and utilize this determination in performing other functions of the application.

User profile 400 may determine the descriptive nature of received data, and utilize the determined descriptive nature to identify in which one or more categories 422-429 to store the data (e.g., the identified of other users with whom the user interacts may be identified as contact data 424, while foods and locations may be identified as user preference data 425). In an embodiment, the descriptive nature may be determined based, at least in part, on the source from which the data is received. For example, data from a registration process may be more likely to relate to personal data of the user, while search terms used by the user in a search may be indicative of user preferences. Additionally, or alternatively, the descriptive nature may be determined, at least in part, on the artificial intelligence (e.g., the predictive model described herein) that has been trained over time based on previously stored descriptive data.

In an embodiment, a plurality of descriptive user data models 405 are stored in a database (e.g., database 114), with each descriptive user data model 405 associated with a different user. Each descriptive user data model 405, corresponding to a particular user, may be stored locally on a user system 130 of the user (e.g., in database 134) or remotely on platform 110 (e.g., in database 114). In addition, user profile engine 400 may be executed locally, as a module of client application 132, to generate the descriptive user data model 405 of a particular user. Alternatively or additionally, user profile engine 400 may be executed remotely on platform 110 as a module of server application 112.

User profile engine 400 may comprise or be interfaced with one or more sources of descriptive data, such as one or more functions of the application. The application may inject data into user profile engine 400 for processing based on an input received from the user during use of each function. For example, the application may receive search terms to execute a search function. The application may inject the search terms into user profile engine 400. Such search terms may be indicative of a user's biases. In an embodiment, the application may also inject information related to the user's interactions with search results (e.g., whether or not a certain result is accessed by the user). In the case that the user accesses a result, the application may infer that the result is relevant to the user's biases, whereas, in the case that the user does not access a result, the application may infer that the result is not relevant to the user's biases. In some cases, such analysis may also indicate that a publisher or content owner is of particular interest to the user or is not of interest to the user. Similarly, the application may process and extract information from messages (e.g., broadcast messages or other messages) or other interactions throughout the application, to inform user profile engine 400, for example, using a conventional natural language parser to identify context and usage. While certain sources of user data are described herein, it should be understood that these sources are merely illustrative, and that user profile engine 400 may comprise or be interfaced with fewer, more, or different sources than those discussed herein. For example, user profile engine 400 may be interfaced with one or more app modules, an API of the operating system of user system 130, and/or any source of data input by the user into user system 130.

User profile engine 400 may be described herein as receiving descriptive data from or injected by various functions of the application. However, it should be understood that the receipt of data by user profile engine 400 may also refer to an instance in which information is received by user profile engine 400, and user profile engine 400 then derives and categorizes the data from the received information. For example, user profile engine 400 may derive descriptive data from information received from a source by extracting character strings from the information to be used as descriptive data, and then aggregating that descriptive data into the descriptive user data model 405 associated with a particular user. Injection may comprise inputting the descriptive data into embedded data fields and/or data structure of user profile engine 400 and/or otherwise associating the descriptive data with a particular user.

In an embodiment, user profile engine 400 may retrieve the information (e.g., descriptive data) automatically (e.g., without user input), semi-automatically (e.g., after user confirmation, for example, in response to a prompt within the graphical user interface or upon establishing a communication connection with a network), or manually (e.g., in response to a specific user input or request).

In an embodiment, user profile engine 400 may receive information from a gamification engine, as described in more detail elsewhere herein. The gamification engine may receive descriptive data from a plurality of sources and reward users in the form of tokens and/or tiers based on the user's activity within the application. The gamification engine may then inject allocated rewards data, associated with a user, into user profile engine 400, to be included in descriptive user data model 405.

The various types of descriptive data will now be described in more detail. However, the descriptive data described herein are merely examples and not intended to be limiting. FIG. 4A illustrates a plurality of categories 422-429 of descriptive user data. Each category of user data may comprise a plurality of different types of information and/or data points that may be aggregated by user profile engine 400 to generate descriptive user data model 405. Exemplary categories include, without limitation, personal data 422, user offer data 423, contact data 424, user preference data 425, business data 426, personal growth data 427, health and nutrition data 428, and/or objectives data 429. Example data points of each category 420-429 are provided in Table 1 below. In an embodiment, a single data point may be associated with multiple categories (e.g., a contact may be a personal contact as well as a business contact). These data points are intended for illustrative purposes only, and are not exhaustive of the type of information that is collected and aggregated in user profile engine 400.

TABLE 1
Descriptive User Data Model

Personal Data
Name
Address
Geolocation
Photos
Religion
Political Party
Contact Data
Contact Network
Relationship Tier
Interaction Level
Social Platform(s)
School(s)/Alumni
Preferences Data
Food Taste
Movies
Books
Ratings
News Sources
Celebrities
Friends
Business Data
Business Type
Services Preferred
Rank in Network
Ratings on Service
Personal Growth Data
Myers-Briggs Type Indicator
Jung's Personality Metrics
Astrological Sign
Chakras
IQ
Introvert/Extrovert Personality Traits
Kabbalah
Health and Nutrition Data
Illness
Nutrition
Pain
Exercise
Supplements
Medications
User Objective data
User Requests
Service Requests
Item Requests
Advice Requests
Donation Requests
Assistance Requests
User Needs, Wants, Desires, Goals, etc.
Inferred Needs, Wants, Desires, Goals, etc.
Point Allocations
User Offer Data
User Offers
Service Offers
Item Offers
Advice Offers
Donation Offers
Assistance Offers

In an embodiment, personal data 422 comprises data and information related to the identity and personal information of the user. For example, personal information for a person may include, without limitation, a name, address (e.g., street and street number, city, state, postal code, country, etc.), ethnicity, gender, current and/or previous geolocation, spiritual information (e.g., religious affiliation), political party, language(s) spoken, interests (e.g., keywords, books, movies, music, etc.), organizations, communities or other groups of which the user is a member, profession, prior profession, education level, age, background, career keywords, business history, skills, awards, current projects, business possibilities, areas of knowledge, programs and/or seminars taught by the user, mentors or other people whom the user admires, research, strengths, areas in which the user wishes to improve, and/or the like. Personal information for a company may include, without limitation, a name, address, contact information (e.g., telephone number, fax number, email address), website address, type (e.g., public or private), industry, languages supported, geographic research, revenue, number of employees, awards, organizations of which the company is a member, keywords, open job positions, statement(s) about the company (e.g., summary, intention, vision, history, etc.), culture of the company (e.g., as keywords), past, current, and/or future projects, global footprint, actions taken related to the company's global footprint, from where the company sources, manufacturing, laws or policies supported by the company, and/or the like. Personal data 422 may also include data extracted based on photographs stored by the user, such as personal attributes (e.g., eye color, height, hair color, etc.). Personal data 422 may further include marriage status, educational background, employment status and/or history, and/or the like.

In an embodiment, contact data 424 comprises data and information related to the user's contact network and/or connections with other persons. Contact data 424 may include, without limitation, family members, friends, business contacts, alumni base contacts, schoolmates, or other contacts that the user may have. The contact network may include other users of the application or may include contacts outside of the application. For example, the application may retrieve the user's contacts from one or more social-networking platforms (e.g., Facebook™, Instagram™, Linkedln™, etc.).

In an embodiment, each contact may be associated with a degree of separation from the user (also referred to herein as a “relationship tier”). Relationship tiers comprise a first tier, second tier, third tier, and so on, based on whether the user is in direct connection with the contact or the user is connected to the contact via one or more other contacts. The degrees for the relationship tiers need not be limited to three degrees, and may be any number of degrees.

In an embodiment, each contact may be ranked against other contacts based on that contact's relationship with the user (e.g., how close the contact is with the user). For example, family members may be ranked higher than alumni contacts. Alternatively or additionally, each contact may be associated with a level of interaction, based on how often or frequently the user interacts with the contact. Higher levels of interaction may be indicative of contacts that are closer to the user than other contacts.

In an embodiment, user preference data 425 comprises data and information related to the user's tastes and preferences. For example, user preference data 425 may include, without limitation, the user's preference with respect to food, movies, books, television shows, and/or the like. Preference data 425 may also include preferences in news sources, subject matter, celebrities, and/or contacts (e.g., preference of a first contact over a second contact).

In an embodiment, business data 426 comprises data and information related to the business and services either utilized or performed by the user. For example, the user may be part of or involved in one or more companies, the user may own one or more companies, have invested in one or more companies, be interested in one or more companies, and/or the like. Business data 426 may include, without limitation, information related to the user's employment (e.g., business sector, type of company, customer base, product and services offered, etc.), the user's employees and/or coworkers, preferred services and/or products, information related to the user's position within the business environment, and/or the like.

In an embodiment, each business accessed by the user may be ranked against other businesses. For example, companies that the user is part of or involved with may be ranked higher than other companies. Alternatively or additionally, each company may be associated with a level of interaction, based on how often or frequently the user interacts with a company (e.g., via messaging, notification, searches, etc.). Higher levels of interaction may be indicative of companies that are to be ranked higher than others. The ranking may be stored as data associated with the descriptive data.

In an embodiment, the services and/or products offered by the user or a company associated therewith may be rated by other users who have received and/or used that user's services and/or products. The rating may be stored as data and associated with the corresponding business data 426.

In an embodiment, personal growth data 427 comprises data and information related to indicators of a user's mental health. Personal growth data 427 may also be related to personality traits, psychological, mental, and/or spiritual indicators, and/or the like. Personal growth data 427 may be based, for example, on a Myer-Briggs Type Indicator, Jung's Personality Metrics, astrological signs, Chakras, Intelligence Quotient, introvert and/or extrovert personality traits, Kabbalah, and/or the like. Other similar indicators and metrics may be included as well. In an embodiment, personal growth data 427 may include information for assisting the user to achieve mental, psychological, and/or spiritual goals, such as improving the user's well-being by understanding their personality. For example, personal growth data 427 may indicate that the user exhibits extroverted personality traits, and the application may, for example, return user-specific search results that are particularly aimed at extroverted personalities. As another example, a user may search for “things to do in San Diego” and, if the user is associated with being an extrovert, the application may return results of festivals, meet and greet events, and other types of social events. On the other hand, if the user is associated with being an introvert, the application may return results that are not centered around large groups of people, such as, learning new skills and inner personal activities. It will be understood that personal growth data 427 may be similarly applied to the other functions of the application as well.

In an embodiment, personal growth data 427 may be received from the user. For example, personal growth data 427 may be entered in a registration screen and/or survey screen, as described elsewhere herein. In an embodiment, personal growth data 427 may be determined, at least in part, by the artificial intelligence (e.g., the predictive model described herein) based on other descriptive data. For example, the artificial intelligence may analyze other descriptive data to determine one or more indicators included in personal growth data 427. As another example, certain searches or user inputs may be indicative of certain personality traits (e.g., constantly searching for social gatherings may be indicative of an extroverted personality). As another example, user interactions may be utilized by the application to fill out a questionnaire automatically, without user response.

In an embodiment, user objective data 429 comprises data and information related to one or more user requests, needs, wants, desires, goals, etc. User objective data 429 may include, without limitation, user requests, needs, and/or goals of services, goods, donations, and/or the like. Such requests, etc. may be explicitly provided by the user and/or inferred by the application (e.g., using the artificial intelligence, for example the predictive model described elsewhere herein). In an embodiment, contribution data may be included in user objective data 429. User objective data 429 may be utilized in connection to the exchange of needs and offers, described elsewhere herein. In an embodiment, user objective data 429 may also include a point value. For example, any given user request may be associated with a predetermined point value for use in the gamification engine described elsewhere herein. Thus, when another user fulfills the user request, the other user may be allocated a reward (e.g., reward tokens or tier) based on the associated point value. Furthermore, in an embodiment, a value determined by the user may be associated with user objective data 427. For example, user objective data 429 may include a request for a “1903 silver dollar” and be associated with a value to the user of $60 (the amount the user is willing to pay for this item). Similarly, user offers may include items and amounts that may be used in executing the exchange described elsewhere herein.

In an embodiment, user offer data 429 comprises data and information related to one or more user offers, tenders, etc. User offer data 429 may include, without limitation, user offers, tenders, bids, suggestions, etc. of services, goods, donations, and/or the like. Such offers, etc. may be explicitly provided by the user and/or inferred by the application (e.g., using the artificial intelligence, for example the predictive model described elsewhere herein). In an embodiment, contribution data may be included in user offer data 423. User offer data 423 may be utilized in connection to the exchange of needs and offers, described elsewhere herein. In an embodiment, user offer data 423 may be utilized to acquire points and/or rewards associated with one or more other user's objective data 429. For example, as described above, any given user request may be associated with a predetermined point value, and when a user fulfills the user requests via the user objective data 429, the user may be allocated a reward based on the point value associated with the reward. Furthermore, user offers may include descriptions of items and amounts, values that may be used in executing the exchange described elsewhere herein.

In an embodiment, user objective data 429 and user offer data 423 may be received from the user. For example, user objective data 429 may be input by the user into a registration screen and/or survey screen, as described below, or another user input. Similarly, a user may input user offer data 423 into registration screens, survey screens, or any other input screen associated with user offers.

In an embodiment, user objective data 429 and user offer data 423 may be utilized, at least in part, by the artificial intelligence (e.g., the predictive model described herein) to suggest biased connections for fulfilling user requests. For example, the artificial intelligence may pull one or more user requests from user objective data 429 (e.g., “1903 silver dollar”) and pull descriptive data from another category (e.g., contact data 424) of a first user. The artificial intelligence may also pull descriptive data of the other users, for example, one or more of the contacts of the first user's contact data 424. The pulled data from the contact may include another user's offer data 423, which may include user offers having at least one data point that is relevant to the first user's request. The artificial intelligence may then suggest a connection between the users based on the user objective data 429 and user offer data 423. In an embodiment, the offer may be an exact match to the request (e.g., the contact has a “1903 silver dollar” for sale), may be an acceptable replacement to the request (e.g., the contact has a “1905 silver dollar” for sale, is connected to someone who has a “1903 silver dollar”, etc.), and/or direct the artificial intelligence to additional users.

In an embodiment, health and nutrition data 428 comprise data and information related to a user's physical health. Health and nutrition data 428 may include medical history and current health indicators. For example, health and nutrition data 428 may include, without limitation, prior medical illnesses, surgeries, conditions, prior and/or current medications, and/or other medical events of the users. Health and nutrition data 428 may also include health indicators and guidelines for the user derived, for example, based on the user's personal data. For example, health and nutrition data 428 may include diet information, nutrition guidelines for maintaining health standards (e.g., based on a user's age, gender, weight, ethnicity, etc.), supplement guidelines, exercise programs, and/or the like. Health and nutrition data 428 may include both prior and current medical status, as well as information for assisting the user to achieve a desired health goal or target (e.g., weight loss, strength, general health, etc.).

In an embodiment, descriptive data may comprise a relevance indicator corresponding to data comprised in each category 422-429. The relevance indicator may indicate that a particular data point is of particular interest or relevance to the user. In an embodiment, the relevance indicator may be a weighting associated with each data point, that is comparable and rankable against other data points in descriptive user data model 405. Thus, data points that are more relevant (e.g., of more interest to the user, more liked by the user, or in the direction of a user's particular bias) may have a higher weight than other data points. In an embodiment, the relevance indicator may be based, for example, on a computation of the frequency and/or number of times a user interaction causes the data point to be injected into user profile engine 400. For example, a user may search the same or similar terms frequently, which may be indicative of the user's interest or preference for the particular search term. As another example, repeated access to the same website may be indicative that the user prefers that website over other websites as a content source.

In an embodiment, the categories and/or data points therein may be, at least partially, determined or influenced by the artificial intelligence described elsewhere herein (e.g., the predictive model described herein). For example, the artificial intelligence may determine whether an input is relevant to the user and with which category 422-429 the data point should be associated.

In various embodiments, user profile engine 400 may develop a dynamically updateable representation of the biases of the user based on continuously received descriptive data from one or more functions of the application over time. For example, the user may interact with the application over an extended period of time, and, based on each interaction, the corresponding functions of the application may inject descriptive data into user profile engine 400. User profile engine 400 may then update descriptive user data model 405, at least in part, based on each received descriptive data over time. In this way, descriptive user data model 405 is constantly updated and modified. For example, in the background, user profile engine 400 may collect and aggregate any and all information entered by the user into the application. In an embodiment, the updateable descriptive user data model 405 may be utilized to train the artificial intelligence (e.g., the predictive model described herein) over time as the user inputs or otherwise generates increasing amounts of descriptive data. For example, each time the artificial intelligence accesses descriptive user data model 405, it has access to increasingly greater amounts of information from which it can determine the user's biases.

In an embodiment, descriptive data may be generated based on one or more data points from multiple functions of the application. As an example, the descriptive data may comprise a listing of contacts 424 for a first user. Each contact may represent another user of the application having another associated descriptive user data model 405. User profile engine 400 may derive additional data points for the first user by retrieving the other user's descriptive data and aggregating these with the first user's descriptive data, for example, as preferences data 425 of the first user. For example, user profile engine 400 may determine that, based on a relationship between users, a first user may share similar interests with their contacts (e.g., friends and family). In an embodiment, a weighting may be applied to the derived data points. For example, preference data 425, received directly from the user, may be associated with a higher weighting (e.g., more relevance) than preference data 425 inferred from a user's activities in the application and/or another user's descriptive user data. Similarly, descriptive data derived from a contact with whom the user has a direct connection may have a higher weighting than a contact 426 with whom the user has an indirect connection.

In an embodiment, descriptive data may be generated based on multiple data points. That is, one or more descriptive data for a user may be derived based in part from a first descriptive data. In an embodiment, the derived descriptive data may correspond to a category (e.g., category 422-429) that may be the same or different than the first descriptive data. As an example, health and nutrition data 428 may be derived based on other descriptive data, such as personal data 422. For example, an exercise descriptive data point, dieting data point, nutrition data point may be derived based on a user's age, weight, ethnicity, gender, or other relevant data of personal data 422. Similarly, as described above, personal growth data 427 may be derived from other descriptive data. While a specific example is described herein in reference to the health and nutrition data 428, similar derivations may be applied to other categories of data as well.

It should be understood that aggregation of the descriptive data may be performed independently of when the application receives the user interaction corresponding to the descriptive data. The aggregation by user profile engine 400 may be performed immediately (e.g., in real time in response to a user input or activity) or periodically (e.g., at a predetermined interval, after a predetermined amount of descriptive data is received, etc.).

In an embodiment, after aggregating the descriptive data, descriptive user data model 405 may be transmitted to user profile engine 400 and stored in a database (e.g., database 114 and/or 134). In an embodiment, user profile engine 400 may interact with and store descriptive user data model 405 on the blockchain, as described elsewhere herein.

FIG. 4B illustrates a process 430 for identifying a source of descriptive data, according to an embodiment. While process 430 is illustrated with a specific sequence of steps, in alternative embodiments, process may be implemented with more, fewer, or a different arrangement and/or ordering of steps. Process 430 may be performed by the application, and may be implemented in either server application 112 and/or client application 132.

In step 432, a user input is received by the application via the graphical user interface. For example, the user may input user requests and execute any of the functions implemented by the application.

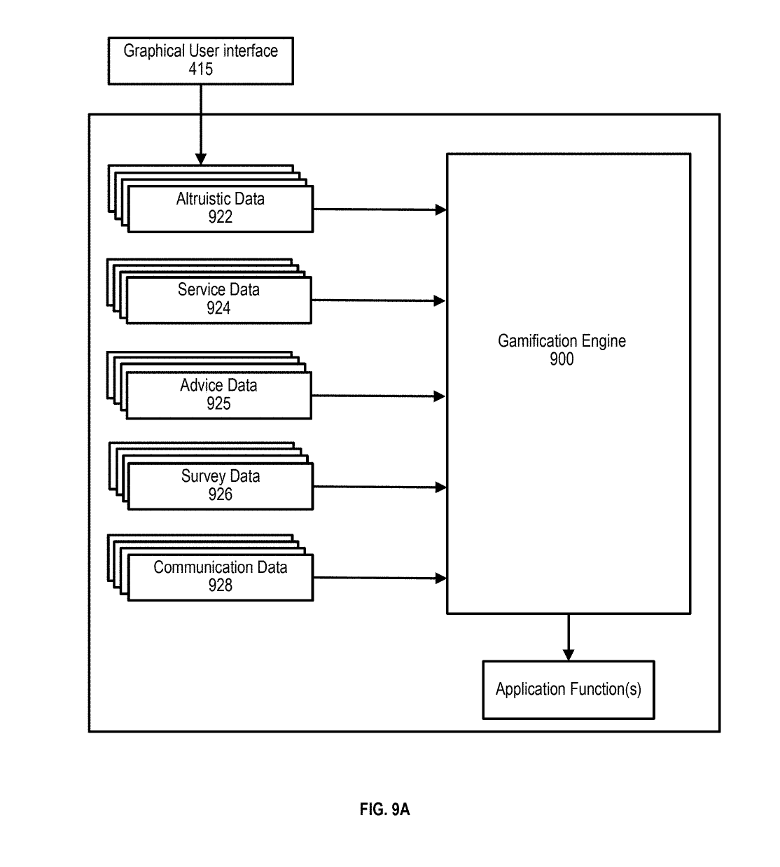

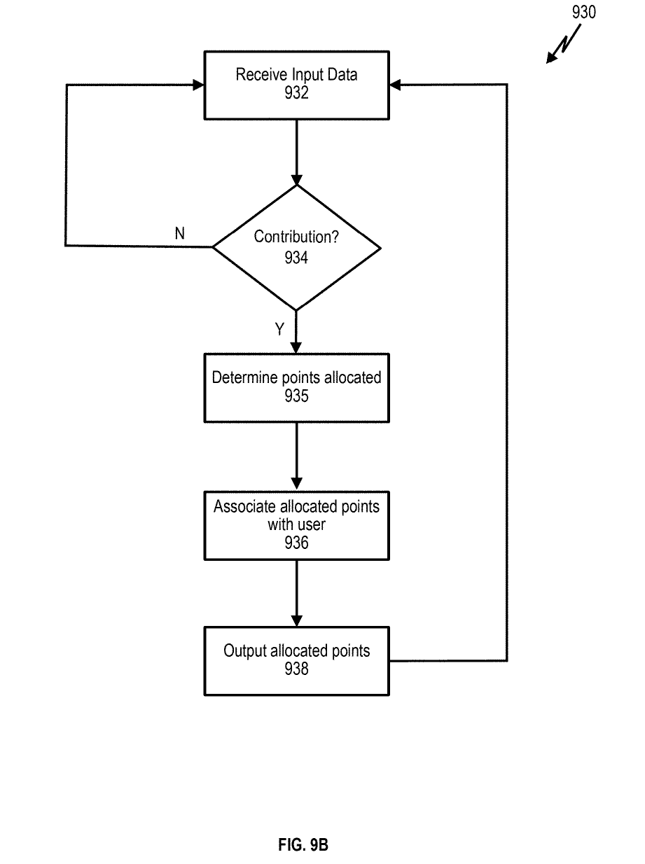

In step 436, the application determines whether or not the user input is from a registration process. For example, upon first access to the application, the application may present the user with a registration screen with one or more inputs for receiving personal information and creating authenticating credentials (e.g., username, passwords, biometrics, etc.). The personal information may include at least some of the information associated with personal data 422, including a user's name, address, email address, telephone number, and/or the like. In an embodiment, the registration screen may comprise additional fields for data in any one or more of categories 422-429. In an embodiment, data entered into the registration screen may be used as a starting point for training the artificial intelligence (e.g., the predictive model described herein) for a particular user's biases. If the application determines that the source of the user input, received in step 432, is a registration process (i.e., “YES” in step 434), process 430 proceeds to optional step 437A. In optional step 437A, the received user input and associated data may be injected into a gamification engine, as described below with respect to FIGS. 9A and 9B. After optional step 437A, the process proceeds to step 438.

If the application determines the source is not a registration process (i.e., “NO” in step 434), process 430 proceeds to step 436. In step 436, the application determines whether or not the user input is from a survey process. In an embodiment, the survey process may involve a survey screen, that the user accesses from time to time, comprising questions for teasing out descriptive data. For example, the graphical user interface may comprise a survey screen that presents the user with a plurality of questions and associated fields for inputting answers to the questions. Such questions may be directed to establishing additional information about the user associated with any one of categories 422-429, for example, directed to the user's preferences, health targets/goals, current health data, personal growth goals, and/or the like. The user may enter answers into the fields as user inputs. In an embodiment, the survey screen is displayed in response to completing the registration process, upon request of the user via a user operation, in response to executing a related function of the application, and/or periodically from time to time. For example, the user may opt-in to receiving survey notifications upon registration and/or via a settings screen.

In an embodiment, the survey process may involve displaying a prompt, generated by the application, (e.g., overlaid on an active screen or as a separate screen) for a user to enter descriptive data. In an embodiment, the prompt may be based on the currently active screen or function of the application. For example, if a user has searched for “things to do in San Diego,” the application may prompt the user with a plurality of questions for additional descriptive data (e.g., “Do you want to travel to San Diego?,” “Are you interested in outdoor activities?,” “Are you interested in restaurants with a view of the ocean?,” etc.). In an embodiment, the user may opt out of the prompts.

If the application determines that the source of the user input, received in step 432, is the survey process (i.e., “YES” in step 436), process 430 proceeds to step 437B. In step 437B, the received input and associated data is injected into the gamification engine, as described below with respect to FIGS. 9A and 9B. If the source of the user input is not from the survey process (i.e., “NO” in step 436), the application may determine that the user input is based on a user interaction with one or more functions of the application. For example, the user may input search terms via a search module, the application may identify that this input is not based on a registration process or a survey process, and proceed to optional step 437A. Alternatively or additionally, the application may identify the particular source of the user input and include this information with the corresponding descriptive data.

Steps 437A and 437B may be substantially the same. For example, in an embodiment, the gamification engine may receive descriptive data and allocate rewards as described in FIGS. 9A and 9B. In an embodiment, gamification may be based, at least in part, on the source from which the data is received (e.g., whether data is received from a survey process, a registration process, one or more other functions of the application, etc.). In an embodiment, only data received from survey processes (e.g., step 437B) are injected into the gamification engine. The gamification engine may output the data in association with the allocated rewards data to user profile module 400 (e.g., in step 438).

In step 438, descriptive user data model 405 is updated and stored, for example, based on the received user input (e.g., from step 432). As described above in more detail, user profile engine 400 aggregates received descriptive data into a table or data structure that may be utilized, accessed, and searched by one or more other functions of the application. In the case where data is received from the registration process (e.g., step 434), user profile engine 400 may generate an initial descriptive user data model 405, based at least in part, on the received data. Descriptive user data model 405 may be stored in a database (e.g., database 114 and/or 134). In the case where data is received from either a survey process or other function of the application (e.g., as determined in step 436), user profile engine 400 may utilize the data to update and adapt descriptive user data model 405 with new and/or additional information. Thus, descriptive user data model 405 is adaptive over time based on multiple and increased uses of the application by the user. In an embodiment, the artificial intelligence (e.g., the predictive model described herein) may utilize descriptive user data model 405 to bias one or more executed functions to the particular user. The artificial intelligence may be trained and evolve over time as descriptive user data model 405 evolves.

Process 430 may be repeated for each user input. Thus, descriptive data may be continually collected, for example, based on multiple inputs from each of a plurality of sources over time. In an embodiment, the application may reject or otherwise cease to collect redundant descriptive data (e.g., reception of the same or similar descriptive data as previously collected descriptive data). In another example, the application may determine whether some descriptive data is relevant to the user, while determining that other data is irrelevant, and only collect descriptive data that is determined to be relevant. In an embodiment, such determinations may be, at least partially, influenced by the artificial intelligence (e.g., the predictive model described herein). For example, the artificial intelligence may determine whether received descriptive data is relevant to the user or not, for example, via the feedback loop described above. Accordingly, descriptive user data model 405 may be continually and dynamically updated based on user interactions with the application over time.

3.2. Artificial Intelligence

As discussed throughout the present description, much of the functionality in the application may be driven by artificial intelligence (e.g., the predictive model described herein). For example, at least a portion of the links 304 to be included on a user's home screen(s) 302, the links 310 to be included in a user's category-snapshot screen 308, the links 326 to be include in a user's social-snapshot screen 324, search results to be presented in response to a user search, the number and/or arrangement of screens to be presented to a user in multi-screen view and/or search, the type of app modules, the number of app modules, and/or the arrangement of app modules to be presented to a user in a multi-modal view and/or search, the number, arrangement, and/or content to be included in content blocks 351 or 352 of a user's content feed 350, the recipients of a broadcast message sent by a user, the matching of requests to offers for electronic commerce, and/or any of the other decisions, selections, or determinations that are performed automatically by the application for the benefit of a particular user, may be performed by the artificial intelligence.

Advantageously, the use of artificial intelligence to personalize or “bias” the user's experience and provide the user with more relevant, specific, and immediate information (e.g., in real time) encourages interaction between the user and the application. This also enables companies to provide targeted, personalized, and/or real-time advertising to users and/or initiate real-time interactions with users, simultaneously across multiple online platforms (e.g., via multiple app modules). Thus, the application may enable a company to increase its brand positioning and transparency with users of the application, which may thereby increase the number of referrals to the company (e.g., provided by users of the application who have had positive interactions with the company via the application).

In an embodiment, when providing a function to a particular user, the artificial intelligence is specifically biased for that user. In other words, contrary to conventional artificial intelligence and search, which removes personal biases to provide general search results, the artificial intelligence described herein may incorporate a user's personal biases into its functions (e.g., searching functions) to produce user-biased functions.

In an embodiment, the artificial intelligence may be trained for a particular user, at least in part, by that user's responses to prompts. For example, after the artificial intelligence injects what it perceives to be user biases into a particular function (e.g., search, advertising, etc.), the application may prompt the user (e.g., via a pop-up overlay in the graphical user interface, via feedback inputs associated with each search result, advertisement, etc.) to indicate whether or not the functional result (e.g., search results, advertisement, etc.) of the user-biased function was useful (e.g., via one or more inputs within the pop-up overlay). If the user responds by indicating that the functional result was not useful, the application may adjust its artificial-intelligence algorithm for the user to eliminate a same or similar functional result in the future. On the other hand, if the user responds by indicating that the functional result was useful, the application may not adjust its artificial-intelligence algorithm for the user or may adjust its artificial-intelligence algorithm to reinforce a same or similar functional result in the future. The application may prompt the user for such feedback for as long as the user utilizes the application or for a set period of time. In addition, the application may only prompt the user for such feedback when it is likely to improve the artificial intelligence for the user. Thus, over time, the prompts may become less frequent, as the artificial intelligence becomes more and more synchronized with the user's biases, such that prompts become less and less likely to further improve the artificial intelligence.

The application may provide users with the ability to opt in or opt out of the learning and/or functional processes of the artificial intelligence. The ability to opt in and opt out may be provided for individual processes of the artificial intelligence. For example, the user may be able to opt in to everything except allowing the artificial intelligence to parse his or her communications. The application may incentivize users to opt-in to as many processes as possible by awarding them rewards (e.g., reward tokens or tiers) for each opt in. For example, a user may be given a set amount of reward tokens for each process of the artificial intelligence to which that user opts in. The corresponding reward tokens may be taken away if the user later opts out of a process.

FIG. 5 illustrates a process 500 for a user-biased artificial-intelligence-driven search (e.g., processing), according to an embodiment. For example, a user-biased artificial-intelligence driven processing of input to search for and produce relevant output. While process 500 is illustrated with a specific sequence of steps, in alternative embodiments, process 500 may be implemented with more, fewer, or a different arrangement and/or ordering of steps. Process 500 may be performed by the application, and may be implemented in either server application 112 and/or client application 132.

In step 505, the application receives search terms. The search terms may be received via a user input to search input 306 or via a speech-to-text process in embodiments which receive voice input. The search terms may comprise a string of text comprising one or more character strings (e.g., keywords).

In step 510, the application determines whether or not the search terms contain a set of words with a double meaning. The application may utilize a conventional natural language parser to identify the presence of homonyms (e.g., “pole,” “kid,” “saw,” “bark,” “bow,” etc.), figures of speech (e.g., “It's raining cats and dogs,” “break a leg,” etc.), double entendres (e.g., “Yeah, she'll come first,” “Get down,” “I'm having an old friend for dinner,” etc.), multiple meanings (e.g., “screwdriver”), irony/sarcasm (e.g., “as sunny as a winter day in Alaska,” “as pleasant as a root canal,” “clear as mud,” etc.), and/or the like. For example, the application could identify terms that have double meanings using a preregistered lookup table of such terms. If a term is identified as having a double meaning (i.e., “YES” in step 510), process 500 proceeds to step 515. Otherwise, if no term is identified as having a double meaning (i.e., “NO” in step 510), process 500 proceeds to step 520.

In step 515, the meaning of each term with a double meaning is selected based on the context in which it occurs and/or the history and/or biases of the user who input the search terms. For example, if the term “screwdriver” occurs in conjunction with other terms or prior search(es) indicating that the user's search is related to tools (e.g., the search terms also include the term “flathead” or “stainless steel,” the search follows a prior search for “wrench,” etc.), the term “screwdriver” should be interpreted as the hardware tool with that name. On the other hand, if the term “screwdriver” occurs in conjunction with other terms or prior search(es) indicating that the user's search is related to drinks (e.g., the search terms also include the term “drink” or “recipe,” the search follows a prior search for “bars” or “food”, etc.), the term “screwdriver” should be interpreted as the cocktail with that name. As another example, if the user's prior activities include a proclivity for drinking (e.g., prior purchases of cocktail mixers, calendared events at bars, etc.) and not much history related to tools, the term “screwdriver” should likewise be interpreted as the cocktail, rather than the tool.

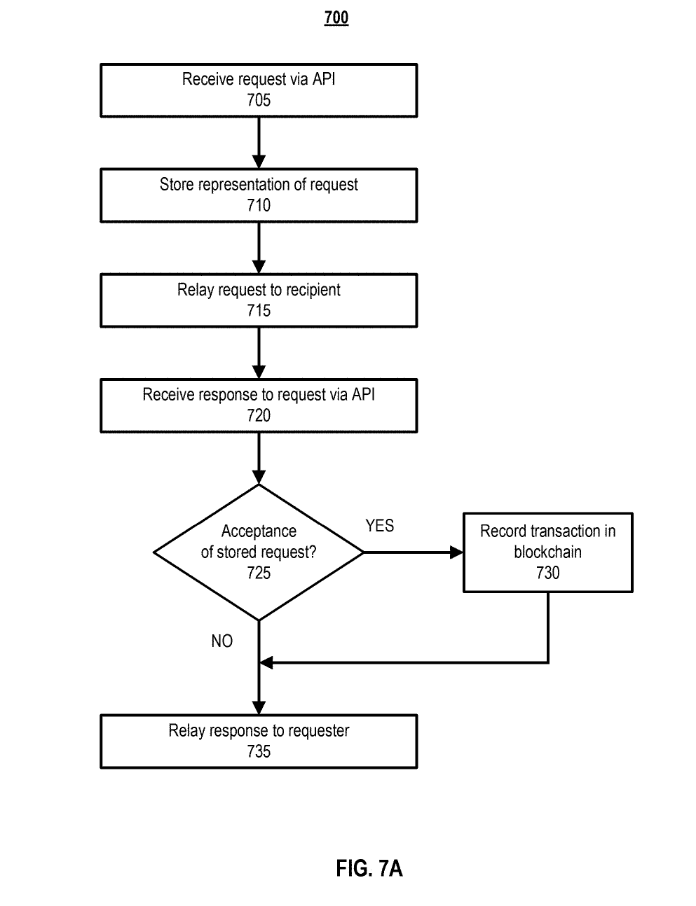

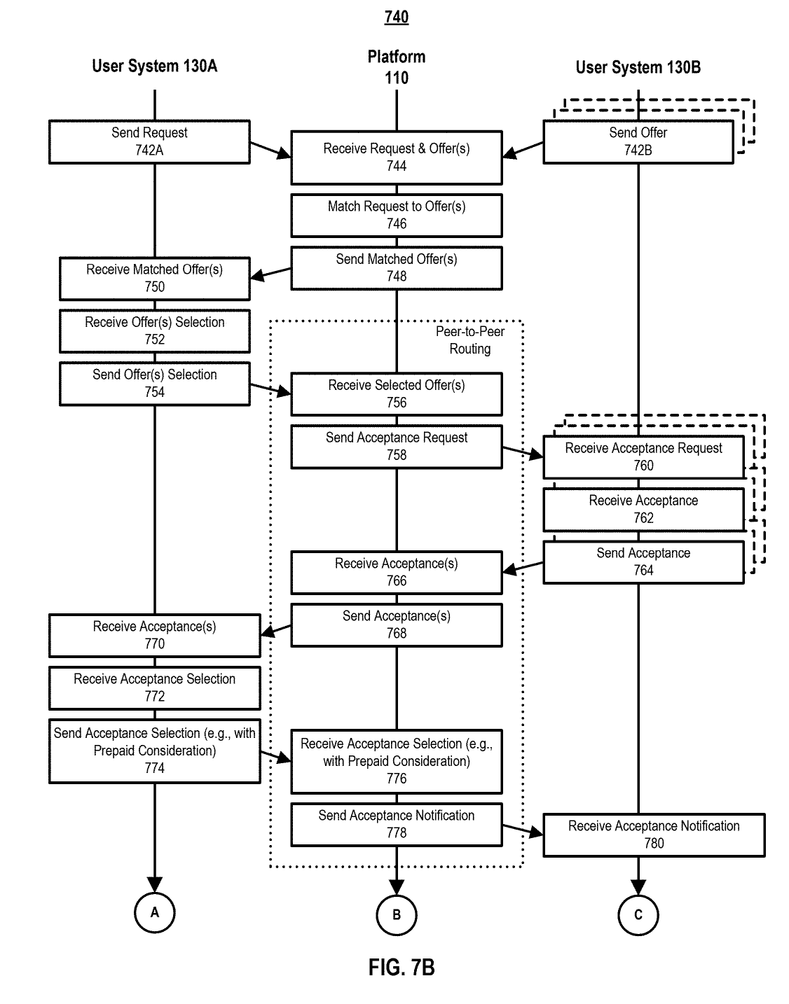

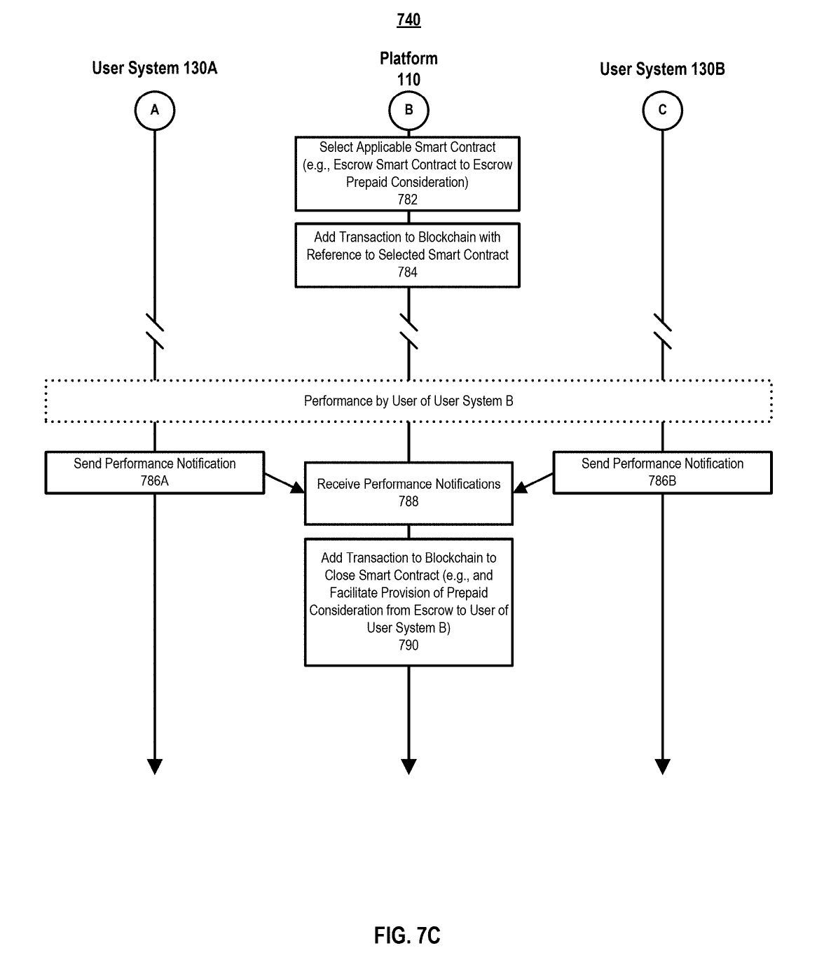

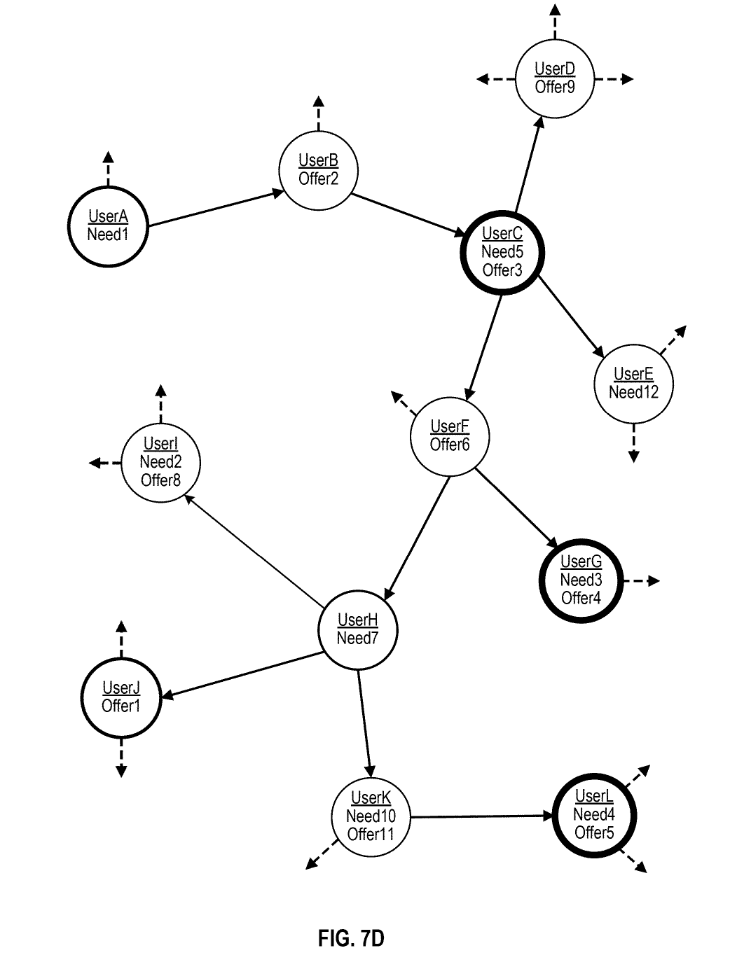

In step 520, the application “triangulates” or otherwise determines the search context for the particular user. In an embodiment, the search context comprises any of the user's biases that are relevant to the search terms. These biases may include the user's preferences, interests, activities, history, and/or any other user-specific information acquired from his or her use of the application (e.g., as defined in the user's descriptive user data model 405). Using the example above, if the search terms include the term “screwdriver,” and this term was determined in step 515 to refer to the cocktail, the search context may include the user's current or future location (e.g., relevant to where the user may obtain a screwdriver cocktail), the user's favorite restaurants or bars at which a screwdriver cocktail may be purchased and within a vicinity of the user's location, people within the user's social network within a vicinity of the user's location (e.g., relevant to possible drinking companions), taxi or ride-sharing services that service the user's vicinity (e.g., including a peer-to-peer ride-sharing service from another user that may be booked via process 740 described with respect to FIGS. 7B-7C), hangover cures (e.g., pharmacies or locations at which Advil™ can be purchased, food recipes, gym locations, etc.), screwdriver cocktail recipes, and/or the like. In some embodiments, the search context may also be based, in part, on user information acquired from other user's use of the application, for example, server application 112.

In step 525, the artificial intelligence of the application performs a simultaneous or contemporaneous search across all sources available to the application, using the user-biased search context determined in step 520. The application may train a predictive model for each user, using a user-biased training set, such that the search results for a particular user will be different than the search results for a different user. To generate the predictive model, the application may utilize feature selection to automatically identify and select features (i.e., data) that are most relevant to the user-biased search results. The application may then perform a gradient descent to solve a linear regression on the selected features, to generate an algorithm representing the predictive model for the particular user. This predictive model represents the artificial intelligence used for identifying user-biased search results for the user. The predictive model may be continually trained, as the user's biases change (e.g., as the user continues to interact with the application), so that it evolves with the user. The output of step 525 is a set of user-biased search results, produced by the artificial intelligence (e.g., predictive model for the particular user), from all available sources.

In step 530, the artificial intelligence of the application determines a best fit of the user-biased search results for the particular user. In an embodiment, the artificial intelligence may utilize a Bayesian network, based on a social graph or network, to group users based on likes, dislikes, tastes, and/or the like, in order to determine preferred content for the particular user's search results. The output of step 530 is a set of best-fit, user-biased search results for the user.

In step 535, the artificial intelligence of the application may filter the best-fit, user-biased search results. While any type of filtering may be used, in an embodiment, the search results are filtered based on sentiment. Specifically, search results that reflect a negative sentiment may be eliminated, such that only search results with a neutral and/or positive sentiment are ever presented to the user. Thus, all negative content can be filtered out, and never shown to the user, such that the user only reviews positive content in his or her search results and/or content feeds.

For instance, the artificial intelligence may utilize a logistic regression to score each search result, on an overall sentiment scale, from a negative extreme (e.g., having a score of −1.0 for most negative) to neutral (e.g., having a score of 0.0) to a positive extreme (e.g., having a score of 1.0 for most positive). In this case, any search result with a negative sentiment score (e.g., having a score of less than 0.0) may be filtered out, whereas any search result with a positive sentiment score (e.g., having a score greater than 0.0 or some other positive threshold), and optionally a neural sentiment score (e.g., having a score of 0.0 or within a range of 0.0 to some other positive threshold), may survive the filter. As an example, an external system 140 (e.g., Google Cloud Natural Language™), may be used for determining the sentiment scores of search results. In this case, the artificial intelligence may utilize an API of the external system 140 to pass the content of a search result to the external system 140, and receive the sentiment score for the search result from the external system 140. In any case, the output of step 535 and the artificial intelligence is a set of filtered, best-fit, user-biased search results.

In step 540, the application provides the filtered, best-fit, user-biased search results to the user, using the graphical user interface described herein. For example, these search results may be presented to the user in a multi-screen view 328 and/or multi-modal view 336, with the top-most search result provided in the initial active module screen, and other search results provided in inactive module screens that logically extend outward from the initial active module screen, with higher-ranked search results logically and navigably closer to the initial active module screen than lower-ranked search results.

3.3. Broadcast

In an embodiment, the application enables users to broadcast a message (e.g., request for a service or good) to an application-wide audience of users. A user may broadcast the message in real time in a direct and targeted manner, based on criteria specified by the user. Furthermore, recipients of the broadcast message may respond in real time. For example, a user may broadcast a message requesting a service or good, the application (e.g., artificial intelligence, for example, the predictive model described herein) may match that request to other users, who are able to offer that service or good, or previously received offers of that service of good from other users, and facilitate a transaction between matched users. This transaction may be performed by the application in real time.

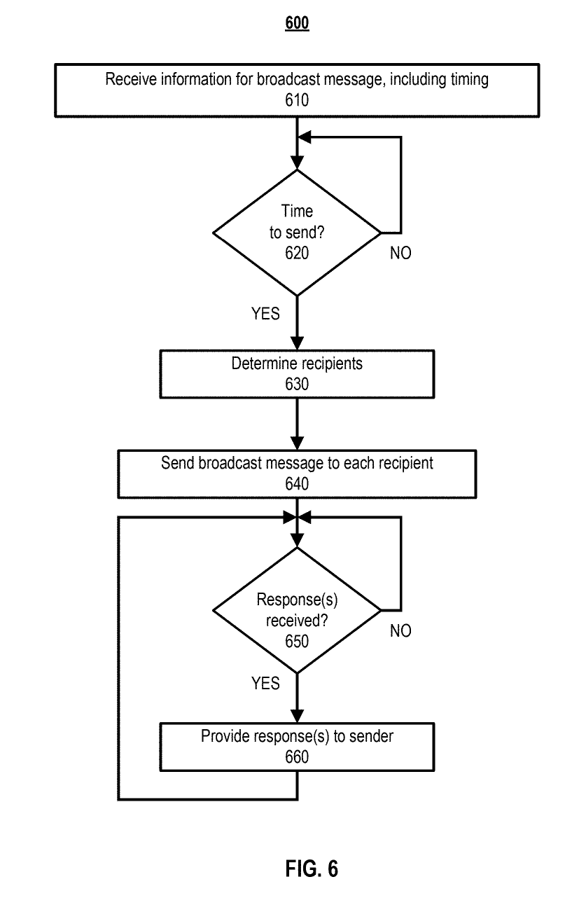

FIG. 6 illustrates a process 600 for broadcasting via the application, according to an embodiment. While process 600 is illustrated with a specific sequence of steps, in alternative embodiments, process 600 may be implemented with more, fewer, or a different arrangement and/or ordering of steps. Process 600 may be performed by the application, and may be implemented in either server application 112 and/or client application 132.

In step 610, information for the broadcast message is received. This information may be collected using the broadcast wizard described, in an embodiment, with respect to FIG. 3L. The received information may comprise criteria for determining a target of the broadcast message, the content of the broadcast message, a timing of the broadcast message, and/or a deadline time at which responses to the broadcast message must be received (e.g., specified number of minutes, hours, days, or other time period, from submission of the broadcast message, after which no more responses will be received or considered, specified date and/or time, specified date and/or time range during which all responses must be received, etc.). When specified, the timing of the broadcast message may indicate that the broadcast message should be sent after a specified delay (e.g., a number of hours, days, weeks, etc.), at a specified date and/or time, during a specified date and/or time range, according to a specified frequency or interval (e.g., daily, weekly, monthly, etc.), while a recipient is performing a specified activity (e.g., shopping via an app module, viewing or searching for certain content, etc.), when a recipient is located within a vicinity of a specified location (e.g., a store of the sending user), and/or the like. The received information may also indicate a type of sending user (e.g., on behalf of a person or company), a context of the broadcast message (e.g., personal or business), a subject of the broadcast message, a target location if different from the user's location (e.g., users in New York, even if the sending user is in Los Angeles), and/or the like.

In step 620, the application (e.g., server application 112) determines whether to send the broadcast message, based on the timing received in step 610. If the timing has not yet been reached (i.e., “NO” in step 620), the application continues to wait to send the broadcast message. In the event that the timing, received in step 610, indicates that the broadcast message should be sent immediately, step 620 can be omitted entirely, such that the application proceeds directly from step 610 to step 630.

In step 630, the application (e.g., server application 112) determines users that satisfy the criteria for the target. These users will become the recipients of the broadcast message. The application may utilize the criteria specified by the sending user and/or the artificial intelligence, described elsewhere herein (e.g., the predictive model described herein), to identify users that satisfy the criteria for the target. For example, the sending user may target specific groups of users (e.g., friends, teams of users, users within the user's social network, service providers, experts, companies, members of a particular community, all users, etc.). Additionally or alternatively, the artificial intelligence may select the most appropriate users to be recipients of the broadcast message, based on the biases (e.g., preferences, interests, and/or activities) of the sending user and/or potential recipient-users. As another alternative or addition, the artificial intelligence may restrict or limit who may be a recipient of the broadcast, based on the sending user's contributions (e.g., restricting the recipients to users with the same and/or lower ratings than the sending user). Thus, for example, the artificial intelligence may not necessarily select all users, who satisfy the criteria for the target to be recipients, but may instead select a subset of such users whose biases indicate that they will likely respond to the broadcast message in an appropriate and relevant manner and/or which are similar to the sending user's biases. In addition, the artificial intelligence may account for the type of sending user, the context of the broadcast message, and/or the subject of the broadcast message (e.g., specified in step 610) when selecting users to be recipients of the broadcast message. For example, the artificial intelligence may utilize different matching criteria for determining recipients in the business context than in the personal context. The artificial intelligence may also utilize other criteria that are not necessarily specified by the user, such as the user's location (e.g., select recipient-users within a certain radius or other vicinity of the sending user).

Notably, the order of steps 620 and 630 may be changed, such that the recipients are determined right after the information for the broadcast message is received (e.g., before or immediately after the broadcast message is submitted by the user). In the event that the broadcast message is to be sent immediately after being submitted, this reordering will likely make no difference. However, in the event that the broadcast message is to be sent a significant time after the broadcast message has been submitted (e.g., after a delay of several days), the recipients satisfying the criteria for determining the target may change significantly (e.g., as new users register with or leave the application, as users' profiles, preferences, activities, and other biases change, etc.) The difference may be especially striking in embodiments which utilize the artificial intelligence (e.g., the predictive model described herein) for determining the recipients in step 630, since the artificial intelligence may continue to learn and evolve based on the sending user's and/or potential recipient-users' activities. Thus, it may be advantageous to wait until the time, at which the broadcast message is sent, to determine the recipients of the broadcast message.

In step 640, the application (e.g., server application 112) sends the broadcast message to each recipient-user determined in step 630. In the event that the timing, received in step 610, indicates that the broadcast message should be sent immediately, the application may send the broadcast message essentially in real time.

In step 650, the application (e.g., server application 112) determines whether any responses have been received. If a response has been received (i.e., “YES” in step 650), the application, in step 660, provides the response to the user who submitted the broadcast message. Otherwise (i.e., “NO” in step 650), the application continues to wait for responses.

In step 660, responses may be provided to the sending user individually (e.g., via a notification, such as alert 344 illustrated in FIG. 3N) or collectively (e.g., via broadcast-results screen 342 illustrated in FIG. 3M). As discussed elsewhere herein, a response may result in an agreement (e.g., contract formation, purchase, etc.) between the sending user and the responding recipient-user, additional communications between the sending user and the responding recipient-user, and/or the like.

In an embodiment and instance in which the broadcast message has an associated deadline time, responses received after the deadline time may be ignored. Alternatively, the graphical user interface may prevent recipients from responding to any broadcast message after the deadline time.

In an embodiment, step 660 need not be performed, for example, in the instance in which the broadcast message is a broadcast notification that does not require a response thereto. Similarly, step 650 may be optional in certain implementations.

Advantageously, process 600 enables a sending user to connect to and communicate with previously unknown, yet appropriately targeted, recipient-users (e.g., via artificial intelligence, for example, the predictive model described herein) in step 630), and provides immediate, real-time results back to the sending user (e.g., via notifications). These targeted, potentially real-time broadcasts in conjunction with the real-time responses may provide instant, global, yet personal, connections between users of the application, and facilitate immediate interactions between people and businesses.

3.4. Blockchain Integration

In an embodiment, peer-to-peer transactions completed via the application may be recorded on a blockchain. In addition, all peer-to-peer interactions may be recorded on the blockchain. Furthermore, in an embodiment, all interactions with the application, whether peer-to-peer, peer-to-application (e.g., the user using any function of the application described herein), or application-to-peer (e.g., the application issuing a reward to a user), may be recorded on the blockchain by the application.

3.4.1 Transaction Recordation

FIG. 7A illustrates a process 700 for recording transactions in a blockchain, according to an embodiment. While process 700 is illustrated with a specific sequence of steps, in alternative embodiments, process 700 may be implemented with more, fewer, or a different arrangement and/or ordering of steps. Process 700 may be performed by the application, and may be implemented in either server application 112 and/or client application 132.

In step 705, a request, from a sender to one or more recipients, is received. For example, the request may comprise a message (e.g., a broadcast message) comprising an offer. In an embodiment, the request is received through an API. Specifically, the sender of the message (e.g., the application or a software module within the application communicating with an API to another software module within the application) may call a subroutine of the API, implemented for sending a request to one or more recipients. Alternatively, the request may be received in another manner, other than through an API.

In step 710, a representation of the request is stored for future retrieval. For example, the representation of the request may be stored in a relational database (e.g., database 114), indexed by a unique request identifier, so that it may be retrieved when a response (e.g., comprising a matching request identifier) to the request is received.

In step 715, the request, received via the API in step 705, is relayed to the one or more recipients specified via the API. The relayed request may be altered (e.g., by adding the unique request identifier for tracking responses to the request) from the original request received in step 705, or may be identical to the original request received in step 705.

In step 720, a response to the request is received. For example, in the event that the request comprised a message with an offer, the response may comprise a message with an acceptance or declination of that offer. In an embodiment, the response may be received through the same API by which the request was received (e.g., via a subroutine of the API that has been implemented for sending a response to a request). Alternatively, the response may be received in another manner, other than through an API. The response may comprise the request identifier, such that the response may be matched to the representation of the request, by using the request identifier to retrieve the representation of the request from the relational database in which it was stored in step 710.

In step 725, process 700 determines whether or not the response, received in step 720, represents an acceptance of the request received in step 705. For example, the response may be parsed to determine whether it represents an acceptance, non-acceptance, or declination of the request. If the response represents an acceptance of the request (i.e., “YES” in step 725), process 700 proceeds to step 730. Otherwise, if the response does not represent an acceptance of the request (i.e., “NO” in step 725), process 700 proceeds to step 735.

In step 730, since the combination of the request and response represents an agreement (e.g., an offer and acceptance of the offer), the agreement is recorded as a transaction in a blockchain. The recorded transaction may reference a smart contract, i.e., a computer protocol that executes logic, for example to facilitates, verifies, or enforces performance of the agreement. In an embodiment, the transaction may include one or more of the agreement, the content of the agreement, the content of the request, and/or the content of the response.

The blockchain comprises a chain of blocks which grows over time as new blocks are added. Each new block comprises one or more transaction records and a cryptographic hash of the preceding block. The cryptographic hash, added to each new block, makes it computationally difficult to modify the blockchain. Thus, the blockchain may be maintained as an open, distributed ledger, that is used to record transactions in a verifiable and virtually immutable manner.

In step 735, the response, received in step 720, is relayed to the sender of the request received in step 705. The relayed response may be altered from the original response received in step 720, or may be identical to the original response received in step 720.

In the event that the request, received in step 705, has been relayed to a plurality of recipients, steps 720-735 may be repeated for each response to the request that is received. In addition, it should be understood that, during a negotiation of an agreement, the response, received in step 720, may comprise a counteroffer. In this case, process 700 may iterate a number of times, until the response, received in step 720 of an iteration, comprises an acceptance. Alternatively, the counteroffering response may be treated in the same manner as the request received in step 705, such that process 700 determines (e.g., in step 725) whether or not the original sender of the request has accepted the counteroffer via a message received from the original sender of the request (e.g., in step 720).

In an embodiment, the broadcast messages and responses to broadcast messages, described with respect to process 600, may be relayed between the sending user and the recipient-users using process 700. In this manner, broadcast process 600 may be used to automatically form agreements and record those agreements as transactions on the blockchain. In appropriate cases, these agreements may be recorded on the blockchain to utilize smart contracts.

In a similar manner to agreements formed via broadcast process 600, any and all agreements or other transactions, formed via the application, may be recorded on the blockchain. For example, other transactions may include the distribution or payment of rewards (e.g., as part of the gamification process described elsewhere herein), donations or other contributions to charities, social causes, and/or the like, acceptance of an opportunity provided by another user or the artificial intelligence (e.g., the predictive model described herein) (e.g., acceptance of a job offer), and/or the like. In some embodiments, the agreements and other transactions can be stored in the blockchain in association with other data indicative of the nature of the transactions, for example, the content and/or data included as part of the or used to form the transaction.

FIGS. 7B and 7C illustrate an e-commerce process 740 (also referred to herein as “the exchange”) using a blockchain, according to an embodiment. While process 740 is illustrated with a specific sequence of steps, in alternative embodiments, process 740 may be implemented with more, fewer, or a different arrangement and/or ordering of steps. It should be understood that the steps performed by user system 130A and/or user system 130B may be performed by a client application 132, executing on each respective user system 130. In addition, the steps performed by platform 110 may be performed by server application 112.

In step 742A, a user system 130A sends a request to platform 110 (e.g., via the application). The request may be a request for a service (e.g., professional service, such as legal service, financial service, accounting service, medical service, design service, expert advice, fitness services, educational services, etc.), good (e.g., new or used products, such as electronics, clothing, groceries, books, vehicles, etc.), or any other tangible or intangible thing that may be exchanged. The request may be made by any user, including either a person or company, but, for ease of understanding, will be primarily described herein as a request by a person for a service or good.

In step 742B, one or more user systems 130B send an offer to platform 110 (e.g., again, via the application). Each offer may be an offer to perform a service, sell a good, or provide any other tangible or intangible thing that may be exchanged. Essentially, an offer may be made for anything that can be requested, and a request can be made for anything that can be offered. An offer may be made by any user, including either a person or company, but, for ease of understanding, will be primarily described herein as an offer by a business for a service or good.

Steps 742A and/or 742B may be initiated via one or more screens of the graphical user interface of the application to send a communication, within the application, from user system 130 to platform 110. Alternatively or additionally, a request may be sent in steps 742A and/or 742B using any other means of communication, including, without limitation, SMS, MMS, email, and/or the like.

In step 744, platform 110 receives the request from user system 130A and the offer(s) from user system(s) 130B. The request and offer(s) may be received at different times and in any order. In an embodiment, platform 110 acts as a clearinghouse that collects requests and offers submitted from any number and variety of user systems 130 (e.g., via the application), operated by any types of users (e.g., personal, business, etc.), at any time and over any time period. Thus, while only a single request and one or more offers are discussed in the context of the present example, it should be understood that, in practice, platform 110 may receive millions of requests and offers, and that process 740 may be repeated for each request.

In step 746, platform 110 matches requests to offers. For purposes of simplifying the description, only a single request and a plurality of offers, related to that request, will be discussed. However, it should be understood that, in practice, platform 110 may match each of any number of requests to one or more offers, and each of any number of offers to one or more requests.

The request, received in step 742A, may be matched to the plurality of offers, received in step 742B, using any means of matching, including a matching algorithm and/or the artificial intelligence described elsewhere herein (e.g., the predictive model described herein). For example, a request for a particular service or good may be matched to each offer for that particular service or good. The number of offers may be limited to a certain number (e.g., the top ten matching offers, or another number set by the user and/or application) in order to avoid overwhelming the requester.

The artificial intelligence may be employed to narrow down the number of offers (e.g., to a predetermined number of best-fit offers) and/or eliminate any offer that the requester is unlikely to accept. The artificial intelligence may select and/or eliminate offers from consideration according to the requesting and/or offering users' biases (e.g., preferences, interests, activities, etc.). For example, certain offers may be selected, eliminated, and/or ranked higher or lower based on location (e.g., selected or ranked higher if the offeror is within a geographical vicinity of the requester, and/or eliminated or ranked lower if the offeror is outside a geographical vicinity of the requester). As another example, certain offers may be selected, eliminated, and/or ranked higher or lower based on matching biases (e.g., preferences, interests, and/or activities). For instance, a certain offer may be selected or ranked higher if the offeror contributes to social causes (e.g., reduced carbon footprint, animal rescue, community involvement, etc.) in which the requester is interested (e.g., as determined by the offeror's and requester's activities through the application), and/or eliminated or ranked lower if the offeror does not contribute to social causes in which the requester is interested, or contributes to causes that are antithetical to those in which the requester is interested. In this manner, consumer-users can ensure that their purchases are supporting issues or causes that are important to them, and business-users can increase and strengthen their global brand positioning using conscious giving, sponsorships, and promotions. In a sense, a company's culture, actions, and effects on society and the environment are indelibly recorded in the blockchain—and, in an embodiment, openly exposed to the public—so that the character of the company can become an important factor in consumer choice.

In step 748, the list of one or more matching offers, determined in step 746, are sent to user system 130A for review by the requester. The list is subsequently received by user system 130A in step 750.

In step 752, the user may review and select one or more of the offers in the list of offers, received in step 750, via the graphical user interface of the application. For example, the graphical user interface may comprise an offer-selection screen which includes a selectable representation of each offer in the list (e.g., with a summary of the offer and/or offeror, and a link to further details regarding the offer and/or offeror). The requesting user may select one or more of the offers within the offer-selection screen, and then submit the selection via an input of the graphical user interface. In an alternative embodiment, the requesting user may only be allowed to select a single offer in the list at a time.

In step 754, the selected set of one or more offers is sent by user system 130A to platform 110. The selected set of offer(s) is subsequently received by platform 110 in step 756.

In step 758, platform 110 sends an acceptance request to the user system 130B of each offeror whose offer is included in the requester's selected set of offer(s), received in step 756. In an embodiment in which the user is only allowed to select a single offer, platform 110 would send only a single acceptance request in step 758. Each acceptance request essentially requests the offeror to accept the requester's request (e.g., for a service or good).

In step 760, the user system 130B of an offeror receives the acceptance request, and, in step 762, the user system 130B of the offeror receives the offeror's requested acceptance of the requester's request. For example, the graphical user interface of the application may comprise an acceptance screen which includes an input for indicating the offeror's acceptance of the request. More specifically, reception of the acceptance request in step 760 may trigger an alert 344 in the offeror's graphical user interface. The offeror may view the notification associated with alert 344 (e.g., in region 348) by selecting alert 344. Alternatively or additionally, the offeror may access an acceptance-request screen of the graphical user interface (e.g., via a link 304, voice input, etc.), which lists all requests or unaccepted requests with a description of the requester and/or request. This list of requests may be sortable and/or filterable by request type, whether the request is active or inactive (e.g., whether or not a deadline for accepting the request has passed, the request has already been matched with an offer, etc.) and/or accepted or unaccepted, ratings of the requests, relevance of the requests, number of interactions by other users with the requests, and/or the like. The description of the requestor and/or request, which may be the same as the description displayed in response to selection of alert 344, may comprise the requester's thumbnail image or avatar, name, profession, and/or location (e.g., city and state of current residence), the request type (e.g., recommendation, advice, etc.), a request description, an input (e.g., link or virtual button) for accepting the request, an input for declining the request, and/or an input for viewing more details about the request. To accept the request, the offeror may simply select the input for accepting the request and/or utilize a voice input to accept the request. In response to the offeror's selection of this input, in step 764, user system 130B sends the acceptance to platform 110.

In an embodiment in which the requester is allowed to select multiple offers at a time, steps 760-764 may be performed by the user system 130B of each offeror whose offer was selected by the requester. It should be understood that, in the event that the offeror declines the acceptance request, the declination may be relayed from user system 130B by platform 110 to user system 130A, and, in the event that no acceptance request is accepted, process 740 may either end or return to step 752 (e.g., so that the user may select a new offer).

In step 766, platform 110 receives an acceptance from each of one or more user systems 130B, and, in step 768, sends a notification of the acceptance to the requester's user system 130A. In an embodiment in which the requester is allowed to select multiple offers at a time, platform 110 may receive multiple acceptances. In this case, platform 110 may relay each acceptance as it comes in, in which case steps 766-768 are repeated each time that an acceptance is sent from a user system 130B to platform 110. Otherwise, platform 110 may collect all of the acceptances first, and then send all of the acceptances to the requester's user system 130A at one time. For example, platform 110 may attach a deadline time to each acceptance request sent in step 758, and, once the deadline time has passed, send all of the acceptances, that were received prior to the deadline, to the requester's user system 130A at one time (e.g., in one message).

In step 770, the requester's user system 130A receives one or more acceptances from platform 110, and, in step 772, user system 130A receives the requester's selection of one offeror's acceptance. For example, the graphical user interface may comprise an acceptance-selection screen which includes a selectable representation of each acceptance by an offeror (e.g., with a summary of the acceptance and/or offeror, and a link to further details regarding the acceptance and/or offeror). The requesting user may select one of the acceptances within the acceptance-selection screen, and then submit the selection via an input of the graphical user interface.

In step 774, the selected acceptance is sent by user system 130A to platform 110. In an embodiment, the requester may also submit his or her consideration for the agreement represented by the mutual acceptance of the offer, with or contemporaneously with the acceptance selection sent in step 774. For example, in many cases, the consideration will be money. Thus, a prepayment may be submitted with the acceptance selection in step 774. The prepayment can be submitted using any well-known online payment methods (e.g., credit card, debit card, direct debit from a bank account, Paypal™, Venmo™, electronic wallet, etc.). In an embodiment, prepayments may be made using a cryptocurrency associated with the blockchain described herein. In addition, this cryptocurrency may be integrated with the rewards system described herein (e.g., the reward tokens, discussed herein, may be the cryptocurrency, exchangeable with the cryptocurrency, etc.). In this case, a user can utilize his or her reward tokens to engage in the transactions described herein. In an alternative embodiment or other instances of the same embodiment (e.g., in cases in which the consideration is a tangible object that cannot be transferred online), the prepayment may be performed offline (e.g., by the requesting user mailing or otherwise conveying the consideration to a location designated by the operator of platform 110 or the offeror).

In step 776, the acceptance selection (e.g., with the prepayment, if applicable), sent by user system 130A in step 774, is received by platform 110. Platform 110 identifies the offering user associated with the selected acceptance, and then sends an acceptance notification to the user system 130B of the offering user. The acceptance notification indicates that the acceptance sent by the offering user's user system 130B in step 764 was accepted by the requesting user. The acceptance notification may also indicate that the requesting user's consideration (e.g., payment) has been received. In instances in which the consideration is received separately from the acceptance selection in step 776, platform 110 may send a separate notification when the consideration is received, or may wait until the consideration is received before sending the acceptance notification in step 778. In any case, in step 780, the user system 130B of the offering user, whose offer the requesting user has selected, receives the acceptance notification from platform 110.

In step 782, platform 110 selects an applicable smart contract to be used for the transaction. For example, if the consideration has been prepaid, platform 110 may select a smart contract that provides an escrow for the consideration, regardless of whether the consideration was received electronically (e.g., in step 776) or offline (e.g., by physical shipping). In an embodiment, platform 110 may provide a plurality of available smart contracts to be utilized to carry out various transactions, features and/or functions of the platform described herein. For example, transactions representing offers, requests, acceptances, and/or the like may each be associated with a separate smart contract for executing and/or recording the transaction. Each smart contract may be associated with a unique address by which transactions may utilize the smart contract. The logic of the smart contracts may be centrally located or distributed across one or more servers (e.g., servers associated with the platform 110). In addition, the deployed smart contracts may communicate with each other directly. For example, a deployed smart contract for a particular type of agreement may communicate with another smart contract for escrowing a prepayment, terminating the agreement, and/or the like, according to the specified terms of the agreement.

In step 784, platform 110 adds a transaction, representing the agreement between the requesting and offering users, to the blockchain. The selected smart contract in step 782 may include a reference to another smart contract that can be utilized by the selected contract to complete the execution of the transaction. For example, the transaction may provide a set of one or more parameters (e.g., representing terms of the agreement, an address of the electronic wallet of the requesting user and/or offering user, etc.) to an address (e.g., the reference) of the smart contract and/or other smart contracts selected as part of the transaction. As is understood in the art, a smart contract is a computer protocol that, for example digitally facilitates, verifies, or enforces a negotiation or performance of a contract, in a trackable and irreversible manner. A smart contract may be partially or fully self-executing and/or self-enforcing. Further, one or more smart contracts can be used to carry out other features and/or functions of the platform.

In an embodiment, platform 110 may facilitate a more complicated negotiation than the offer and acceptance illustrated in process 740. For example, the peer-to-peer routing performed in FIG. 7B may involve one or more rounds of counteroffers by the requester and/or offeror prior to full acceptance and opening of the smart contract. Instead of simply selecting one or more offers in step 752, the requester may select one or more offers to which to send a counteroffer. The counteroffer(s) may be relayed by platform 110 via steps 756 and 758, and the offeror may accept the counteroffer in step 762, or may propose a counter-counteroffer which is then similarly relayed by platform 110 to the requester. This peer-to-peer routing may continue for any number of rounds of counteroffers until an acceptance is received from either the requesting user or offering user. Platform 110 may record the negotiations (i.e., the offer and the counteroffer(s)), as well as the final agreement, in the blockchain.

At some time, the offeror who made the accepted offer will perform according to the terms of the recorded agreement. Otherwise, if the offeror fails to perform, the escrowed consideration may be returned to the requester in the same manner in which it was received (e.g., by refund to the requester's credit card if prepaid by credit card, by mail if received by mail, etc.).

Once the offeror has performed, in steps 786A and 786B, the requester and offeror, respectively, may both send a performance notification to platform 110, via their respective user systems 130A and 130B. Alternatively, only the requester or only the offeror may need to send the performance notification to platform 110 in steps 786A and/or 786B. In either case, the performance notification(s) are received by platform 110 in step 788. Furthermore, in an embodiment, the requester may rate the performance (e.g., on a scale of one to five or one to ten, using a like or dislike input, using one to five stars, etc.) of the offeror via the performance notification sent in step 786A or in a separate communication.

In step 790, in response to receiving the performance notification(s) in step 788, platform 110 may execute a transaction, representing the performance, to the blockchain. Again, the transaction may use a smart contract (e.g., use the address of the smart contract selected in step 782, or use the address of another smart contract specifically for closing the agreement) to close the smart contract opened by step 784. In addition, platform 110 may facilitate provision of the escrowed consideration (e.g., provided as prepayment in step 774) to the offeror. This may comprise transferring the payment (e.g., cryptocurrency, reward tokens, etc.) from an electronic wallet under the control of the smart contract to an electronic wallet of the offeror. Alternatively, the transfer may be from a bank account under control of the application to a bank account of the offeror, may be a physical shipment of the consideration (e.g., if the consideration is a tangible object, other than cash) to the offeror, and/or any other means of transferring tangible or intangible consideration from one party to another.

If the smart contract is self-enforcing or performance can otherwise be determined via online activity, steps 786-790 may be omitted, since the smart contract may perform any necessary transfers and record those transfers as transactions on the blockchain. For example, if the smart contract involves the purchase of a good, the requester's payment for the good may be escrowed, by transferring the payment (e.g., a cryptocurrency of the blockchain, which may be the reward tokens described elsewhere herein) from an electronic wallet of the requester to an electronic wallet over which the smart contract has authority. The application may automatically generate a shipping label with tracking information that the offeror can print and use to ship the good to the requester. For example, the application may interface with an API of an external system 140 of a commercial shipper (e.g., UPS™, FedEx™, etc.) to request a new shipment and receive tracking information for the new shipment. The application may then generate the shipping label with the tracking information and address of the requester, and provide access to the shipping label (e.g., as a Portable Document Format (PDF) document) to the offeror via the graphical user interface. The offeror can then package the good, print the label, affix the label to the packaged good, and convey the labeled, packaged good to the commercial shipper for transport. Once the commercial shipper has delivered the good, the commercial shipper may push a notification to the application, or the application may pull the delivery status from the commercial shipper (e.g., via an API of the commercial shipper's external system 140). The application may then provide this information to the smart contract, and the smart contract may use the information to self-execute to transfer the escrowed payment from the electronic wallet over which it has authority to an electronic wallet of the offeror, and record this transfer on the blockchain.

In an embodiment, the application may utilize the artificial intelligence (e.g., the predictive model described herein), instead of explicit requests and offers, to determine the requests and offers. In this case, steps 742-744 are not necessary and may be omitted from process 740. For instance, the artificial intelligence may parse through a user's biases (e.g., preferences, interests, and/or activities), including the user's communications, to identify needs that the user is likely to have and/or things which the user may likely have to offer. For example, if a user sends a message to another user indicating that her shoe broke, the artificial intelligence may infer from this message that this user has a need for new shoes. In this sense, the artificial intelligence may know users' needs even before they do. The application may perform the matching in step 746 of process 740, based on the inferred needs and offers, in a similar or identical manner to the case in which the application has explicit requests and offers. The application could also match inferred needs to explicit offers and explicitly requested needs to inferred offers.

Whether the needs and offers are explicitly requested or inferred, the application may traverse a user's social network to match a need of the user to an offer by someone within his or her social network, and/or match an offer of the user to a need by someone within his or her social network. In general, a matching algorithm of the application traverses the social network from a given user with a need or offer to identify another user with a matching offer or need. The matching algorithm may start from a given user, travel to all or a subset of relevant users who are directly connected (e.g., friend or other contact) to the given user within a social network, to determine whether there is a match between the need or offer of the given user and an offer or need in the subset of directly-connected relevant users. If no match is found, the matching algorithm may then, in turn, explore all or a subset of relevant users who are directly connected to the previously explored users, and so on and so forth, until a match has been found, or no more connections remain to be explored.

In an embodiment, the matching algorithm may match any users' needs and offers that it finds during a traversal, whether or not they relate to the original user's need or offer. Thus, the matching algorithm may be used more generally to perform matching throughout the entire social network managed by the application, instead of simply focusing on one specific user's need or offer at a time. The matching algorithm may operate for as long as there are unmet needs or offers, in an attempt to “close the loop” on each unmet need or offer.

In an embodiment, the matching algorithm may be configured to identify non-exact matches. For this purpose, the matching algorithm may utilize the artificial intelligence described herein (e.g., the predictive model described herein) to identify a non-exact match that the user is likely to consider to be sufficient or better than nothing. For example, if a user has a need for a 1903 silver dollar, and the matching algorithm is not able to find a user who has a 1903 silver dollar to offer, the matching algorithm may instead match the user's need to a 1905 silver dollar (e.g., if the user's biases indicate that he or she is likely to be interested).

In an embodiment, the matching algorithm may comprise or utilize the artificial intelligence to predict needs and/or offers. For example, if a first user has a need for a 1903 silver dollar, and a second user does not currently have a 1903 silver dollar, but the second user's calendar indicates that he or she will be attending a coin convention next week, the artificial intelligence may predict that the second user may be able to obtain the needed 1903 silver dollar for the first user. In this case, the application could send a notification to the first user and/or the second user to facilitate the acquisition by the second user of the 1903 silver dollar, at next week's coin convention, on behalf of the first user.

In an embodiment, the matching algorithm may be configured to optimize matches based on one or more criteria. For example, the matching algorithm may prioritize matches by proximity, cheapest value, congruence, and/or the like. It should be understood that the matching algorithm may rank matches according to multiple prioritizations or weightings. For example, the matching algorithm may score each match based on weightings assigned to two or more attributes of a match (e.g., degree of separation between users, amount of money involved, equivalence between the need and offer, etc.), and select the match with the highest score as the one to be presented to the users.

In prioritization by proximity, matches between users with smaller degrees of separation within the social network are more likely to be chosen by the matching algorithm than matches between users with larger degrees of separation. For example, a match between two users that are connected by three direct connections through two intermediate users will be prioritized over a match between users that are connected by four or more direct connections through three or more intermediate users. The quality of the connections may also be evaluated and prioritized. For example, a family member of a friend of the user may be prioritized over a coworker of a friend of the user, since a family member is generally a closer connection than a coworker. Advantageously, prioritization by proximity may maximize the familiarity and trust between the parties to the transaction. For instance, a user is more likely to know or trust someone who is a friend of a friend than someone who is an acquaintance of a coworker of a friend.

In prioritization by cheapest value, matches that involve less money being exchanged are more likely to be chosen by the matching algorithm than matches involving more money. For example, if a need for a 1903 silver dollar can be matched to two offers of a 1903 silver dollar of $40 and $60, the match with the offer of $40 will be prioritized over the match with the offer of $60.

In prioritization by congruence, matches between needs and offers that are more equivalent are prioritized over matches between needs and offers that are less equivalent. For example, if a need for a 1903 silver dollar can be matched to non-exact offers of a 1905 silver dollar and a 1910 silver dollar, the match with the offer of the 1905 silver dollar will be prioritized over the match with the offer of the 1910 silver dollar.

In an embodiment, the matching algorithm may comprise or utilize artificial intelligence (e.g., the predictive model described herein) which selects matches according to each particular user's biases. Specifically, the artificial intelligence may learn how the particular user prefers matches to be prioritized (e.g., more emphasis on proximity than cheapest value, more emphasis on congruence than proximity, etc.). For example, after a match is notified to a user, the application may prompt the user to indicate whether the match was to his or her liking. Alternatively, the application may notify two or more matches to a user and prompt the user to identify which match is more to his or her liking. Based on the user's feedback, the application may adjust the matching algorithm for the particular user to make it more likely that matches the user liked are returned over matches that the user did not like.

Alternatively or additionally, the user could specify how matches should be prioritized (e.g., when submitting a request, and/or via a settings screen). For example, a user could specify that he or she prefers that the matching algorithm only search a particular subset of the user's direct connections, such as only friends, family, teams, communities, and/or the like. The user could also specify a maximum degree of separation (e.g., one degree of separation if the user only wants the matching algorithm to search direct connections). The user could also specify other criteria for determining the subset of users that should be searched, such as only those users with similar biases (e.g., similar interests, similar preferred sources of content, etc.), only those with significant contributions (e.g., to social causes), and/or the like.

FIG. 7D illustrates an example of how the application may traverse a user's social network, according to an embodiment. The description with respect to FIG. 7D may be understood as one implementation of step 746. The example traversal will be described with respect to a UserA who has a Need1. In some embodiments, the user needs as described herein (e.g., Need1, Need2, Need3, etc.) may be any one or more user requests, needs, desires, goals that are provided by each user and/or inferred as described herein, for example, as provided in user objective data 429 associated with each user (e.g., UserA, UserB, etc.). First, the matching algorithm travels from UserA to UserB, who has a direct connection to UserA within UserA's social network. For example, UserB may be a friend or other contact of UserA. Since UserB fails to have an offer matching UserA's needs, the matching algorithm then traverses UserB's immediate social network. Thus, the matching algorithm may travel from UserB to UserC, and so on and so forth.

As illustrated, by traversing each user's social network, the matching algorithm eventually identifies UserJ who has an Offer1 that matches the Need1 of UserA. In some embodiments, the user needs as described herein (e.g., Offer1, Offer2, Offer3, etc.) may be any one or more user offers that are provided by each user and/or inferred as described herein, for example, as provided in user offer data 423 associated with each user (e.g., UserJ, UserB, etc.). Accordingly, the application may send notifications to one or both parties and facilitate a peer-to-peer exchange between UserA and UserJ, in a similar manner to the peer-to-peer routing described with respect to process 740.

During the traversal, the matching algorithm may also identify UserC with Need5 and Offer3, UserG with Need3 and Offer4, and UserL with Need4 and Offer5. Based on these needs and offers, the matching algorithm determines that a three-party transaction will satisfy each of these users' particular need. Accordingly, the application may send notifications to one or all three of these parties and facilitate a peer-to-peer-to-peer exchange that involves transactions between UserC and UserL (Need5 to Offer5), UserC and UserG (Offer3 to Need3), and UserG and UserL (Offer4 to Need4). It should be understood that even more complex (e.g., N-party) transactions may be identified and facilitated in a similar manner.

The needs and offers discussed above may be any type of need or offer, including both commercial needs and offers (e.g., service or good) and personal needs and offers (e.g., social needs and offers), and may be defined at any level of granularity. For example, a need may be a romantic date or meet up with another user who has similar preferred sources of content as the user, a recommendation from a specific demographic of users, advice on a relationship from other users with similar biases as the user, and/or the like.

In an embodiment, requests, offers, and/or participations in a transaction may all result in rewards being distributed to the parties involved. In other words, the more a user participates in “closing a circle” (i.e., matching a need to an offer), the more reward tokens they receive. A different token value may be assigned to each request, offer, and transaction based on the goals of the application. For example, if a goal of the application is to promote social awareness, more reward tokens may be assigned to a completed offer of life coaching than the simple payment of money. In general, contributions to another user's well-being or life would be assigned higher reward tokens than simple pecuniary contributions.

Notably, in the case of a transaction, an offeror may receive tokens from both the requester (e.g., in exchange for satisfying the requester's need) and from the application (e.g., as a reward for satisfying the requester's need). In addition, the requester may receive reward tokens for participating in the transaction or, in general, for the interaction with the application. Thus, a single transaction may result in multiple transfers of tokens, both as consideration in the transaction and as a reward for one or more users' contributions related to the transaction.

Furthermore, it should be understood that a donation is simply an offer without any accompanying need (e.g., UserB in FIG. 7D is associated with an Offer2, but no need). Thus, a donation can be used to “close a circle” by satisfying another user's need without adding any further need for the matching algorithm to consider. Accordingly, the application should award users' donations with reward tokens.

3.4.2 Enhanced Router

In an embodiment, all peer-to-peer interactions (e.g., communications between any two users) are recorded on the blockchain, regardless of whether or not those interactions are related to or result in the use of a smart contract, completed transaction, or other exchange. This may be facilitated by the distribution of enhanced routers, which execute software (e.g., firmware) for adding peer-to-peer interaction records to the blockchain (e.g., via communication with platform 110).

The enhanced routers may be distributed to businesses (e.g., business users of the application) to be used as access points to network(s) 120. For example, a business may install the enhanced router in its place of business to provide user systems 130 with shared Wi-Fi™ access to the Internet via the business' Wi-Fi™ network. User systems 130 may connect to the access point, provided by the enhanced router, via conventional means. For example, the access point may broadcast its Service Set Identifier (SSID). A user system 130 may use a radio system (e.g., radio 265) to scan the environment and discover the SSID being broadcast by the access point. User system 130 may then establish a connection with the access point via standard means. Once a connection has been established, the access point may relay communications between client application 132 and server application 112. However, unlike conventional access points, the access point taps the communications, being relayed, to identify peer-to-peer interactions and send them to platform 110 for recordation in the blockchain.

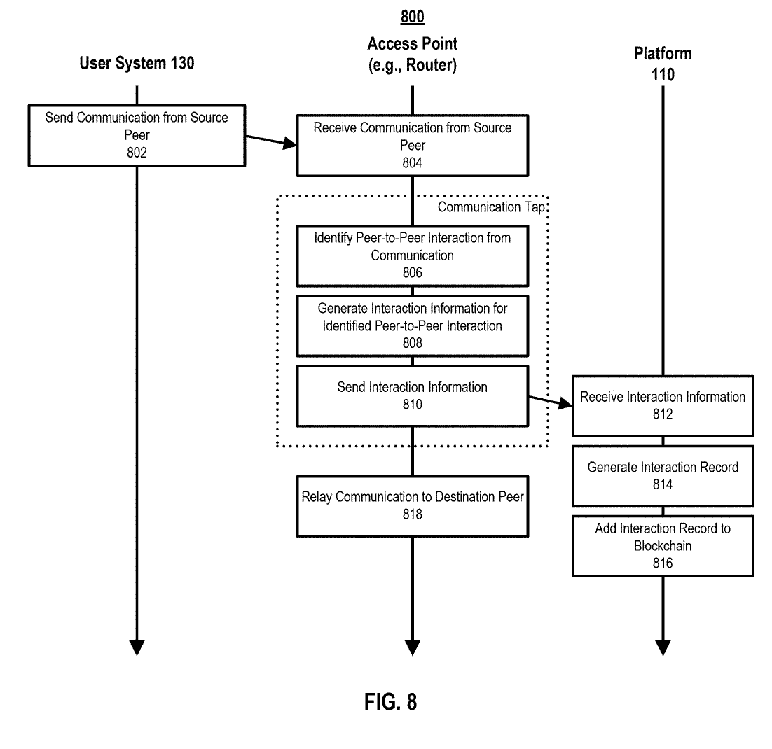

FIG. 8 illustrates a process 800 for recording interactions on the blockchain, according to an embodiment. While process 800 is illustrated with a specific sequence of steps, in alternative embodiments, process 800 may be implemented with more, fewer, or a different arrangement and/or ordering of steps. It should be understood that the steps performed by user system 130 may be performed by client application 132. In addition, the steps performed by platform 110 may be performed by server application 112. Furthermore, the steps performed by the router as the access point may be performed by software (e.g., firmware) added to a standard router and executed by a processor (e.g., processor 210) on the router, or, alternatively, by hardware added to a standard router.

In step 802, a user system 130 sends a communication on behalf of a user, as a source peer, to another user as a destination peer, via the access point. The communication may be generated by the source peer via the graphical user interface of the application. The communication may be any type of communication, containing any type of peer-to-peer interaction between the source peer and the destination peer. For example, the peer-to-peer interaction could be a broadcast, a response to a broadcast, a request, an offer, an acceptance, a notification, content to be shared by the source peer with the destination peer, a payment or other transfer, and/or the like.

In step 804, the access point receives the communication from user system 130. A conventional access point, provided by a conventional router, would simply relay the communication to its destination. However, in the enhanced router, one or more types of communications may be “tapped” to identify a peer-to-peer interaction represented by the communication.

Specifically, in step 806, the access point identifies a peer-to-peer interaction from the communication. For example, the communication may be parsed to identify the peer-to-peer interaction.

In step 808, the access point generates interaction information representing the identified peer-to-peer interaction. The access point then sends the interaction information to platform 110 in step 810. The interaction information may be sent to platform 110 via an API to the blockchain functionality provided by platform 110.

In step 812, platform 110 receives the interaction information from the access point, and generates an interaction record in step 814. In step 816, platform 110 then adds the interaction record to a block of the blockchain.

In step 818, which may occur at any point after step 804 depending on the particular implementation, the access point relays the communication, received in step 804, to its intended destination. Specifically, the access point will relay the communication, via network(s) 120 (e.g., the Internet), to a user system 130 of the destination peer specified by the communication.

In order to encourage businesses to install the enhanced routers and share bandwidth on their Wi-Fi™ networks for providing peer-to-peer communications within the application, businesses may be provided with an incentive. For example, in order to establish connections with the access points provided by the enhanced routers, consumers may be required to install client application 132 on their user systems 130. Client application 132 may monitor each consumer's usage of an enhanced router and charge per use or as a unit of data usage. Alternatively or additionally, the consumer may pay a fixed subscription fee (e.g., monthly or annually) for access to the entire infrastructure of enhanced routers, or as part of a subscription fee for usage of the application as a whole. In any case, each business may be provided a share of these payments or fees, for example, based on the number of enhanced routers the business is operating, the amount of the business' bandwidth being used by the consumers, and/or the like.

3.5. Gamification

In an embodiment, at least some aspects of the application may be gamified, in order to encourage users to interact and otherwise engage with and via the application. For example, the application may reward users based on achievements, such as the completion of certain activities (consuming grow-themed content) via the application, contributions (e.g., referrals) made by the user through the application, amount of time spent in the application, positive interactions with other users, and/or the like. A user may view, access, and/or otherwise interact with his or her rewards and/or gamified activities in the application via links 304 on one or more home screens (e.g., grow-themed home screen 302D).

In an embodiment, the application may reward users using tokens and tiers (e.g., token thresholds). As discussed elsewhere herein, these tokens may be or may be exchangeable with the cryptocurrency of the blockchain acting as the ledger of the application. When a user has earned a first number of tokens (e.g., more than a first threshold), the user may be advanced to a first tier, when the user has earned a second number of tokens (e.g., more than a second threshold), the user may be advanced to a second tier, and so on and so forth. Each tier may be associated with one or more features within the application that were not available at lower tier(s). Thus, users may unlock features within the application by earning reward tokens to advance to a new tier. These features may include, without limitation, access to new search features, access to new app modules, access to new people (e.g., increased reach within the user's social network), access to more resources, access to the broadcast feature (e.g., described with respect to process 600), access to more opportunities, access to more themes (e.g., additional themed home screens 302), a higher level of personalization (e.g., by the artificial intelligence, for example, the predictive model described herein), access to data and information from user objective data 429 (e.g., items and/or service associated with higher token values), access to data and information from user offer data 423 (e.g., items and/or service for connecting to other users to facilitate exchanges), and/or the like.

In an embodiment, a user may utilize earned reward tokens to obtain an item in exchange for one or more tokens. For example, the application may offer concert tickets which a user may obtain in exchange for a number of tokens. The offered item may be any type of good, product, service, article, etc. In an embodiment, the offered item may be similar to features unlocked by advancing to new tiers as described above. In an embodiment, the token value may be set by the application or determined based on a supply and demand model. The supply and demand model may, for example, be influenced by the artificial intelligence (e.g., the predictive model described herein) based on an analysis of users. For example, the application may determine that demand for the concert tickets is high based, at least in part, on an increase in searches for the particular band and/or concert. In an embodiment, the artificial intelligence may access a user's descriptive user data model 405 and suggest items based on user preferences and currently owned tokens. In an embodiment, exchanging tokens for items may reduce the number of tokens associated with a user without affecting the reward tier achieved by and associated with the user.

In an embodiment, the application may also reward users with ratings and/or recognitions. For example, a user may be awarded a ratings and/or recognition based, at least in part, on contributions made by the user within the application. A company-user may also be rated by the number of users who interact with it or with whom the company interacts, the communities of which the company is a member or to which the company has contributed, the company's global footprint, the amount of content (e.g., content with a positive sentiment) generated by the company, and/or the like. In addition, users may provide ratings of any interaction with any other user (e.g., positive, negative, and/or neutral), and the application may utilize those user-specified ratings to compute the ratings for each rated user.

In an embodiment, ratings may be awarded and tracked based on one or more of a growth (e.g., increasing growth of the user's personal network, achieving personal growth goals, etc.) and contributions, as described elsewhere herein. In an embodiment, ratings may be associated with a user based on feedback received from other users in response to the user's interactions with the other users (e.g., exchanges, contributions, other transactions involving services or goods, etc.). Contributions that other users may rate include, without limitation, financial contributions, goods, services, or other resources (e.g., food, water, equipment, time, etc.), volunteering, education, and/or the like. In an embodiment, ratings may be displayed on screen, associated with the user, as a ratio (e.g., average) based on the number of received ratings (e.g., on a scale of one to five or one to ten, as one to five stars, etc.)

In an embodiment, recognition may be awarded and tracked based on tokens received and/or tiers achieved (e.g., via contributions made). For example, as the user acquires tokens and/or reaches a new tier, the user may be granted greater exposure to other users of the application (e.g., other people, celebrities, companies, communities or other groups, etc.), access to more resources, access to more functions of the application, and/or the like. The graphical user interface may enable users to search their rewards, as well as other users' rewards (e.g., by rating, recognition, tokens, tiers, access, etc.).

As further examples, rewards may comprise financial grants, financial loans, resources, cash, paid health care, paid retirement, paid tuition, paid bills, lottery prizes, increased business access, increased access to people, increased access to communities, increased access to content, profit-sharing pools, promotion of the user's business, promotion of the user's cause, mentorship, live show interviews, interviews with a person whom the user admires, being a guest speaker on a talk, “dream for a day” prizes, VIP access to events and/or premieres, services, discounts, travel, merchandise, and/or the like.

In an embodiment, each earned reward may be recorded as a transaction on the blockchain, as described elsewhere herein. For example, the grant of a number of reward tokens for a particular contribution by the user may be recorded as a transfer of tokens (e.g., from the system to the user), or an exchange between the system (e.g., providing the points to the user) and the user (e.g., providing the contribution to the system). In this manner, all rewards are indelibly fixed in the blockchain. In this embodiment, the tokens may actually be units of a cryptocurrencys. As with any cryptocurrency, users may utilize the cryptocurrency as a medium of exchange (e.g., within and outside the application), and those exchanges may be recorded as transactions in the blockchain.

In an embodiment, users may form teams and earn at least some rewards as teams. For example, the application may offer a reward (e.g., a certain number of tokens) for the completion of a particular activity or goal (e.g., an inexpensive water purification system that can be used in developing countries), and groups of users may form teams. The first team to achieve the goal (e.g., as determined based on a set of predefined criteria), may earn the reward. In an embodiment, teams may be formed to achieve a common goal (e.g., satisfying user requests and/or offers). Tokens, earned by a team, may be allocated to each member of the team (e.g., in proportion to their contributions), and members of a team pool their tokens to achieve a common goal. Teams may be selected by the users and/or the application (e.g., based on criteria, such as the relationship between the users, the degree of separation between users, shared biases, shared goals, etc.).

FIG. 9A illustrates an example of the operation of a gamification engine 900, according to an embodiment. Gamification engine 900 may be a software module of the application. Gamification engine 900 gamifies the application to encourage and otherwise incentivize users to engage with the application and/or other users. Gamification engine 900 may be configured to allocate rewards to users based, at least in part, on user interactions with the application (e.g., contribution classifications 922-928). As used herein, a “reward” may refer to tokens and/or tiers awarded to users (e.g., for contributions or other interactions within the application).

Gamification engine 900 may comprise or be interfaced with one or more sources of contribution classifications 920-928, each comprising data indicative of a user's contributions within the application. Graphical user interface 415 (e.g., the graphical user interface described throughout the present disclosure) may inject an input, received from a user, into gamification engine 900 for the allocation of rewards, as described in more detail with respect to FIG. 9B. For example, a user's interaction with graphical user interface 415 may generate data to be transferred into one or more of contributions classifications 922-928 based, at least in part, on a type of contribution made by the user. For example, a user may input data into a survey screen, as described above, and data indicating the completion of that survey may be injected into gamification engine 900. In another example, a user may provide services (e.g., as included in use objective data 429) in response to, for example, a broadcast message, and data indicating the services rendered may be injected into gamification engine 900. In an embodiment, the data indicating an interaction may represent that the user completed and/or performed the contribution. Alternatively or additionally, the data may also include data associated with the entire exchange (e.g., data indicating a contribution was made and the content of the contribution). Additional example types of contributions are provided in more detail below.

While certain sources of data are described herein, it should be understood that these sources are merely illustrative, and that gamification engine 900 may comprise or be interfaced with fewer, more, or different sources than those discussed herein. For example, gamification engine 900 may be interfaced with one or more app modules, an API of the operating system of user system 130, and/or any source of data input by the user into user system 130.

In an embodiment, gamification engine 900 may retrieve the contribution data automatically (e.g., without user input), semi-automatically (e.g., after user confirmation, for example, in response to a prompt of the graphical user interface or upon establishing a communication connection with a network), or manually (e.g., in response to a specific user input or request).

The various types of contributions will now be described in more detail. However, the contribution types described herein are merely examples and not intended to be limiting. FIG. 9A illustrates a plurality of types of interactions including, without limitation, providing assistance corresponding to altruistic data 922, providing a service corresponding to service data 924, providing advice corresponding to advice data 925, responding to surveys corresponding to survey data 926, and/or quality of communications with other users corresponding to communication data 928. Example data points of each classification 922-928 are illustratively provided in Table 2 below. These data points are intended for illustrative purposes only, and are not exhaustive of the type of interactions that are allocated rewards by gamification engine 900.

TABLE 2
Interactions Data

Altruistic Data
Financial/Services/Time Donation(s)
Scholastic/Tutor
Adopt Animal
Altruistic Behavior
Provide Empath
Fulfilling User Requests
Service Data
Installation of Software
Action Items
Birth Mother
Cooking
Advice Data
Suggestions
Dress
Exercise
Food/Nutrition
Cooking
Relationships
Career
Survey Data
Adding Data About User Accounts (e.g., banks)
Personal Surveys
Business Surveys
Communication Data
Being Friendly
Politeness
Graciousness
Grateful

In an embodiment, altruistic data 922 comprises data and information related to various altruistic and/or charitable behavior. Altruistic data 922 may include, without limitation, data indicative of donations made by the user (e.g., financial, scholastic such as scholarships, etc.), donations of time (e.g., charitable services, tutoring, etc.), adoption (e.g., animals and/or children), and/or the like. In an embodiment, altruistic data 922 may also include fulfilling user requests as set forth in user objective data 429. For example, altruistic data 922 may include data that indicates that the user has offered an item or services via user offers in user offer data 423.

In an embodiment, contribution data may include opportunity data, which may be based, at least in part, on user objective data 429. For example, user objective data 429 of a first user may include a user request. The application (e.g., driven by the artificial intelligence, for example, the predictive model described herein) may identify the user request, pull the request, and push such request data to one or more other users as opportunity data. The application may determine which users to push the opportunity data too based on, for example, matching of user offer data 423 and/or artificial intelligence as described elsewhere herein (e.g., the predictive model described herein). The opportunity data may be part of an exchange, described elsewhere herein. The opportunity data may include an indicator of relevance to the receiving user's user offer data 423 (e.g., user offers), for example, based on a ratio (e.g., between zero and one hundred). Thus, receiving users may be presented suggestions (e.g., opportunity data) based on other users' requests. In an embodiment, tokens may be allocated, as described herein, to each opportunity. Thus, when a receiving user responds to fulfill the opportunity, the user may be rewarded the associated tokens.

In an embodiment, service data 924 comprises data and information related to providing services or performing actions upon the request of others. Service data 924 may include, without limitation, data indicative of downloading and/or installing software on behalf and/or at the request of the application, performing action items provided by and/or performing services (e.g., cooking) for others, being a birth mother, and/or the like.

In an embodiment, advice data 925 comprises data and information related to providing advice to others (e.g., users of the application and/or other people). Advice data 925 may include, without limitation, data indicative of providing suggestions and advice as to fashion, exercises programs, nutrition and dieting programs, relationships, careers, and/or the like. For example, as described above, user objective data 429 of a first user may include a request for advice on a particular subject (e.g., how to prepare corned beef), and a second user may provide advice in response to this request (e.g., in response thereto or in user offer data 423). Alternatively or additionally, in an embodiment, the artificial intelligence (e.g., the predictive model described herein) may drive the contribution, for example, by pulling the request from user objective data 429 of the requester and pushing the advice from user offer data 423 of the contributor. In either case, data indicative of the exchange may be stored in advice data 925. It should be understood that this example is not limited to advice data 925, but may apply in a similar manner to any contribution data described or implied herein.

In an embodiment, survey data 926 comprises data and information related to completing surveys (e.g., entering data into a survey screen). Survey data 926 may include, without limitation, data indicating that the user completed one or more surveys via a survey process, data indicating a user entered data regarding user accounts (e.g., financial accounts, social-networking accounts, etc.), and any information otherwise requested during a survey process.

In an embodiment, communication data 928 comprises data and information related characteristics and quality of communications of the user. Communication data 928 may include, without limitation, data indicating that a user's communications with others on the network are friendly, polite, gracious, grateful, and/or positive in nature. In an embodiment, the positive nature of a user's communications may be determined, at least in part, based on a context of the communication for a particular user, a positive sentiment score, and/or the like (e.g., as described above in connection to FIG. 5). In an embodiment, the artificial intelligence (e.g., the predictive model described herein) may influence such determinations. While the artificial intelligence is described in connection to communication data 928, it will be appreciated that the artificial intelligence may be implemented to influence each contribution type described herein (e.g., artificial intelligence may be used to connect users for performing donations, services, etc.).

Gamification engine 900 is configured to receive one or more data points via user inputs, as described above, and responsively allocate rewards. In an embodiment, the allocation of rewards may utilize artificial intelligence as described elsewhere herein (e.g., the predictive model described herein). For example, the artificial intelligence may process the interaction data to determine a quality and/or nature of an interaction, and gamification engine 900 may utilize this determination in classifying the contribution for allocating rewards. It should be understood that the allocation of rewards may be performed independently of when the interaction data point is received and/or may be performed in response to receiving a user input. As a non-limiting example, a user may interact with the application on-line or off-line and the tokens may be allocated at any time.

In an embodiment, each contribution data may be associated with a reward. For instance, each contribution may be associated with a token value. In an embodiment, the association is stored in a table and/or data structure, as described below. For example, in an offer and exchange scenario, the user request may include an associated token value that can be rewarded to a user whose offer fulfills the request. In another embodiment, each contribution type may be associated with a predetermined token value. For example, survey data 926 may be associated with low token values (e.g., one token, five tokens, etc.), whereas altruistic data 922 may be associated with higher token values (e.g., fifty tokens, one-hundred tokens, etc.). Thus, points may be allocated according to which contribution the user performs. While certain example token values are provided herein, these are merely illustrative, and other token values may be used. Furthermore, each data point within a given contribution category may have different associated token values (e.g., donations may be associated with a higher token value than an exchange).

In an embodiment, rewards associated with contribution data may be based, at least in part, on a value of the contribution. For example, the rewarded token amount may be proportional to the value in terms of monetary and/or temporal value. If a user contributes services to another user, the number of tokens awarded may be proportional to the time the user spent on the contribution. Similarly, the more expensive an item and/or donation is, the more tokens that may be allocated to the contribution. Furthermore, in an embodiment, rewards may be proportional to the frequency and/or number of times a user contributes to others within the application. Thus, as users contribute, more frequently and more time and/or monetary value, then the user may acquire increasingly more tokens for use within the application.

Upon allocating rewards to contributions, the allocations may be associated with a corresponding user and stored in a database (e.g., database 114). In an embodiment, the allocated rewards and associated contribution data may be recorded as a transaction on the blockchain (e.g., comprising a transfer of tokens). In an embodiment, the allocated rewards may be stored as a table or other data structure which associates the allocated rewards with the given user. For example, as gamification engine 900 receives data from one or more other functions of the application, it may extract data indicative of the contribution, process the data to determine a quality of the interaction (e.g., positive sentiment, altruistic, etc.), allocate the reward as tokens based on the contribution type and/or quality, and store the allocation in the database as a new data structure or update an existing data structure associated with the given user. In embodiments where users form teams, each team member's contribution may be processed to allocated reward tokens, which are associated proportionally with each team member who contributed to the team's common goal. The data structure may be transmitted as allocated rewards data and utilized by one or more functions of the application. For example, the data structure may group allocated tokens into rewards tiers, and one or more functions of the application may prevent or restrict access, based on whether a user has achieved a necessary rewards tier.

In an embodiment, gamification engine 900 may inject the allocated rewards into user profile engine 400. In one example, the data structure of allocated rewards for a particular user may be injected into user profile engine 400 to update a descriptive user data model 405. In another example, data indicative of the rewards associated with a user may be injected as descriptive data, as described above, and aggregated into the descriptive user data model 405 associated with the user.

FIG. 9B illustrate a process 930 for allocating reward tokens to a user, according to an embodiment. While process 930 is illustrated with a specific sequence of steps, in alternative embodiments, process may be implemented with more, fewer, or a different arrangement and/or ordering of steps. Process 930 may be performed by the application (e.g., gamification engine 900), and may be implemented in either server application 112 and/or client application 132.

In step 932, the application receives a user input from the graphical user interface. For example, the user may input user requests and execute any of the functions implemented by the application.

In step 934, the application determines whether or not the input data is indicative of a contribution made by the user. The determination may be performed in accordance with the disclosure above and may include a determination of that the input data corresponds to one or more of categories 922-928 of contribution data. In an embodiment, the determination may be based on whether the input data entered by the user is in response to data associated with a token value (e.g., entering a donation associated with a token value and/or responding to a user request). The presence of a token value associated with the input data at step 934 may be indicative that the input data is contribution data. In another embodiment, the determination may be influenced by the artificial intelligence as described herein (e.g., the predictive model described herein). If the input data is not one of the types of contribution data (i.e., “NO” in step 934), process 930 returns to step 932 and waits for another user input. Otherwise (i.e., “YES” in step 934), process 930 proceeds to step 935.

In step 935, the application determines rewards to be allocated to the contribution data. For example, as described above, the user interaction may execute one or more functions of the application, as described herein, which may correspond to contribution data, as described above. In an embodiment, tokens previously associated with the originating request to which the user has responded may be identified and determined based on the contribution type. For example, tokens associated with a user request may be retrieved, from another user's user objective data 429 that includes the request, and allocated to the user. In an embodiment, token allocations may be determined based on another user's contributions, for example, in a case in which both users are part of a team that earned the reward.

In step 936, the application associates the allocated rewards with the user. In an embodiment, this association may be stored in a database (e.g., database 114). In step 938, the allocated tokens, associated with the user, are output to other functions as allocated rewards data. In an embodiment, data indicative of the allocated rewards, associated with the user, are output with the corresponding user inputs. As described elsewhere herein, each allocation of reward tokens may be recorded as a transaction on the blockchain. The allocated tokens may also be added to and/or associated with a descriptive user data model 405 associated with the user.

3.6. Privatized Content Delivery

In an embodiment, platform 110 privatizes external data by polling external systems 140 for data, and then storing the data, received from external systems 140, in one or more datasets that are managed by platform 110 (e.g., database 114). External systems 140 may comprise systems that host sites and other resources on the Internet (e.g., websites). In this embodiment, platform 110 may essentially copy a portion of the Internet to be stored and managed locally at platform 110. For instance, platform 110 may poll and store local copies of all Internet resources that have been and/or are likely to be accessed by users of the application.

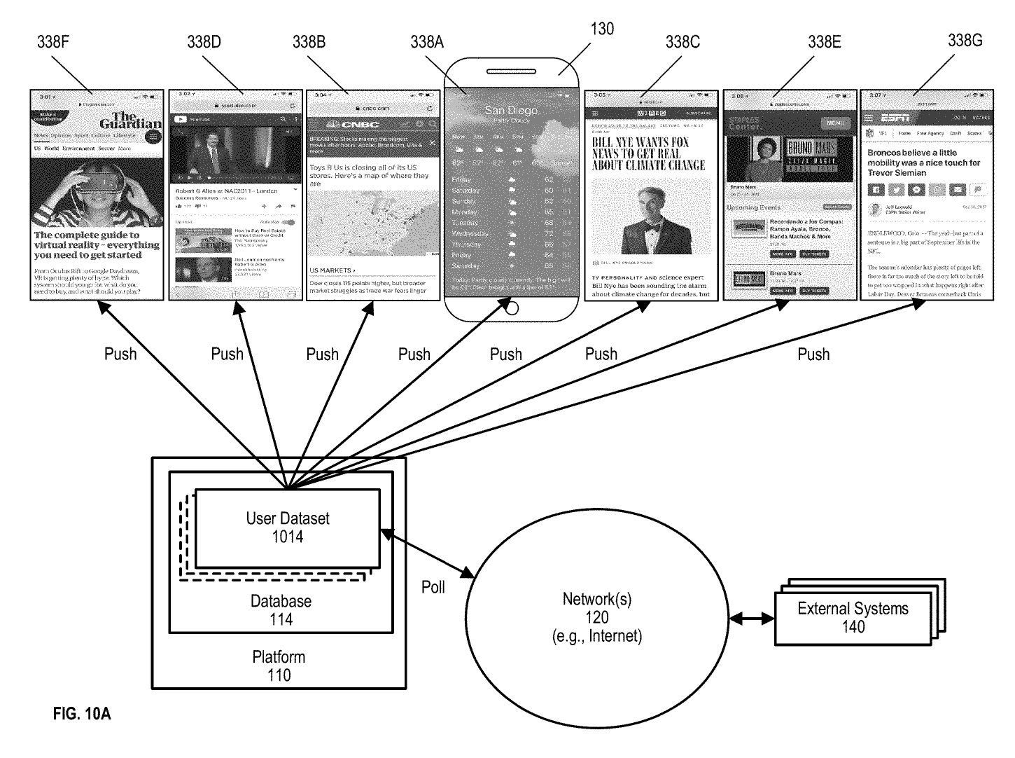

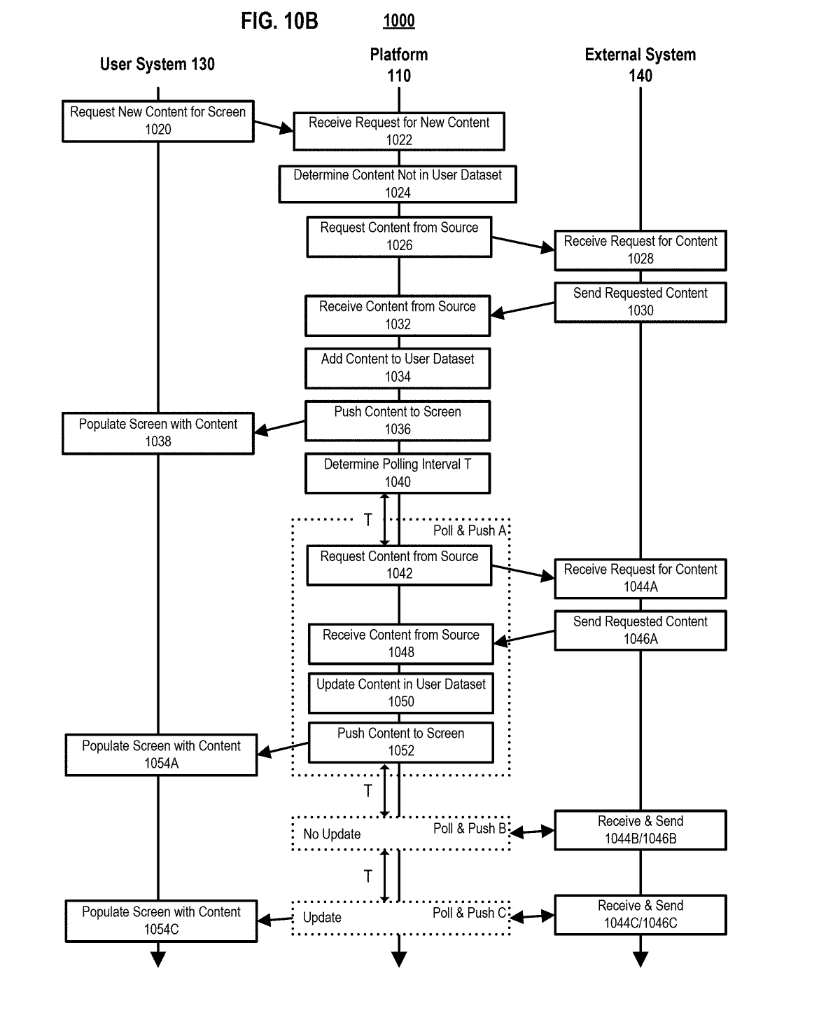

FIG. 10A illustrates an infrastructure for delivering privatized external content, according to an embodiment. The first time a user system 130 requests content from a particular source (e.g., website on external system 140), platform 110 may access the source to retrieve the content, store the content in a user dataset 1014, associated with the user of user system 130, in database 114, and provide the content to user system 130. Subsequently, while the content is open in user system 130 (e.g., being presented in an active or inactive module screen, being presented in a content block 351 or 352 of a content feed 350, etc.), platform 110 may poll the source to update the copy of the content in user dataset 1014. Platform 110 may maintain a separate user dataset 1014 for each user of the application, which may be indexed or otherwise retrievable by a unique identifier of the user (e.g., assigned by the application).

The polling may be performed at regular intervals (e.g., every few seconds, every minute, etc.). When the content is not open in user system 130 (e.g., as notified by user system 130), the polling may be performed at longer intervals or not at all. The length of the polling intervals for a particular source may depend on the source, content, and/or the user's behavior. For example, a source or content (e.g., a news article) which is not as frequently updated may be polled at longer intervals than a source or content that is more frequently updated (e.g., a stock quote during market hours). In addition, a source that is frequently viewed by the user (e.g., viewed as an active module screen on user system 130) may be polled at shorter intervals than a source that is not as frequently viewed by the user.

Whenever the content in user dataset 1014 is updated, as a result of an instance of polling, the updated content may be pushed to the appropriate screen of user system 130. Content may be updated independently from other content. For instance, a user may be viewing module screens 338A-338G in a multi-modal view. In this case, platform 110 may poll all seven sources at varying intervals. If one or more of the sources are updated, platform 110 may store and push only those updates for those sources to the corresponding screens. For example, if the source content of module screen 338A, 338D, and 338G has been updated, while the source content of module screens 338B, 338C, 338E, and 338F has not been updated, platform 110 may push respective updates to module screens 338A, 338D, and 338G, so that the content in these module screens change, while module screens 338B, 338C, 338E, and 338F remain static. The content may pushed and updated in module screens even if the updated module screens are inactive (e.g., not currently being displayed).

Platform 110 may maintain a user dataset 1014 for each user of the application. Each user dataset 1014 may be logically separate from other user datasets 1014 and associated with a particular user. Alternatively, the privatized content may be stored in a single application-wide dataset that is used to feed the screens of all users. In an embodiment in which a first user may view the same content that a second user is viewing (e.g., another user's content feed 350, another user's multi-screen view 328 and/or multi-modal view 336, etc.), the first user's screen(s) may be populated directly from the second user's user dataset 1014 or copied into the first user's user dataset 1014.

Notably, the privatization of external content enables this data to be pushed to user systems 130 (e.g., unsolicited), instead of having to be pulled by user systems 130. Advantageously, this can reduce power consumption by user systems 130. Thus, in the event that a user system 130 is a mobile device which draws its power from a battery, the privatization of external content by platform 110 improves the battery life of the user system 130. Instead, of the mobile user system 130, with its limited power supply, having to continually retrieve and update content, this task is offloaded to platform 110, which may have a practically infinite power supply.

FIG. 10B illustrates an example of a process 1000 for delivering privatized external content, according to an embodiment. While process 1000 is illustrated with a specific sequence of steps, in alternative embodiments, process 1000 may be implemented with more, fewer, or a different arrangement and/or ordering of steps. It should be understood that the steps performed by user system 130 may be performed by a client application 132, executing on user system 130. In addition, the steps performed by platform 110 may be performed by server application 112. Furthermore, all communications between user system 130, platform 110, and external system 140 may be performed over network(s) 120, which may comprise the Internet.

In step 1020, user system 130 requests new content for a screen from platform 110. User system 130 may send such a request whenever new content from a source needs to be populated into a screen. The content may be requested for an entire screen, such as a module screen 330 or 338 (e.g., in response to initiation of a new app module), or for a portion of a screen, such as a content block 351 or 352 in content feed 350 (e.g., in response to initiation of content feed 350, or the addition of a new content block 351 or 352 to an existing content feed 350).

In step 1022, platform 110 receives the request for new content from user system 130. In response to receiving the new content request, platform 110 determines whether or not the content is currently in the user dataset (e.g., user dataset 1014) of the user associated with user system 130 in step 1024. Platform 110 may retrieve a user's user dataset based on a user identifier associated with the user and included by user system 130 in any request. If the requested content were determined to already exist in the user dataset 1014, platform 110 could immediately send the requested content to user system 130 for display in the screen (e.g., after updating the content if necessary). However, in the illustrated example, the requested content is assumed to be initially absent from user dataset 1014. In this case, in step 1026, platform 110 requests the content, requested by user system 130 in step 1020, from external system 140 (i.e., the source of the content). It should be understood that external system 140 may represent the source of any type of content (e.g., a social-networking platform providing social media, a weather platform providing weather forecasts, a news platform providing news articles, any server providing any website, etc.).

In step 1028, external system 140 receives the request for content from platform 110. In response, external system 140 sends the requested content to platform 110 in step 1030.

In step 1032, platform 110 receives the requested content from external system 140. After receiving the requested content, platform 110 adds the content to the user dataset (e.g., user dataset 1014), associated with the user of user system 130, in step 1034. For example, platform 110 may store the content so that it is indexed or otherwise retrievable based on its source (e.g., external system 140, a specific domain or Uniform Resource Locator (URL) associated with the content, and/or the like). In addition, in step 1036, platform 110 pushes the content, received in step 1032, to user system 1036, and user system 130 subsequently receives the pushed content in step 1038.

In step 1040, platform 110 may determine a polling interval T. The polling interval T may be based on the source of the content and/or the behavior of the user. For example, if the source is updated frequently and/or the user is likely to view the content frequently (e.g., as determined by the artificial intelligence, described elsewhere herein (e.g., the predictive model described herein), based on the user's past behavior), platform 110 may set a shorter polling interval T, such that the polling will occur more frequently. On the other hand, if the source is updated infrequently and/or the user is likely to view the content infrequently, platform 110 may set a longer polling interval T, such that polling will occur less frequently. Thus, the polling interval T may be adjusted over time, based on changes in the type of content, source of the content, or the user's behavior (e.g., as determined by the artificial intelligence). Alternatively, polling interval T could be a preset, fixed, or default interval.

Steps 1042-1054 illustrate the poll-and-push functionality of platform 110, according to an embodiment. Specifically, after each expiration of the polling interval T, over a plurality of intervals, platform 110 executes steps 1042 and 1048-1052.

In step 1042, platform 110 requests the content from the external system 140 representing the source of the content. This step may be similar or identical to step 1026. In addition, external system 140 receives the request from platform 110 in step 1044, and sends the requested content to platform 110 in step 1046. Steps 1044 and 1046 may be similar or identical to steps 1028 and 1030, respectively. In step 1048, which may be similar or identical to step 1032, platform 110 receives the requested content from external system 140.

In step 1050, platform 110 updates the content stored, in step 1034, in the user dataset (e.g., user dataset 1014), associated with the user of user system 130, based on the content received from external system 140 in step 1048. Platform 110 may perform this update by overwriting or otherwise modifying the content stored in step 1034, using the content received in step 1048. For instance, platform 110 may simply replace the content stored in association with the same source address (e.g., URL) with the updated content received in step 1048, or may retrieve the content stored in association with the same source address (e.g., by source address) and modify that content to reflect the updated content received in step 1048.

In step 1052, platform 110 pushes the updated content to the corresponding screen of user system 130. Subsequently, in step 1054, user system populates the corresponding screen with the updated content, pushed in step 1052. Steps 1052 and 1054 may be similar or identical to steps 1036 and 1038, respectively.

After each expiration of polling interval T, steps 1042-1054 may be repeated. However, it should be understood that, during any of the poll-and-push iterations, if the content received in step 1048 does not reflect any updates with respect to the content stored in the user dataset (e.g., in step 1034 or a prior step 1050), steps 1050-1054 may be omitted from that particular poll-and-push iteration. For example, as illustrated by poll-and-push iteration B, in FIG. 10B, if the content retrieved in steps 1042-1048 does not reflect any updates from the previously retrieved content, steps 1050-1054 are omitted. In this manner, the battery life of user system 130 may be improved, since it does not have to unnecessarily consume the power necessary to receive and populate the corresponding screen with stale content.

The poll-and-push iterations may continue at the expiration of each polling interval T for as long as the screen, corresponding to the content, is available for viewing by the user of user system 130 (e.g., whether active or inactive). Once the content is closed at user system 130 (e.g., the instance of the app module generating the screen reflecting the content is terminated, the content feed comprising the content block representing the content is terminated, the content block representing the content is removed from the content feed, etc.), platform 110 may terminate the poll-and-push functionality for that particular content. The next time that the particular content is requested by user system 130, platform 110 may omit steps 1026-1034, since the content will already exist in the user dataset (e.g., user dataset 1014).

It should be understood that process 1000 may be performed for each instance of content that is opened at user system 130. This may involve performing process 1000, virtually simultaneously, for each of a plurality of screens (e.g., in a multi-screen view 328, multi-modal view 336, etc.) and/or content blocks (e.g., in a content feed 350) that are simultaneously open at user system 130.

Advantageously, the substitution of the conventional pull paradigm at mobile user systems 130 with the disclosed poll-and-push paradigm at platform 110 reduces battery consumption by each mobile user system 130, while still ensuring that the content being viewed by the user reflects real-time, updated content. Specifically, each mobile user system 130 only needs to consume the power necessary to receive content after a portion of intervals (i.e., at each interval in which platform 110 determines that the content has been updated and should be pushed), rather than having to consume the power necessary to both request and receive the content after all intervals.

In an embodiment, when content is modified at user system 130 (e.g., by a user inputting information into the content or otherwise interacting with the content), the modified content may be sent from user system 130 to platform 110. Platform 110 may update the corresponding content in the user's user dataset 1014 with the modified content. If appropriate, platform 110 may also relay the modified content to the source of the original content (e.g., an external system 140).

3.7. Analytics

In an embodiment, the application collects data on all activities conducted through or facilitated by the application. This data can be analyzed (e.g., “mined”) to discover meaningful patterns in the activities of an individual user, a particular community of users, and/or all users of the application. For example, all user behavior may be analyzed, including, without limitation, behavior within app modules, across all home screens 102 and/or other screens of the graphical user interface, across other features and functions of the application, and/or any of the search functions (e.g., content searching, multi-view and/or multi-modal searching, broadcast searching, business or people searching, chat searching, community searching, searching followed users, give searching, grow searching, live searching, content-feed searching, notification searching, ratings searching, recognition searching, rewards searching, preferred sources searching, etc.).

3.7.1 Personal

In an embodiment, the application may provide each user with a private, personalized analysis of all of the user's activities and data. For example, this analysis may be accessible via a link 304 of a home screen 302 (e.g., grow-themed screen 302D). The analysis may provide the user with direct feedback concerning patterns in the user's online activities, such as the amount or percentage of time spent by the user to consumer certain categories of content. Users may review and correlate their progress in learning, relationships, areas of focus, actions, and/or the like to actual results and achievements in every area of their lives. The analysis of a user's activities may also be used by the artificial intelligence, described elsewhere herein (e.g., the predictive model described herein), to provide suggestions (e.g., links 304 on a home screen 302, categories in category-snapshot screen 308, etc.) to the user.

The data available for viewing by users and/or use by the artificial intelligence may include, without limitation, usage of app modules, web searches, multi-screen and/or multi-modal searches, content searches, platform searches, broadcasts, notifications, content feeds, browsing interests, messaging, social network (e.g., friends, teams, communities, etc.), self-improvement information, viewed content, education, entertainment, games, recognition, rewards, ratings, contributions to other users, contributions to the application or other causes, achievement of goals, and/or the like.

3.7.2 Application-Wide

In an embodiment, the application may provide application-wide analytics of the activities of all users or a subset (e.g., community or other group) of users. The analytics may mine data from users' activities across all online media (e.g., all app modules), providing advanced and unique metadata for consumption by advertisers, researchers, and/or the like.

In an embodiment, a company-user may specify criteria for defining a subset of users (e.g., all users of a particular gender, age, and/or income level). The application may then provide the company-user with an analysis of the online activities of that subset of users. The company-user can use that analysis for product research and development, targeted advertising, and/or the like.

For example, the application may analyze user activities to identify which communications (e.g., advertisements, broadcasts, or other messages from a company-user to a consumer-user) and/or activities most frequently resulted in consumer-users purchasing services or goods. From this information, the application could determine which communications and/or activities are the most predictive of whether or not a consumer-user will purchase a service or good. Company-users can use this information to better allocate their resources (e.g., spend more resources on certain communications and/or activities which are more likely to lead to a purchase) so as to maximize the conversion of these consumer-users into purchasers.

A company-user could even utilize this information to time communications (e.g., advertisements), such that communications are received during a time in which the consumer-user is more likely to make a purchase and/or during an activity by the consumer-user in which the consumer-user is more likely to make a purchase (e.g., when the consumer-user is shopping through an app module). For example, in an embodiment of the broadcast function, the graphical user interface (e.g., via the broadcast wizard described elsewhere herein) may comprise one or more inputs that allow the company-user to specify a time or activity of the consumer-user during which the broadcast message should be notified to the consumer-user.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising using at least one hardware processor to:
manage a plurality of app modules, wherein each app module comprises a software module that generates a screen comprising content from a corresponding content source;
generate a graphical user interface, which provides user navigation between each screen generated by an executing one of the plurality of app modules, and which receives a search input;
in response to receiving a search input, comprising one or more search terms, via the graphical user interface, execute two or more of the plurality of app modules to, for each of the two or more app modules, generate a content screen that comprises a search result of a search based on the one or more search terms;
sort the search results into a plurality of categories;
rank the search results within each of the plurality of categories; and
generate a result screen, within the graphical user interface, that comprises, for each of one or more of the plurality of categories, a scroll interface, wherein each scroll interface comprises visual representations of a plurality of the content screens that comprise the search results that were sorted into the category, and wherein each scroll interface is scrollable in one or more directions.

2. The method of claim 1, wherein each scroll interface comprises visual representations of the plurality of the content screens logically arranged along a single axis that is scrollable in two directions.

3. The method of claim 2, wherein the single axis is a horizontal axis of the graphical user interface.

4. The method of claim 2, wherein the logical arrangement is circular, such that, for each scroll interface, the visual representations may be continuously scrolled in either of the two directions, to repeatedly show all of the visual representations in the scroll interface.

5. The method of claim 1, wherein each scroll interface comprises a central position, and at least a first position adjacent to one side of the central position and a second position adjacent to an opposite side of the central position, wherein one visual representation is positioned in each of the central position, the first position, and the second position, and wherein the visual representation of the content screen that comprises the search result, which was ranked highest within the category represented by the scroll interface, is initially positioned in the central position.

6. The method of claim 5, wherein the visual representation positioned in the central position is visually distinguished from the visual representation positioned in the first position and the visual representation positioned in the second position.

7. The method of claim 6, wherein the visual representation positioned in the central position has a larger size than the visual representation positioned in the first position and the visual representation positioned in the second position, and wherein the visual representation positioned in the first position is a same size as the visual representation positioned in the second position.

8. The method of claim 7, wherein each scroll interface comprises four or more positions, including the central position, the first position, and the second position, wherein the visual representation, positioned in the central position, has a largest size, and wherein any visual representation, positioned in a position farther from the central position than a position of another visual representation, has a smaller size than that other visual representation.

9. The method of claim 5, wherein each scroll interface comprises text that describes the visual representation positioned in the central position.

10. The method of claim 9, further comprising using the at least one hardware processor to generate the text based, at least in part, on biases of a user represented by a data model associated with the user, wherein the data model is generated based, at least in part, on user activities within the graphical user interface.

11. The method of claim 1, further comprising using the at least one hardware processor to select the one or more categories to be represented in the result screen based, at least in part, on biases of a user represented by a data model associated with the user, wherein the data model is generated based, at least in part, on user activities within the graphical user interface.

12. The method of claim 1, further comprising using the at least one hardware processor to rank the search results within each of the plurality of categories based, at least in part, on biases of a user represented by a data model associated with the user, wherein the data model is generated based, at least in part, on user activities within the graphical user interface.

13. The method of claim 1, wherein the one or more categories comprise a snapshot category which comprises the search result which was ranked highest within each of the other plurality of categories.

14. The method of claim 1, further comprising using the at least one hardware processor to, in response to a user selection of a visual representation of a content screen from a scroll interface, display the content screen within the graphical user interface.

15. The method of claim 1, wherein the content source corresponding to at least one of the executing two or more app modules comprises a social-networking platform, and wherein the search result of the search of the social-networking platform comprises one or more social media.

16. The method of claim 15, wherein the one or more search terms comprise a name of a person, and wherein the search result of the search of the social-networking platform comprises one or more social media associated with an account that the person has with the social-networking platform.

17. The method of claim 1, wherein the content source corresponding to at least one of the executing two or more app modules comprises a website, and wherein the search result of the search of the website comprises a webpage.

18. The method of claim 1, wherein each visual representation of a content screen comprises a thumbnail image of the content screen.

19. A system comprising:
at least one hardware processor; and
an application comprising one or more software modules that, when executed by the at least one hardware processor,
manage a plurality of app modules, wherein each app module comprises a software module that generates a screen comprising content from a corresponding content source,
generate a graphical user interface, which provides user navigation between each screen generated by an executing one of the plurality of app modules, and which receives a search input,
in response to receiving a search input, comprising one or more search terms, via the graphical user interface, execute two or more of the plurality of app modules to, for each of the two or more app modules, generate a content screen that comprises a search result of a search based on the one or more search terms,
sort the search results into a plurality of categories,
rank the search results within each of the plurality of categories, and
generate a result screen, within the graphical user interface, that comprises, for each of one or more of the plurality of categories, a scroll interface, wherein each scroll interface comprises visual representations of a plurality of the content screens that comprise the search results that were sorted into the category, and wherein each scroll interface is scrollable in one or more directions.

20. A non-transitory computer-readable medium storing instructions that, when executed by a processor, cause the processor to:
manage a plurality of app modules, wherein each app module comprises a software module that generates a screen comprising content from a corresponding content source;
generate a graphical user interface, which provides user navigation between each screen generated by an executing one of the plurality of app modules, and which receives a search input;
in response to receiving a search input, comprising one or more search terms, via the graphical user interface, execute two or more of the plurality of app modules to, for each of the two or more app modules, generate a content screen that comprises a search result of a search based on the one or more search terms;
sort the search results into a plurality of categories;
rank the search results within each of the plurality of categories; and
generate a result screen, within the graphical user interface, that comprises, for each of one or more of the plurality of categories, a scroll interface, wherein each scroll interface comprises visual representations of a plurality of the content screens that comprise the search results that were sorted into the category, and wherein each scroll interface is scrollable in one or more directions.
